(19) United States
(12) Patent Application Publication
(10) Pub. No.: US 2026/0147188 A1
(43) Pub. Date: May 28, 2026

(54) FIXED-FOCAL-LENGTH OPTICAL SYSTEM AND IMAGING APPARATUS

(71) Applicant: FUJIFILM Corporation, Tokyo (JP)

(72) Inventor: Masato KONDO, Saitama (JP)

(73) Assignee: FUJIFILM Corporation, Tokyo (JP)

(21) Appl. No.: 19/394,673

(22) Filed: Nov. 19, 2025

(30) Foreign Application Priority Data
Nov. 26, 2024 (JP) 2024-205708

(51) Int. Cl. G02B 13/00; G02B 7/02

(52) U.S. Cl. CPC G02B 13/0045; G02B 7/025; G02B 13/006

(57) ABSTRACT

A fixed-focal-length optical system consists of, in order from an object side to an image side, a front group, a stop, and a rear group. In a case where a refractive index and an Abbe number of a lens included in the fixed-focal-length optical system are denoted by Nd and νd, respectively, the fixed-focal-length optical system includes at least one specific lens that is a lens satisfying 2.435<Nd+0.01425×νd<2.75 and 15<νd<39.

### CROSS-REFERENCE TO RELATED APPLICATIONS

This application claims priority from Japanese Patent Application No. 2024-205708, filed on Nov. 26, 2024, the entire disclosure of which is incorporated herein by reference.

### BACKGROUND OF THE INVENTION

### Technical Field

The disclosed technology relates to a fixed-focal-length optical system and an imaging apparatus.

### Related Art

In the related art, a fixed-focal-length lens system according to JP2017-049572A has been known as a lens system that can be used in an imaging apparatus such as a digital camera.

### SUMMARY

There is demand for a fixed-focal-length optical system in which chromatic aberration and other various types of aberration are corrected in a well-balanced manner, and a level of demand is increasing year by year.

The present disclosure provides a fixed-focal-length optical system in which chromatic aberration and other various types of aberration are corrected in a well-balanced manner, and an imaging apparatus comprising the fixed-focal-length optical system.

According to a first aspect of the present disclosure, there is provided a fixed-focal-length optical system consisting of, in order from an object side to an image side, a front group, a stop, and a rear group, in which the fixed-focal-length optical system includes at least one specific lens that is a lens satisfying Conditional Expressions (1) and (2) represented by

$$2.435 < N d + 0.01425 \times v d < 2.75 , and \qquad ( 1 )$$

$$15 < vd < 39. \qquad ( 2 )$$

A refractive index at a d line for a lens included in the fixed-focal-length optical system is denoted by Nd. An Abbe number based on the d line for the lens included in the fixed-focal-length optical system is denoted by νd.

According to a second aspect of the present disclosure, in the fixed-focal-length optical system of the first aspect, in a case where a partial dispersion ratio between a g line and an F line for the lens included in the fixed-focal-length optical system is denoted by θgF, the specific lens satisfies Conditional Expression (3) represented by

$$0.65 < θ gF + 0.00316 \times v d < 0 \text{.85} . \qquad ( 3 )$$

According to a third aspect of the present disclosure, in the fixed-focal-length optical system of the first aspect, in a case where a focal length of the front group in a state where an infinite distance object is in focus is denoted by fF, and a focal length of the rear group in the state where the infinite distance object is in focus is denoted by fR, Conditional Expression (4) is satisfied, which is represented by

$$- 5 < fR / fF < 10. \qquad ( 4 )$$

According to a fourth aspect of the present disclosure, in the fixed-focal-length optical system of the first aspect, at least one focus lens group that moves along an optical axis during focusing is disposed.

According to a fifth aspect of the present disclosure, in the fixed-focal-length optical system of the fourth aspect, in a case where a focal length of a focus lens group having strongest refractive power among the focus lens groups included in the fixed-focal-length optical system is denoted by ffocmax, and a focal length of the fixed-focal-length optical system in a state where an infinite distance object is in focus is denoted by f, Conditional Expression (5) is satisfied, which is represented by

$$0.2 < \vert ffoc max / f \vert < 3.5 . \qquad ( 5 )$$

According to a sixth aspect of the present disclosure, in the fixed-focal-length optical system of the fourth aspect, the number of focus lens groups included in the fixed-focal-length optical system is two, and in a case where a focal length of the focus lens group on the object side out of the two focus lens groups is denoted by ff1, and a focal length of the focus lens group on the image side out of the two focus lens groups is denoted by ff2, Conditional Expression (6) is satisfied, which is represented by

$$0.1 < \vert ff 1 / ff 2 \vert < 10. \qquad ( 6 )$$

According to a seventh aspect of the present disclosure, in the fixed-focal-length optical system of the fourth aspect, in a case where a combined focal length of all lenses on the object side with respect to a focus lens group closest to the object side among the focus lens groups included in the fixed-focal-length optical system is denoted by ffocF, and a focal length of the fixed-focal-length optical system in a state where an infinite distance object is in focus is denoted by f, Conditional Expression (7) is satisfied, which is represented by

$$- 2 < f / ffocF < 6. \qquad ( 7 )$$

According to an eighth aspect of the present disclosure, in the fixed-focal-length optical system of the fourth aspect, in a case where a combined focal length of all lenses on the image side with respect to a focus lens group closest to the image side among the focus lens groups included in the fixed-focal-length optical system is denoted by ffocR, and a focal length of the fixed-focal-length optical system in a state where an infinite distance object is in focus is denoted by f, Conditional Expression (8) is satisfied, which is represented by

$$- 6 < f / ffocR < 2. \qquad ( 8 )$$

According to a ninth aspect of the present disclosure, in the fixed-focal-length optical system of the fourth aspect, two focus lens groups that move on different trajectories from each other during focusing are disposed in the rear group.

According to a tenth aspect of the present disclosure, in the fixed-focal-length optical system of the fourth aspect, one focus lens group is disposed in each of the front group and the rear group, the focus lens group of the front group and the focus lens group of the rear group move on different trajectories from each other during focusing, and Conditional Expression (9) is satisfied, which is represented by

$$0.1 < \vert ffocF / fM \vert < 2. \qquad ( 9 )$$

A combined focal length of all lenses on the object side with respect to a focus lens group closest to the object side among the focus lens groups included in the fixed-focal-length optical system is denoted by ffocF. A combined focal length from a lens adjacent to the focus lens group of the front group on the image side to a lens adjacent to the focus lens group of the rear group on the object side is denoted by fM.

According to an eleventh aspect of the present disclosure, in the fixed-focal-length optical system of the fourth aspect, the at least one focus lens group includes at least one specific lens.

According to a twelfth aspect of the present disclosure, in the fixed-focal-length optical system of the first aspect, the rear group includes at least one specific lens.

According to a thirteenth aspect of the present disclosure, in the fixed-focal-length optical system of the first aspect, the front group includes at least one specific lens.

According to a fourteenth aspect of the present disclosure, in the fixed-focal-length optical system of the first aspect, each of the front group and the rear group includes at least one specific lens.

According to a fifteenth aspect of the present disclosure, in the fixed-focal-length optical system of the first aspect, the fixed-focal-length optical system includes at least one cemented lens, and the at least one cemented lens includes at least one specific lens.

According to a sixteenth aspect of the present disclosure, in the fixed-focal-length optical system of the first aspect, the rear group includes a vibration-proof group that moves in a direction intersecting with an optical axis during image shake correction, and in a case where a focal length of the vibration-proof group is denoted by fIS, and a focal length of the fixed-focal-length optical system in a state where an infinite distance object is in focus is denoted by f, Conditional Expression (10) is satisfied, which is represented by

$$0.05 < \vert fIS / f \vert < 2. \qquad ( 10 )$$

According to a seventeenth aspect of the present disclosure, in the fixed-focal-length optical system of the sixteenth aspect, the vibration-proof group includes at least one specific lens.

According to an eighteenth aspect of the present disclosure, in the fixed-focal-length optical system of the first aspect, a maximum half angle of view in a state where an infinite distance object is in focus is 7 degrees or less, and Conditional Expression (11) is satisfied, which is represented by

$$0.2 < Amax / TLf < 0.8 . \qquad ( 11 )$$

A maximum value of an air spacing on an optical axis in the front group in the state where the infinite distance object is in focus is denoted by Amax. A distance on the optical axis from a lens surface closest to the object side in the front group to a lens surface closest to the image side in the front group in the state where the infinite distance object is in focus is denoted by TLf.

According to a nineteenth aspect of the present disclosure, in the fixed-focal-length optical system of the first aspect, in a case where an angle, with respect to an optical axis, of incidence of a chief ray of a maximum angle of view on an image plane in a state where an object at a longest object distance capable of being focused is in focus is denoted by θc, and θc is in degree units, Conditional Expression (12) is satisfied, which is represented by

$$0 < \vert θ c \vert < 30. \qquad ( 12 )$$

According to a twentieth aspect of the present disclosure, there is provided an imaging apparatus comprising the fixed-focal-length optical system according to any one of the first to nineteenth aspects.

In the present specification, “consist of” and “consisting of” mean that a lens substantially not having refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

In the present specification, a “group having positive refractive power” means that the whole group has positive refractive power. Similarly, a “group having negative refractive power” means that the whole group has negative refractive power. A “lens having positive refractive power” and a “positive lens” are synonymous with each other. A “lens having negative refractive power” and a “negative lens” are synonymous with each other. In the present specification, a “group” is not limited to being configured to consist of a plurality of lenses and may be configured to consist of only one lens.

A “single lens” means one lens that is not cemented. A compound aspherical lens (a lens functioning as one aspherical lens as a whole composed of a spherical lens and a film having an aspherical shape formed on the spherical lens that are integrated with each other) is not regarded as a cemented lens and is treated as one lens. Unless otherwise specified, signs of a curvature radius and refractive power and a surface shape in a paraxial region are used with respect to a lens including an aspherical surface. For the sign of the curvature radius, a sign of the curvature radius of a surface having a convex shape facing the object side is positive, and a sign of the curvature radius of a surface having a convex shape facing the image side is negative.

The “focal length” used in the conditional expressions is a paraxial focal length. Unless otherwise specified, the “distance on the optical axis” used in the conditional expressions is a geometrical distance. Unless otherwise specified, values used in the conditional expressions are values based on a d line in the state where the infinite distance object is in focus. In the present specification, the “object distance” refers to a distance on the optical axis from an object to a lens surface closest to the object side.

A “d line”, a “C line”, an “F line”, and a “g line” according to the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a fixed-focal-length optical system in which chromatic aberration and other various types of aberration are corrected in a well-balanced manner, and an imaging apparatus comprising the fixed-focal-length optical system can be provided.

### BRIEF DESCRIPTION OF THE DRAWINGS

FIG. 1 is a cross-sectional view corresponding to a fixed-focal-length optical system of Example 1 and showing a configuration of a fixed-focal-length optical system according to one embodiment.

FIG. 2 is a cross-sectional view showing a configuration and luminous fluxes in each state of the fixed-focal-length optical system in FIG. 1.

FIG. 3 is each aberration diagram of the fixed-focal-length optical system of Example 1.

FIG. 4 is a cross-sectional view showing a configuration and luminous fluxes of a fixed-focal-length optical system of Example 2.

FIG. 5 is each aberration diagram of the fixed-focal-length optical system of Example 2.

FIG. 6 is a cross-sectional view showing a configuration and luminous fluxes of a fixed-focal-length optical system of Example 3.

FIG. 7 is each aberration diagram of the fixed-focal-length optical system of Example 3.

FIG. 8 is a cross-sectional view showing a configuration and luminous fluxes of a fixed-focal-length optical system of Example 4.

FIG. 9 is each aberration diagram of the fixed-focal-length optical system of Example 4.

FIG. 10 is a cross-sectional view showing a configuration and luminous fluxes of a fixed-focal-length optical system of Example 5.

FIG. 11 is each aberration diagram of the fixed-focal-length optical system of Example 5.

FIG. 12 is a cross-sectional view showing a configuration and luminous fluxes of a fixed-focal-length optical system of Example 6.

FIG. 13 is each aberration diagram of the fixed-focal-length optical system of Example 6.

FIG. 14 is a cross-sectional view showing a configuration and luminous fluxes of a fixed-focal-length optical system of Example 7.

FIG. 15 is each aberration diagram of the fixed-focal-length optical system of Example 7.

FIG. 16 is a cross-sectional view showing a configuration and luminous fluxes of a fixed-focal-length optical system of Example 8.

FIG. 17 is each aberration diagram of the fixed-focal-length optical system of Example 8.

FIG. 18 is a cross-sectional view showing a configuration and luminous fluxes of a fixed-focal-length optical system of Example 9.

FIG. 19 is each aberration diagram of the fixed-focal-length optical system of Example 9.

FIG. 20 is a cross-sectional view showing a configuration and luminous fluxes of a fixed-focal-length optical system of Example 10.

FIG. 21 is each aberration diagram of the fixed-focal-length optical system of Example 10.

FIG. 22 is a cross-sectional view showing a configuration and luminous fluxes of a fixed-focal-length optical system of Example 11.

FIG. 23 is each aberration diagram of the fixed-focal-length optical system of Example 11.

FIG. 24 is a cross-sectional view showing a configuration and luminous fluxes of a fixed-focal-length optical system of Example 12.

FIG. 25 is each aberration diagram of the fixed-focal-length optical system of Example 12.

FIG. 26 is a cross-sectional view showing a configuration and luminous fluxes of a fixed-focal-length optical system of Example 13.

FIG. 27 is each aberration diagram of the fixed-focal-length optical system of Example 13.

FIG. 28 is a cross-sectional view showing a configuration and luminous fluxes of a fixed-focal-length optical system of Example 14.

FIG. 29 is each aberration diagram of the fixed-focal-length optical system of Example 14.

FIG. 30 is a cross-sectional view showing a configuration and luminous fluxes of a fixed-focal-length optical system of Example 15.

FIG. 31 is each aberration diagram of the fixed-focal-length optical system of Example 15.

FIG. 32 is a cross-sectional view showing a configuration and luminous fluxes of a fixed-focal-length optical system of Example 16.

FIG. 33 is each aberration diagram of the fixed-focal-length optical system of Example 16.

FIG. 34 is a cross-sectional view showing a configuration and luminous fluxes of a fixed-focal-length optical system of Example 17.

FIG. 35 is each aberration diagram of the fixed-focal-length optical system of Example 17.

FIG. 36 is a cross-sectional view showing a configuration and luminous fluxes of a fixed-focal-length optical system of Example 18.

FIG. 37 is each aberration diagram of the fixed-focal-length optical system of Example 18.

FIG. 38 is a cross-sectional view showing a configuration and luminous fluxes of a fixed-focal-length optical system of Example 19.

FIG. 39 is each aberration diagram of the fixed-focal-length optical system of Example 19.

FIG. 40 is a cross-sectional view showing a configuration and luminous fluxes of a fixed-focal-length optical system of Example 20.

FIG. 41 is each aberration diagram of the fixed-focal-length optical system of Example 20.

FIG. 42 is a cross-sectional view showing a configuration and luminous fluxes of a fixed-focal-length optical system of Example 21.

FIG. 43 is each aberration diagram of the fixed-focal-length optical system of Example 21.

FIG. 44 is a cross-sectional view showing a configuration and luminous fluxes of a fixed-focal-length optical system of Example 22.

FIG. 45 is each aberration diagram of the fixed-focal-length optical system of Example 22.

FIG. 46 is a cross-sectional view showing a configuration and luminous fluxes of a fixed-focal-length optical system of Example 23.

FIG. 47 is each aberration diagram of the fixed-focal-length optical system of Example 23.

FIG. 48 is a cross-sectional view showing a configuration and luminous fluxes of a fixed-focal-length optical system of Example 24.

FIG. 49 is each aberration diagram of the fixed-focal-length optical system of Example 24.

FIG. 50 is a cross-sectional view showing a configuration and luminous fluxes of a fixed-focal-length optical system of Example 25.

FIG. 51 is each aberration diagram of the fixed-focal-length optical system of Example 25.

FIG. 52 is a cross-sectional view showing a configuration and luminous fluxes of a fixed-focal-length optical system of Example 26.

FIG. 53 is each aberration diagram of the fixed-focal-length optical system of Example 26.

FIG. 54 is a cross-sectional view showing a configuration and luminous fluxes of a fixed-focal-length optical system of Example 27.

FIG. 55 is each aberration diagram of the fixed-focal-length optical system of Example 27.

FIG. 56 is a cross-sectional view showing a configuration and luminous fluxes of a fixed-focal-length optical system of Example 28.

FIG. 57 is each aberration diagram of the fixed-focal-length optical system of Example 28.

FIG. 58 is a cross-sectional view showing a configuration and luminous fluxes of a fixed-focal-length optical system of Example 29.

FIG. 59 is each aberration diagram of the fixed-focal-length optical system of Example 29.

FIG. 60 is a cross-sectional view showing a configuration and luminous fluxes of a fixed-focal-length optical system of Example 30.

FIG. 61 is each aberration diagram of the fixed-focal-length optical system of Example 30.

FIG. 62 is a cross-sectional view showing a configuration and luminous fluxes of a fixed-focal-length optical system of Example 31.

FIG. 63 is each aberration diagram of the fixed-focal-length optical system of Example 31.

FIG. 64 is a cross-sectional view showing a configuration and luminous fluxes of a fixed-focal-length optical system of Example 32.

FIG. 65 is each aberration diagram of the fixed-focal-length optical system of Example 32.

FIG. 66 is a cross-sectional view showing a configuration and luminous fluxes of a fixed-focal-length optical system of Example 33.

FIG. 67 is each aberration diagram of the fixed-focal-length optical system of Example 33.

FIG. 68 is a cross-sectional view showing a configuration and luminous fluxes of a fixed-focal-length optical system of Example 34.

FIG. 69 is each aberration diagram of the fixed-focal-length optical system of Example 34.

FIG. 70 is a perspective view of a front surface side of an imaging apparatus according to one embodiment.

FIG. 71 is a perspective view of a rear surface side of the imaging apparatus according to one embodiment.

### DETAILED DESCRIPTION

Hereinafter, an embodiment of the present disclosure will be described with reference to the drawings. In the following description, the “fixed-focal-length optical system of the present disclosure” may be simply referred to as the “fixed-focal-length optical system” to avoid redundancy.

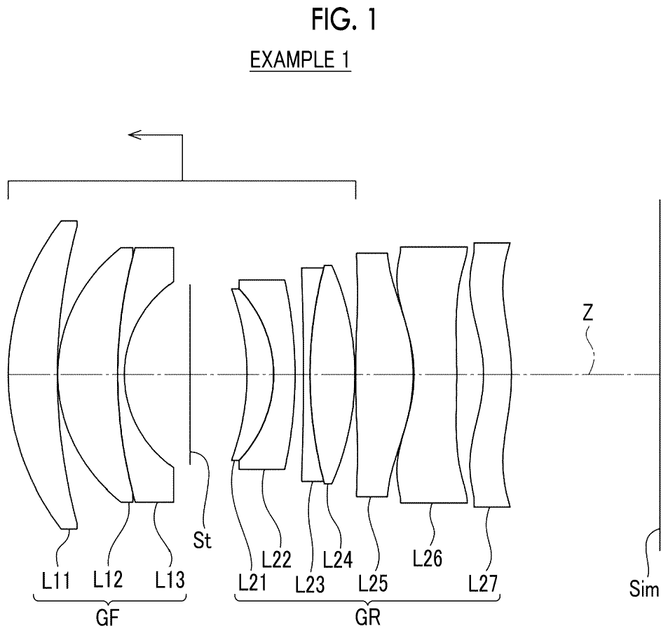

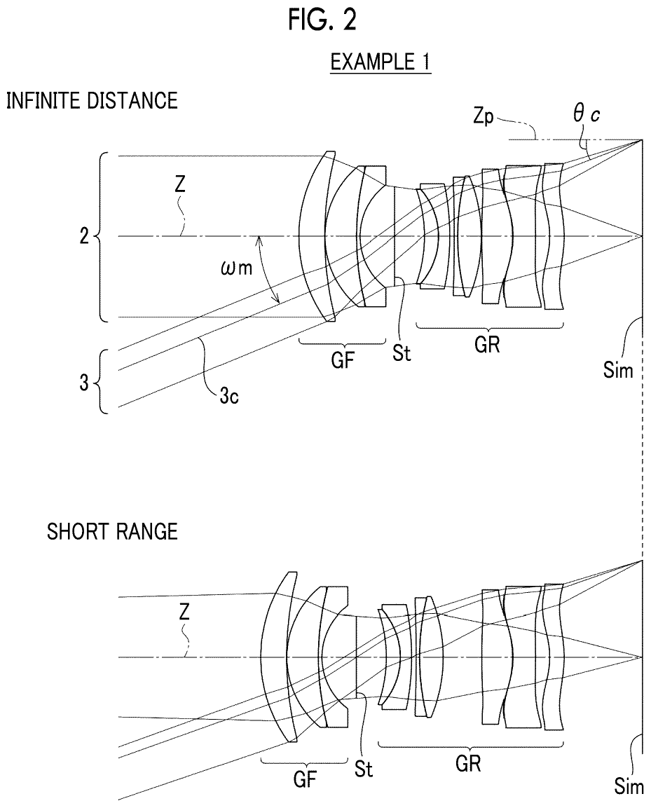

FIG. 1 is a cross-sectional view showing a configuration of a fixed-focal-length optical system according to one embodiment of the present disclosure. FIG. 2 shows a cross-sectional view of the configuration and luminous fluxes of the fixed-focal-length optical system in FIG. 1. In FIG. 2, a state where an infinite distance object is in focus is shown in an upper part labeled “INFINITE DISTANCE”, and a state where a short range object is in focus is shown in a lower part labeled “SHORT RANGE”. In FIG. 2, an on-axis luminous flux 2 and a luminous flux 3 of a maximum half angle of view om in the state where the infinite distance object is in focus, and an on-axis luminous flux and a luminous flux of the maximum half angle of view in the state where the short range object is in focus are shown as the luminous fluxes. In FIGS. 1 and 2, a left side is an object side, and a right side is an image side. The examples shown in FIGS. 1 and 2 correspond to a fixed-focal-length optical system of Example 1 described later. Hereinafter, description will be mainly provided with reference to FIG. 1.

The fixed-focal-length optical system of the present disclosure consists of, in order from the object side to the image side along an optical axis Z, a front group GF, an aperture stop St, and a rear group GR.

For example, each group in FIG. 1 is configured as follows. The front group GF consists of, in order from the object side to the image side, three lenses including lenses L11 to L13. The rear group GR consists of, in order from the object side to the image side, seven lenses including lenses L21 to L27. The aperture stop St in FIG. 1 does not show a size or a shape and shows a position in an optical axis direction. This illustration method of the aperture stop St also applies to other cross-sectional views.

The fixed-focal-length optical system of the present disclosure is configured to include at least one specific lens described below. The specific lens is defined as a lens satisfying Conditional Expressions (1) and (2). A refractive index at a d line for a lens included in the fixed-focal-length optical system is denoted by Nd. An Abbe number based on the d line for the lens included in the fixed-focal-length optical system is denoted by νd.

$$2.435 < Nd + 0. 01425 \times vd < 2.75 \qquad ( 1 )$$

$$15 < vd < 39 \qquad ( 2 )$$

A material of the specific lens may be, for example, glass. Optical glass satisfying Conditional Expressions (1) and (2) and a method of manufacturing the optical glass are described in p. 40 to 42 of the manuscript of the 49th Optical Symposium (duration: Jun. 20 and 21, 2024, host: The Optical Society of Japan, a general incorporated association).

Ensuring that a corresponding value of Conditional Expression (1) is not less than or equal to its lower limit value provides an advantage in favorably performing correction of spherical aberration and correction of chromatic aberration. Ensuring that the corresponding value of Conditional Expression (1) is not greater than or equal to its upper limit value can reduce an increase in difficulty of correcting field curvature.

To obtain more favorable characteristics, the lower limit value of Conditional Expression (1) is more preferably 2.445, further preferably 2.455, further preferably 2.468, further preferably 2.48, further preferably 2.49, further preferably 2.5, further preferably 2.51, and further preferably 2.52. To obtain more favorable characteristics, the upper limit value of Conditional Expression (1) is more preferably 2.74, further preferably 2.73, further preferably 2.72, further preferably 2.71, further preferably 2.7, further preferably 2.69, further preferably 2.68, and further preferably 2.67.

Ensuring that a corresponding value of Conditional Expression (2) is not less than or equal to its lower limit value can favorably correct a second-order spectrum in addition to first-order achromatization in correcting chromatic aberration. Ensuring that the corresponding value of Conditional Expression (2) is not greater than or equal to its upper limit value can favorably correct the second-order spectrum more reliably.

To obtain more favorable characteristics, the lower limit value of Conditional Expression (2) is more preferably 15.5, further preferably 16, further preferably 16.5, further preferably 16.8, further preferably 17.1, and further preferably 17.3. To obtain more favorable characteristics, the upper limit value of Conditional Expression (2) is more preferably 36, further preferably 34, further preferably 33.5, further preferably 33, further preferably 32.5, and further preferably 32.

Using the specific lens satisfying Conditional Expressions (1) and (2) at the same time provides an advantage in correcting chromatic aberration and thus, can reduce labor for correcting chromatic aberration of each lens compared to a case where the specific lens is not used. This provides an advantage in correcting various types of aberration other than chromatic aberration. Accordingly, well-balanced correction of chromatic aberration and other various types of aberration is facilitated.

It is preferable that in a case where a partial dispersion ratio between a g line and an F line for the lens included in the fixed-focal-length optical system is denoted by θgF, the specific lens satisfies Conditional Expression (3).

$$0.65 < θ gF + 0.00316 \times vd < 0.85 \qquad ( 3 )$$

In a case where refractive indices at a g line, an F line, and a C line for a lens are denoted by Ng, NF, and NC, respectively, and a partial dispersion ratio between the g line and the F line for the lens is denoted by θgF, θgF is defined by the following expression.

$$θ gF = ( Ng - NF ) / ( NF - NC )$$

Ensuring that a corresponding value of Conditional Expression (3) is not less than or equal to its lower limit value can favorably correct the second-order spectrum in addition to first-order achromatization in correcting chromatic aberration. Ensuring that the corresponding value of Conditional Expression (3) is not greater than or equal to its upper limit value can favorably correct the second-order spectrum more reliably.

To obtain more favorable characteristics, the lower limit value of Conditional Expression (3) is more preferably 0.67, further preferably 0.675, further preferably 0.68, further preferably 0.683, further preferably 0.689, and further preferably 0.692. To obtain more favorable characteristics, the upper limit value of Conditional Expression (3) is more preferably 0.8, further preferably 0.78, further preferably 0.76, further preferably 0.74, further preferably 0.73, and further preferably 0.725.

In the example in FIG. 2, the lens L11 is the specific lens. However, in the disclosed technology, the specific lens may be disposed at a position different from the example in FIG. 2, and the fixed-focal-length optical system may include a plurality of specific lenses.

For example, the fixed-focal-length optical system may be configured to include at least one cemented lens, and the at least one cemented lens of the fixed-focal-length optical system may be configured to include at least one specific lens. Adopting the specific lens as a lens constituting the cemented lens provides an advantage in reducing chromatic aberration. It is preferable that the specific lens included in the cemented lens satisfies Conditional Expression (3).

It is preferable that the front group GF includes at least one specific lens. Doing so provides an advantage in correcting axial chromatic aberration. In this case, it is preferable that the specific lens included in the front group GF satisfies Conditional Expression (3).

The specific lens having positive refractive power may be disposed closest to the object side in the front group GF. The specific lens consists of a material having a high refractive index. Thus, disposing the specific lens having positive refractive power closest to the object side in the front group GF provides an advantage in reducing an optical total length and correcting spherical aberration. In a variable magnification optical system, the above advantage may not work depending on a magnification changing state, and a high refractive index may work as a disadvantage. However, this does not apply to the fixed-focal-length optical system.

The specific lens having negative refractive power may be disposed closest to the object side in the front group GF. The specific lens consists of a material having a high refractive index. Thus, disposing the specific lens having negative refractive power closest to the object side in the front group GF provides an advantage in compatibility between a wide angle and correction of distortion. In the variable magnification optical system, the above advantage may not work depending on the magnification changing state, and a high refractive index may work as a disadvantage. However, this does not apply to the fixed-focal-length optical system.

It is preferable that the rear group GR includes at least one specific lens. Doing so provides an advantage in correcting lateral chromatic aberration. In this case, it is preferable that the specific lens included in the rear group GR satisfies Conditional Expression (3).

Each of the front group GF and the rear group GR may be configured to include at least one specific lens. Doing so provides an advantage in correcting axial chromatic aberration and lateral chromatic aberration. In this case, it is preferable that both of the specific lens included in the front group GF and the specific lens included in the rear group GR satisfy Conditional Expression (3).

The specific lenses may be consecutively disposed. A lens made of a material having a high refractive index, such as the specific lens, can have strong refractive power even in a case where a difference in a thickness between a part near the optical axis and an edge part is small. Accordingly, in a case where the specific lens is a positive lens, a center thickness can be reduced. In a case where the specific lens is a negative lens, a lens adjacent to a concave surface side of the specific lens can be disposed closer to the specific lens. In a case where the specific lenses having such a shape and disposition characteristic are consecutively disposed regardless of a sign of refractive power, the consecutively disposed specific lenses can have a small thickness in the optical axis direction while having strong refractive power and thus, provide an advantage in size reduction. The specific lenses consecutively disposed as described above generally have high assembly sensitivity and thus, may be disadvantageous in the variable magnification optical system in which a movable portion is present. However, this does not apply to the fixed-focal-length optical system.

The specific lens having positive refractive power may be disposed adjacent to the aperture stop St on the object side. Using a material having a high refractive index, such as the specific lens, for a positive lens and disposing the positive lens adjacent to the aperture stop St on the object side provides an advantage in reducing an increase in a stop diameter. Meanwhile, a lens adjacent to the aperture stop St generally has high sensitivity in the optical axis direction. In the variable magnification optical system, a surface spacing, on the object side, of the aperture stop St generally changes. Thus, the sensitivity is further increased. Accordingly, such disposition of the specific lens is more desirable in the fixed-focal-length optical system than in the variable magnification optical system.

The specific lens may be disposed adjacent to the aperture stop St on the image side. Doing so provides an advantage in reducing axial chromatic aberration. In the variable magnification optical system, a correction state of axial chromatic aberration changes depending on the magnification changing state. However, this does not apply to the fixed-focal-length optical system.

It is preferable that the fixed-focal-length optical system satisfies Conditional Expression (4). A focal length of the front group GF in the state where the infinite distance object is in focus is denoted by fF. A focal length of the rear group GR in the state where the infinite distance object is in focus is denoted by fR. Ensuring that a corresponding value of Conditional Expression (4) is not less than or equal to its lower limit value can reduce various types of aberration such as spherical aberration. Ensuring that the corresponding value of Conditional Expression (4) is not greater than or equal to its upper limit value provides an advantage in implementing a wide angle of view.

$$- 5 < fR / fF < 10 \qquad ( 4 )$$

To obtain more favorable characteristics, the lower limit value of Conditional Expression (4) is more preferably −3, further preferably −1.8, further preferably −1.4, further preferably −1, and further preferably −0.5. To obtain more favorable characteristics, the upper limit value of Conditional Expression (4) is more preferably 7, further preferably 4, further preferably 3, further preferably 2, and further preferably 1.

It is preferable that at least one focus lens group that moves along the optical axis Z during focusing is disposed in the fixed-focal-length optical system. Doing so enables focusing in accordance with a distance to the object. The focus lens group may be configured to consist of a part of the front group GF, may be configured to consist of a part of the rear group GR, may be configured to consist of the aperture stop St and a part of the rear group GR, may be configured to consist of a part of the front group GF, the aperture stop St, and a part of the rear group GR, may be configured to consist of the whole front group GF, the aperture stop St, and a part of the rear group GR, or may be configured to consist of the whole fixed-focal-length optical system.

It is preferable that the at least one focus lens group includes at least one specific lens. Adopting such a configuration provides an advantage in reducing fluctuation of chromatic aberration during focusing. It is preferable that the specific lens included in the focus lens group satisfies Conditional Expression (3).

For example, the focus lens group in the example in FIG. 1 consists of the lenses L11 to L13, the aperture stop St, and the lenses L21 to L24. A bracket and a leftward arrow given to the lenses L11 to L24 in FIG. 1 indicate that the lenses L11 to L24 are the focus lens group, and indicate a direction in which the focus lens group moves during focusing from the infinite distance object to the short range object. The above illustration method related to the focus lens group also applies to the drawings of other examples. In the drawings of the present application, a plurality of constituents illustrated in one bracket connected to an arrow indicating movement indicate that the plurality of constituents move in an integrated manner. Here, “moving in an integrated manner” means moving at the same time in the same direction by the same amount.

While FIG. 1 shows an example in which the number of focus lens groups included in the fixed-focal-length optical system is only one, the fixed-focal-length optical system may be configured to include two focus lens groups that move on different moving trajectories from each other during focusing. Here, “moving on different moving trajectories from each other” related to the plurality of focus lens groups is synonymous with “moving by changing a mutual spacing”. Moving two focus lens groups by different moving amounts provides an advantage in reducing fluctuation of aberration during focusing.

For example, two focus lens groups that move on different moving trajectories from each other during focusing may be configured to be disposed in the rear group GR. Doing so achieves not only an effect of providing an advantage in reducing fluctuation of aberration during focusing but also an effect of being able to reduce a diameter of the focus lens group by disposing the focus lens group on the image side with respect to the front group GF.

Alternatively, one focus lens group may be configured to be disposed in each of the front group GF and the rear group GR, and the focus lens group of the front group GF and the focus lens group of the rear group GR may be configured to move on different trajectories from each other during focusing. Doing so provides an advantage in further reducing fluctuation of aberration during focusing.

It is preferable that the fixed-focal-length optical system satisfies Conditional Expression (5). A focal length of a focus lens group having the highest refractive power among focus lens groups included in the fixed-focal-length optical system is denoted by ffocmax. A focal length of the fixed-focal-length optical system in the state where the infinite distance object is in focus is denoted by f. Ensuring that a corresponding value of Conditional Expression (5) is not less than or equal to its lower limit value provides an advantage in correcting various types of aberration. Ensuring that the corresponding value of Conditional Expression (5) is not greater than or equal to its upper limit value can secure refractive power of the focus lens group and thus, facilitates reduction of a moving amount of the focus lens group during focusing. This provides an advantage in size reduction.

$$0.2 < \vert ffocmax / f \vert < 3.5 \qquad ( 5 )$$

To obtain more favorable characteristics, the lower limit value of Conditional Expression (5) is more preferably 0.3, further preferably 0.35, further preferably 0.4, further preferably 0.45, and further preferably 0.5. To obtain more favorable characteristics, the upper limit value of Conditional Expression (5) is more preferably 3, further preferably 2.5, further preferably 2, further preferably 1.5, and further preferably 1.

It is preferable that the fixed-focal-length optical system satisfies Conditional Expression (7). A combined focal length of all lenses on the object side with respect to a focus lens group closest to the object side among the focus lens groups included in the fixed-focal-length optical system is denoted by ffocF. The focal length of the fixed-focal-length optical system in the state where the infinite distance object is in focus is denoted by f. Ensuring that a corresponding value of Conditional Expression (7) is not less than or equal to its lower limit value prevents an excessive increase in negative combined refractive power of all lenses on the object side with respect to the focus lens group closest to the object side and thus, can reduce an increase in the optical total length and further provides an advantage in securing a light quantity in the edge part. Ensuring that the corresponding value of Conditional Expression (7) is not greater than or equal to its upper limit value prevents an excessive increase in positive combined refractive power of all lenses on the object side with respect to the focus lens group closest to the object side and thus, provides an advantage in correcting distortion and field curvature.

$$- 2 < f / ffocF < 6 \qquad ( 7 )$$

To obtain more favorable characteristics, the lower limit value of Conditional Expression (7) is more preferably −1.5, further preferably −1.2, further preferably −0.9, further preferably −0.7, further preferably −0.5, further preferably −0.4, and further preferably −0.3. To obtain more favorable characteristics, the upper limit value of Conditional Expression (7) is more preferably 4.5, further preferably 3.5, further preferably 2.5, further preferably 2, further preferably 1.5, further preferably 1.2, and further preferably 0.9.

It is preferable that the fixed-focal-length optical system satisfies Conditional Expression (8). A combined focal length of all lenses on the image side with respect to a focus lens group closest to the image side among the focus lens groups included in the fixed-focal-length optical system is denoted by ffocR. The focal length of the fixed-focal-length optical system in the state where the infinite distance object is in focus is denoted by f. Ensuring that a corresponding value of Conditional Expression (8) is not less than or equal to its lower limit value prevents an excessive increase in negative combined refractive power of all lenses on the image side with respect to the focus lens group closest to the image side and thus, provides an advantage in correcting lateral chromatic aberration. Ensuring that the corresponding value of Conditional Expression (8) is not greater than or equal to its upper limit value prevents an excessive increase in positive combined refractive power of all lenses on the image side with respect to the focus lens group closest to the image side and thus, provides an advantage in correcting distortion and field curvature.

$$- 6 < f / ffocR < 2 \qquad ( 8 )$$

To obtain more favorable characteristics, the lower limit value of Conditional Expression (8) is more preferably −4.5, further preferably −3.5, further preferably −2.5, further preferably −2, further preferably −1.5, further preferably −1.2, and further preferably −0.9. To obtain more favorable characteristics, the upper limit value of Conditional Expression (8) is more preferably 1.5, further preferably 1.2, further preferably 0.9, further preferably 0.7, further preferably 0.5, further preferably 0.4, and further preferably 0.3.

In a configuration in which the number of focus lens groups included in the fixed-focal-length optical system is two, it is preferable that the fixed-focal-length optical system satisfies Conditional Expression (6). Out of the two focus lens groups, a focal length of the focus lens group on the object side is denoted by ff1, and a focal length of the focus lens group on the image side is denoted by ff2. Ensuring that a corresponding value of Conditional Expression (6) is not less than or equal to its lower limit value prevents an excessive increase in refractive power of the focus lens group on the object side and thus, facilitates correction of astigmatism. Ensuring that the corresponding value of Conditional Expression (6) is not greater than or equal to its upper limit value prevents an excessive decrease in the refractive power of the focus lens group on the object side and thus, facilitates correction of field curvature.

$$0 \text{.1} < \vert ff 1 / ff 2 \vert < 10 \qquad ( 6 )$$

To obtain more favorable characteristics, the lower limit value of Conditional Expression (6) is more preferably 0.2, further preferably 0.3, further preferably 0.4, further preferably 0.45, and further preferably 0.5. To obtain more favorable characteristics, the upper limit value of Conditional Expression (6) is more preferably 5, further preferably 4, further preferably 3, further preferably 2, and further preferably 1.

In a configuration in which one focus lens group is disposed in each of the front group GF and the rear group GR, and the focus lens group of the front group GF and the focus lens group of the rear group GR move on different trajectories from each other during focusing, it is preferable that the fixed-focal-length optical system satisfies Conditional Expression (9). The combined focal length of all lenses on the object side with respect to the focus lens group closest to the object side among the focus lens groups included in the fixed-focal-length optical system is denoted by ffocF. A combined focal length from a lens adjacent to the focus lens group of the front group GF on the image side to a lens adjacent to the focus lens group of the rear group GR on the object side is denoted by fM. That is, a combined focal length of all lenses positioned between the focus lens group of the front group GF and the focus lens group of the rear group GR is denoted by fM. Ensuring that a corresponding value of Conditional Expression (9) is not less than or equal to its lower limit value prevents an excessive increase in combined refractive power of all lenses on the object side with respect to the focus lens group closest to the object side and thus, provides an advantage in correcting various types of aberration. Ensuring that the corresponding value of Conditional Expression (9) is not greater than or equal to its upper limit value can reduce an increase in a diameter of a lens on the object side with respect to the focus lens group closest to the object side.

$$0.1 < \vert ffocF / fM \vert < 2 \qquad ( 9 )$$

To obtain more favorable characteristics, the lower limit value of Conditional Expression (9) is more preferably 0.4, further preferably 0.5, further preferably 0.6, and further preferably 0.65. To obtain more favorable characteristics, the upper limit value of Conditional Expression (9) is more preferably 1.2, further preferably 1, further preferably 0.9, and further preferably 0.85.

In the fixed-focal-length optical system, the rear group GR may be configured to include a vibration-proof group that moves in a direction intersecting with the optical axis Z during image shake correction. Disposing the vibration-proof group in the rear group GR facilitates reduction of a diameter of the vibration-proof group. The vibration-proof group may be configured to include at least one specific lens. Doing so provides an advantage in reducing fluctuation of chromatic aberration during image shake correction. It is preferable that the specific lens included in the vibration-proof group satisfies Conditional Expression (3).

In a configuration in which the rear group GR includes the vibration-proof group, it is preferable that the fixed-focal-length optical system satisfies Conditional Expression (10). A focal length of the vibration-proof group is denoted by fIS. The focal length of the fixed-focal-length optical system in the state where the infinite distance object is in focus is denoted by f. Ensuring that a corresponding value of Conditional Expression (10) is not less than or equal to its lower limit value provides an advantage in correcting various types of aberration. Ensuring that the corresponding value of Conditional Expression (10) is not greater than or equal to its upper limit value can secure refractive power of the vibration-proof group and thus, facilitates reduction of a moving amount of the vibration-proof group during image shake correction. This provides an advantage in size reduction.

$$0.05 < \vert fIS / f \vert < 2 \qquad ( 10 )$$

To obtain more favorable characteristics, the lower limit value of Conditional Expression (10) is more preferably 0.1, further preferably 0.15, further preferably 0.2, further preferably 0.25, and further preferably 0.3. To obtain more favorable characteristics, the upper limit value of Conditional Expression (10) is more preferably 1.5, further preferably 1, further preferably 0.7, further preferably 0.5, and further preferably 0.4.

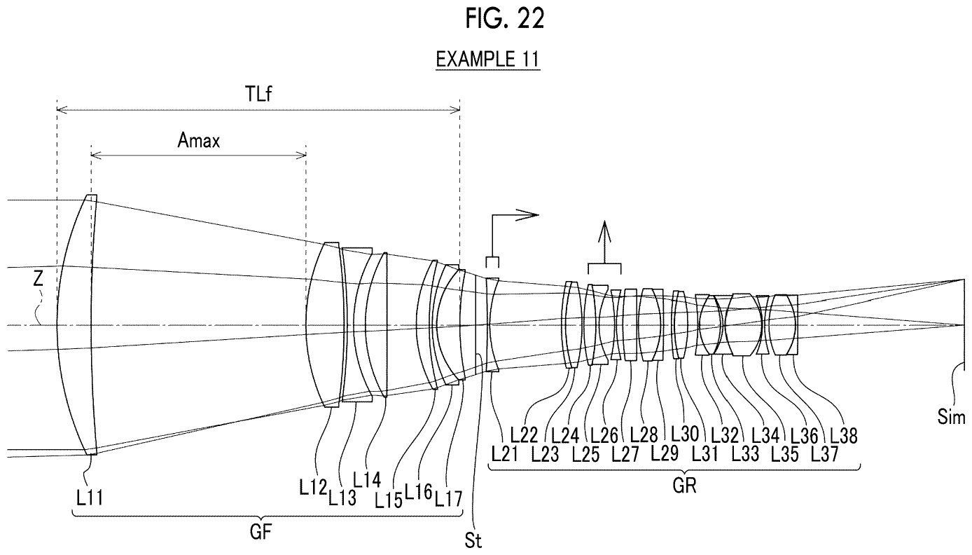

In a configuration in which the maximum half angle of view in the state where the infinite distance object is in focus is 7 degrees or less, it is preferable that the fixed-focal-length optical system satisfies Conditional Expression (11). A maximum value of an air spacing on the optical axis in the front group GF in the state where the infinite distance object is in focus is denoted by Amax. A distance on the optical axis from a lens surface closest to the object side in the front group GF to a lens surface closest to the image side in the front group GF in the state where the infinite distance object is in focus is denoted by TLf. FIG. 22 shows a configuration of a fixed-focal-length optical system of Example 11 in which the maximum half angle of view in the state where the infinite distance object is in focus is 7 degrees or less, and shows, for example, the maximum value Amax of the air spacing and the distance TLf. Ensuring that a corresponding value of Conditional Expression (11) is not less than or equal to its lower limit value can reduce an excessive increase in a weight of the whole optical system. Ensuring that the corresponding value of Conditional Expression (11) is not greater than or equal to its upper limit value facilitates reduction of spherical aberration and axial chromatic aberration.

$$0.2 < Amax / TLf < 0.8 \qquad ( 11 )$$

To obtain more favorable characteristics, the lower limit value of Conditional Expression (11) is more preferably 0.3, further preferably 0.4, and further preferably 0.45. To obtain more favorable characteristics, the upper limit value of Conditional Expression (11) is more preferably 0.7, further preferably 0.65, and further preferably 0.6.

It is preferable that the fixed-focal-length optical system satisfies Conditional Expression (12). An angle, with respect to the optical axis Z, of incidence of a chief ray of a maximum angle of view on an image plane Sim in a state where an object at the longest object distance that can be focused by the fixed-focal-length optical system is denoted by θc. Here, θc is in degree units. For example, in the fixed-focal-length optical system in FIG. 1 the longest object distance that can be focused is an infinite distance. However, Conditional Expression (12) can also be applied to an optical system in which the longest object distance that can be focused is a finite value. For example, the upper part of FIG. 2 shows a chief ray 3c of the maximum angle of view and the angle θc. In FIG. 2, an axis Zp parallel to the optical axis Z is shown by a double dot dash line. Ensuring that a corresponding value of Conditional Expression (12) is not less than or equal to its lower limit value facilitates reduction of a diameter of a lens near the image plane and reduction of the optical total length. Ensuring that the corresponding value of Conditional Expression (12) is not greater than or equal to its upper limit value can reduce a decrease in a light quantity incident on the image plane Sim.

$$0 < \vert θ c \vert < 30 \qquad ( 12 )$$

To obtain more favorable characteristics, the lower limit value of Conditional Expression (12) is more preferably 0.4, further preferably 0.8, further preferably 1.2, further preferably 1.6, further preferably 2, further preferably 2.3, and further preferably 2.5. To obtain more favorable characteristics, the upper limit value of Conditional Expression (12) is more preferably 26, further preferably 23, further preferably 20, further preferably 17, further preferably 14, further preferably 12, and further preferably 10.

It is preferable that the fixed-focal-length optical system satisfies Conditional Expression (13). A paraxial curvature radius of a surface, on the object side, of a lens closest to the object side in the front group GF is denoted by L1f. A paraxial curvature radius of a surface, on the image side, of the lens closest to the object side in the front group GF is denoted by L1r. Conditional Expression (13) is an expression defining a shape factor of the lens. Ensuring that a corresponding value of Conditional Expression (13) is not less than or equal to its lower limit value facilitates correction of astigmatism. Ensuring that the corresponding value of Conditional Expression (13) is not greater than or equal to its upper limit value facilitates favorable correction of spherical aberration and prevents an excessive decrease in refractive power of the lens and thus, facilitates achievement of a wide angle.

$$- 3 < ( L 1 r - L 1 f ) / ( L 1 r + L 1 f ) < 1 \qquad ( 13 )$$

To obtain more favorable characteristics, the lower limit value of Conditional Expression (13) is more preferably −2, further preferably −1, further preferably −0.7, and further preferably −0.5. To obtain more favorable characteristics, the upper limit value of Conditional Expression (13) is more preferably 0.8, further preferably 0.6, further preferably 0.4, and further preferably 0.2.

In a case where an open F-number of the fixed-focal-length optical system in the state where the infinite distance object is in focus is denoted by Fno, it is preferable that the fixed-focal-length optical system satisfies Conditional Expression (14). Ensuring that a corresponding value of Conditional Expression (14) is not less than or equal to its lower limit value facilitates correction of various types of aberration and reduction of the optical total length. Ensuring that the corresponding value of Conditional Expression (14) is not greater than or equal to its upper limit value can secure brightness of the lens system.

$$0.8 < Fno < 3 \qquad ( 14 )$$

To obtain more favorable characteristics, the lower limit value of Conditional Expression (14) is more preferably 0.9, further preferably 0.95, further preferably 1, further preferably 1.05, and further preferably 1.1. To obtain more favorable characteristics, the upper limit value of Conditional Expression (14) is more preferably 2.4, further preferably 2.1, further preferably 1.8, further preferably 1.5, and further preferably 1.3.

In a case where the maximum half angle of view of the fixed-focal-length optical system in the state where the infinite distance object is in focus is denoted by om, it is preferable that the fixed-focal-length optical system satisfies Conditional Expression (15). Here, ωm is in degree units. For example, the upper part of FIG. 2 shows the maximum half angle of view ωm. Ensuring that a corresponding value of Conditional Expression (15) is not less than or equal to its lower limit value can secure a wide angle of view and thus, can provide high added value as an imaging lens system. Ensuring that the corresponding value of Conditional Expression (15) is not greater than or equal to its upper limit value facilitates balancing between optical performance and size reduction.

$$20 < ω m < 50 \qquad ( 15 )$$

To obtain more favorable characteristics, the lower limit value of Conditional Expression (15) is more preferably 21, further preferably 22, further preferably 23, further preferably 24, and further preferably 25. To obtain more favorable characteristics, the upper limit value of Conditional Expression (15) is more preferably 47, further preferably 44, further preferably 41, further preferably 38, and further preferably 36.

The example shown in FIG. 1 is merely an example, and various modifications can be made to the fixed-focal-length optical system of the present disclosure without departing from the gist of the disclosed technology. For example, the number and configurations of lenses included in the front group GF, the rear group GR, and the focus lens group may be different from the example in FIG. 1.

The front group GF may be configured to include, in consecutive order from a position closest to the object side to the image side, a first lens component having positive refractive power, and a second lens component having positive refractive power. In the present specification, one single lens or one cemented lens is one lens component. In a configuration in which the front group GF includes, in consecutive order from the position closest to the object side to the image side, the first lens component and the second lens component, it is preferable that the fixed-focal-length optical system satisfies Conditional Expression (16). A combined focal length of the first lens component and the second lens component is denoted by fp2. Ensuring that a corresponding value of Conditional Expression (16) is not less than or equal to its lower limit value provides an advantage in correcting spherical aberration. Ensuring that the corresponding value of Conditional Expression (16) is not greater than or equal to its upper limit value can reduce overcorrection of spherical aberration.

$$0.8 < f / fp 2 < 10 \qquad ( 16 )$$

To obtain more favorable characteristics, the lower limit value of Conditional Expression (16) is more preferably 1, further preferably 1.2, further preferably 1.4, further preferably 1.6, and further preferably 1.8. To obtain more favorable characteristics, the upper limit value of Conditional Expression (16) is more preferably 8, further preferably 6, further preferably 5, further preferably 4, and further preferably 3.

The front group GF may be configured to include, in consecutive order from the position closest to the object side to the image side, the first lens component having positive refractive power, the second lens component having positive refractive power, and a third lens component having positive refractive power. In a configuration in which the front group GF includes, in consecutive order from the position closest to the object side to the image side, the first lens component, the second lens component, and the third lens component, it is preferable that the fixed-focal-length optical system satisfies Conditional Expression (17). A combined focal length of the first lens component, the second lens component, and the third lens component is denoted by fp3. Ensuring that a corresponding value of Conditional Expression (17) is not less than or equal to its lower limit value provides an advantage in correcting spherical aberration. Ensuring that the corresponding value of Conditional Expression (17) is not greater than or equal to its upper limit value can reduce overcorrection of spherical aberration.

$$1 < f / fp 3 < 10 \qquad ( 17 )$$

To obtain more favorable characteristics, the lower limit value of Conditional Expression (17) is more preferably 1.1, further preferably 1.2, further preferably 1.3, further preferably 1.4, and further preferably 1.5. To obtain more favorable characteristics, the upper limit value of Conditional Expression (17) is more preferably 7.5, further preferably 5.5, further preferably 4, further preferably 3, and further preferably 2.

The front group GF may be configured to include, in consecutive order from a position closest to the object side to the image side, a fourth lens component having negative refractive power, and a fifth lens component having negative refractive power. In a configuration in which the front group GF includes, in consecutive order from the position closest to the object side to the image side, the fourth lens component and the fifth lens component, it is preferable that the fixed-focal-length optical system satisfies Conditional Expression (18). A combined focal length of the fourth lens component and the fifth lens component is denoted by fn2. Ensuring that a corresponding value of Conditional Expression (18) is not less than or equal to its lower limit value provides an advantage in favorable correction of lateral chromatic aberration. Ensuring that the corresponding value of Conditional Expression (18) is not greater than or equal to its upper limit value provides an advantage in favorable correction of various types of aberration such as distortion and field curvature.

$$- 4 < f / fn 2 < - 0.2 \qquad ( 18 )$$

To obtain more favorable characteristics, the lower limit value of Conditional Expression (18) is more preferably −3, further preferably −2, further preferably −1.5, further preferably −1.3, and further preferably −1.1. To obtain more favorable characteristics, the upper limit value of Conditional Expression (18) is more preferably −0.4, further preferably −0.5, further preferably −0.55, further preferably −0.6, and further preferably −0.65.

The front group GF may be configured to include, in consecutive order from the position closest to the object side to the image side, the fourth lens component having negative refractive power, the fifth lens component having negative refractive power, and a sixth lens component having negative refractive power. In a configuration in which the front group GF includes, in consecutive order from the position closest to the object side to the image side, the fourth lens component, the fifth lens component, and the sixth lens component, it is preferable that the fixed-focal-length optical system satisfies Conditional Expression (19). A combined focal length of the fourth lens component, the fifth lens component, and the sixth lens component is denoted by fn3. Ensuring that a corresponding value of Conditional Expression (19) is not less than or equal to its lower limit value provides an advantage in favorable correction of lateral chromatic aberration. Ensuring that the corresponding value of Conditional Expression (19) is not greater than or equal to its upper limit value provides an advantage in favorable correction of various types of aberration such as distortion and field curvature.

$$- 4 < f / fn 3 < - 0.2 \qquad ( 19 )$$

To obtain more favorable characteristics, the lower limit value of Conditional Expression (19) is more preferably −3, further preferably −2, further preferably −1.5, further preferably −1.3, and further preferably −1.1. To obtain more favorable characteristics, the upper limit value of Conditional Expression (19) is more preferably −0.4, further preferably −0.5, further preferably −0.55, further preferably −0.6, and further preferably −0.65.

In a case where a maximum imaging magnification is denoted by β, it is preferable that the fixed-focal-length optical system satisfies Conditional Expression (20). The maximum imaging magnification is an imaging magnification in a case where a nearest object (that is, an object at the shortest object distance that can be focused) is imaged. Ensuring that a corresponding value of Conditional Expression (20) is not less than or equal to its lower limit value can reduce narrowing of an imageable region of the optical system and thus, can secure added value suitable for the imaging lens system. Ensuring that the corresponding value of Conditional Expression (20) is not greater than or equal to its upper limit value can reduce the moving amount of the focus lens group during focusing and thus, can contribute to size reduction of the optical system.

$$0.05 < \vert β \vert < 1.1 \qquad ( 20 )$$

To obtain more favorable characteristics, the lower limit value of Conditional Expression (20) is more preferably 0.09, further preferably 0.12, further preferably 0.15, further preferably 0.18, further preferably 0.21, further preferably 0.24, and further preferably 0.27. To obtain more favorable characteristics, the upper limit value of Conditional Expression (20) is more preferably 1, further preferably 0.9, further preferably 0.8, further preferably 0.75, further preferably 0.7, further preferably 0.67, and further preferably 0.65.

Preferable configurations and available configurations described above can be used in any combination without contradiction and are preferably appropriately selected and adopted in accordance with required specifications.

For example, a preferable aspect of the fixed-focal-length optical system of the present disclosure is a fixed-focal-length optical system consisting of, in order from the object side to the image side, the front group GF, the aperture stop St, and the rear group GR, in which the fixed-focal-length optical system includes at least one specific lens that is a lens satisfying Conditional Expressions (1) and (2).

Next, each example of the fixed-focal-length optical system of the present disclosure will be described with reference to the drawings. Reference numerals given to each lens and each group in the cross-sectional views of each example are independently used for each example to avoid complication of description and illustration caused by an increase in the number of digits of the reference numerals. Accordingly, a common reference numeral given in the drawings of different examples does not necessarily indicate a common configuration.

### Example 1

A cross-sectional view of a configuration of the fixed-focal-length optical system of Example 1 is shown in FIG. 1, and its illustration method and configuration are described above. Thus, duplicate descriptions will be partially omitted. The fixed-focal-length optical system consists of, in order from the object side to the image side, the front group GF having positive refractive power, the aperture stop St, and the rear group GR having positive refractive power. The fixed-focal-length optical system includes only one focus lens group. The focus lens group consists of the lenses L11 to L13, the aperture stop St, and the lenses L21 to L24 and moves to the object side during focusing from the infinite distance object to the short range object.

For the fixed-focal-length optical system of Example 1, Table 1 shows basic lens data, Table 2 shows specifications and variable surface spacings, and Table 3 shows aspherical coefficients.

The table of the basic lens data is described as follows. A column of “Sn” shows surface numbers in a case where a surface closest to the object side is set as a first surface, and the number is increased by one at a time to the image side. A column of “R” shows a curvature radius of each surface. A column of “D” shows a surface spacing on the optical axis between each surface and a surface adjacent to each surface on the image side. A column of “Nd” shows a refractive index at a d line for each lens. A column of “νd” shows an Abbe number based on the d line for each lens. A column of “θgF” shows a partial dispersion ratio between a g line and an F line for each lens. A column of “ED” shows an effective diameter of each surface.

A column of “Material” in the table of the basic lens data, including the tables of the examples described later, is described as follows. The column of “Material” of the specific lens shows any of “N231.Glass”, “N216.Glass”, or “N200.Glass”. Glass described in p. 40 to 42 of the manuscript of the 49th Optical Symposium (duration: Jun. 20 and 21, 2024, host: The Optical Society of Japan, a general incorporated association) can be used as “N231.Glass”, “N216.Glass”, and “N200.Glass”.

For lenses other than the specific lens, the column of “Material” shows “Plastic” for a resin lens and shows a material name before “.” and a manufacturer company name after “.” for other lenses. The table schematically shows the manufacturer company name as follows. “OHARA” indicates OHARA INC. “CDGM” indicates Chengdu Guangming Guangdian Co., Ltd. “HOYA” indicates HOYA Corporation. “HIKARI” indicates HIKARI GLASS Co., Ltd. “SUMITA” indicates Sumita Optical Industries Ltd. “NHG” indicates Hubei New Huaguang Information Materials Co., Ltd.

In the table of the basic lens data, a sign of the curvature radius of a surface having a convex shape facing the object side is positive, and a sign of the curvature radius of a surface having a convex shape facing the image side is negative. A field of the surface number of a surface corresponding to the aperture stop St shows the surface number and a text (St). A value in a lowermost field of the column of D in the table is a spacing between a surface closest to the image side in the table and the image plane Sim. A symbol DD [ ] is used for the variable surface spacings during focusing. In the column of the surface number, a surface number on the object side of the spacing is shown within [ ].

Table 2 shows the focal length, a back focus, the open F-number, a maximum full angle of view, and the variable surface spacings of the fixed-focal-length optical system based on a d line. In a field of the maximum full angle of view, [°] indicates that the maximum full angle of view is in degree units. In Table 2, a column of “Infinite Distance” shows each value in the state where the infinite distance object is in focus, and a column of “Short Range −0.1×” shows each value in a state where the short range object with the imaging magnification of −0.1× is in focus. In the table of specifications, the imaging magnification in a state where the nearest object is in focus is shown with “x” after the text of short range.

In the basic lens data, the surface number of an aspherical surface is marked with * and a field of the curvature radius of the aspherical surface shows a numerical value of a paraxial curvature radius. In Table 3, a column of Sn shows the surface number of the aspherical surface, and columns of KA and Am show numerical values of the aspherical coefficients for each aspherical surface. Here, m in Am is an integer greater than or equal to 3 and varies depending on the surface. For example, m=4, 6, 8, 10, 12, 14, 16, and 18 is established for a thirteenth surface of Example 1. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a sum total related to m.

In the data of each table, a degree unit is used for angles, and a millimeter (mm) unit is used for lengths. However, since the optical system can also be proportionally enlarged or proportionally reduced to be used, other appropriate units can also be used. Each table below shows numerical values rounded to predetermined digits.

TABLE 1
Example 1

| Sn | R | D | Nd | νd | θgF | Material | ED |
|---|---|---|---|---|---|---|---|
| 1 | 32.2191 | 5.750 | 2.00266 | 31.67 | 0.5851 | N200.Glass | 43.16 |
| 2 | 73.8349 | 0.050 | | | | | 43.16 |
| 3 | 20.3028 | 7.017 | 1.61800 | 63.33 | 0.5441 | S-PHM52.OHARA | 38.00 |
| 4 | 60.4846 | 0.785 | 1.85478 | 24.80 | 0.6123 | S-NBH56.OHARA | 31.21 |
| 5 | 14.3995 | 7.648 | | | | | 29.04 |
| 6 (St) | ∞ | 6.657 | | | | | 29.03 |
| 7 | −31.7040 | 3.119 | 1.43875 | 94.66 | 0.5340 | S-FPL55.OHARA | 22.99 |
| 8 | −15.8925 | 2.510 | 1.67270 | 32.10 | 0.5989 | S-TIM25.OHARA | 21.09 |
| 9 | −57.1681 | 1.000 | | | | | 21.20 |
| 10 | −349.7259 | 0.760 | 1.63980 | 34.47 | 0.5923 | S-TIM27.OHARA | 21.20 |
| 11 | 55.0724 | 5.250 | 1.88300 | 39.22 | 0.5729 | H-ZLAF68N.CDGM | 24.40 |
| 12 | −35.1341 | DD[12] | | | | | 26.39 |
| *13 | 119.5889 | 6.733 | 1.76450 | 49.10 | 0.5529 | L-LAH91.OHARA | 26.40 |
| *14 | −21.9010 | 0.112 | | | | | 27.00 |
| *15 | −17.3140 | 5.000 | 1.53409 | 55.87 | 0.5586 | Plastic | 29.15 |
| *16 | −94.8295 | 3.145 | | | | | 30.00 |
| *17 | −17.0734 | 3.211 | 1.53409 | 55.87 | 0.5586 | Plastic | 30.40 |
| *18 | −25.1485 | 17.391 | | | | | 31.55 |

TABLE 2
Example 1

| | Infinite Distance | Short Range −0.1x |
|---|---|---|
| Focal Length | 52.07 | 54.76 |
| Back Focus | 17.391 | 17.391 |
| Open F-Number | 1.45 | 1.99 |
| Maximum Full Angle | 45.2 | 39.6 |
| of View [°] | | |
| DD[12] | 0.100 | 8.574 |

TABLE 3
Example 1

| Sn | 13 | 14 | 15 | 18 |
|---|---|---|---|---|
| KA | 1.0000000E+00 | 1.0000000E+00 | 1.0000000E+00 | 1.0000000E+00 |
| A4 | −1.9423698E−05 | 1.3843005E−05 | 1.3479316E−04 | 1.2612987E−04 |
| A6 | 6.0189033E−08 | 5.2372889E−07 | −1.9317437E−07 | −2.7493822E−07 |
| A8 | −1.2033974E−09 | −2.6808002E−09 | 1.9384999E−09 | 1.2302116E−09 |
| A10 | 5.7922587E−12 | 4.2643069E−12 | −1.8372463E−12 | −6.0890729E−12 |
| A12 | −1.6697460E−14 | 1.8528911E−14 | −1.8781620E−14 | 1.3678234E−14 |
| A14 | 1.5861338E−16 | −1.9351030E−17 | −1.0537380E−18 | −7.4618359E−18 |
| A16 | −6.1138222E−19 | −2.6675431E−19 | 1.9296833E−19 | 3.3558261E−20 |
| A18 | 4.7981403E−22 | 3.8543028E−22 | −1.9361444E−22 | −1.4205150E−22 |

| Sn | 16 | 17 |
|---|---|---|
| KA | 1.0000000E+00 | 1.0000000E+00 |
| A4 | 1.1710126E−04 | 1.9302307E−04 |
| A6 | −8.3745710E−07 | −3.6563416E−07 |
| A8 | 4.1868078E−09 | 1.1874014E−09 |
| A10 | −8.2231560E−12 | −1.4917064E−12 |

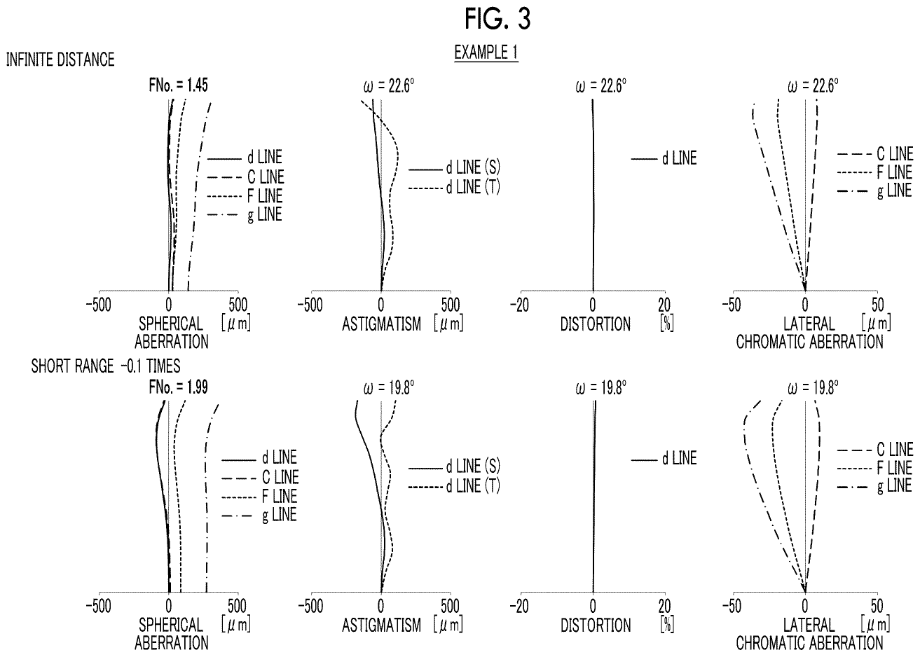

FIG. 3 shows each aberration diagram of the fixed-focal-length optical system of Example 1. FIG. 3 shows spherical aberration, astigmatism, distortion, and lateral chromatic aberration in order from the left. In FIG. 3, an upper part labeled “INFINITE DISTANCE” shows each aberration diagram in the state where the infinite distance object is in focus, and a lower part labeled “SHORT RANGE −0.1×” shows each aberration diagram in the state where the short range object with the imaging magnification of −0.1× is in focus. Lower parts of the aberration diagrams show aberration in a state where the imaging magnification shown in the table of the specifications is set. In the spherical aberration diagram, aberration on a d line, a C line, an F line, and a g line is shown by a solid line, a long broken line, a short broken line, and a dot dash line, respectively. In the astigmatism diagram, aberration on a d line in a sagittal direction is shown by a solid line, and aberration on a d line in a tangential direction is shown by a short broken line. In the distortion diagram, aberration on a d line is shown by a solid line. In the lateral chromatic aberration diagram, aberration on a C line, an F line, and a g line is shown by a long broken line, a short broken line, and a dot dash line, respectively. In the spherical aberration diagram, a value of the open F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise specified. Thus, duplicate descriptions will be omitted below.

### Example 2

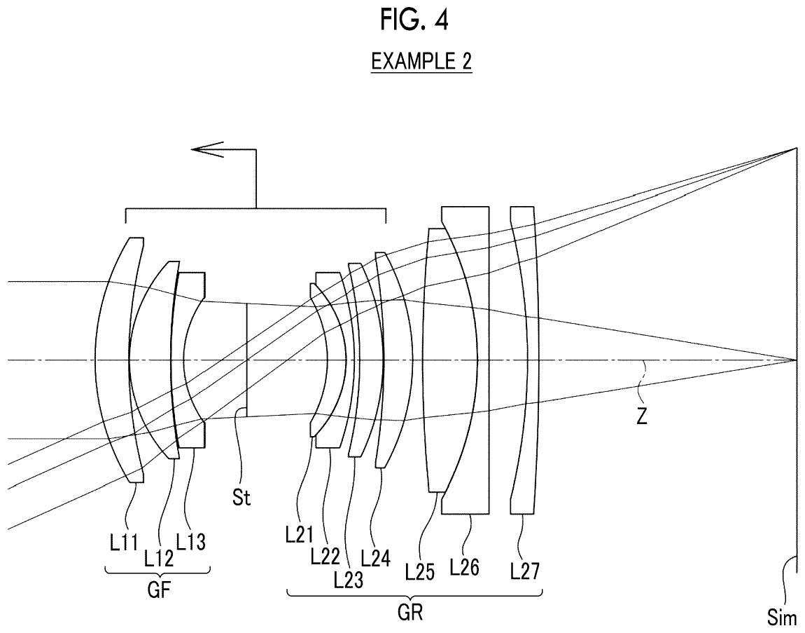

FIG. 4 shows a cross-sectional view of a configuration and luminous fluxes of a fixed-focal-length optical system of Example 2. The fixed-focal-length optical system consists of, in order from the object side to the image side, the front group GF having positive refractive power, the aperture stop St, and the rear group GR having positive refractive power. The front group GF consists of, in order from the object side to the image side, three lenses including the lenses L11 to L13. The rear group GR consists of, in order from the object side to the image side, seven lenses including the lenses L21 to L27. The fixed-focal-length optical system includes only one focus lens group. The focus lens group consists of the lenses L11 to L13, the aperture stop St, and the lenses L21 to L24 and moves to the object side during focusing from the infinite distance object to the short range object.

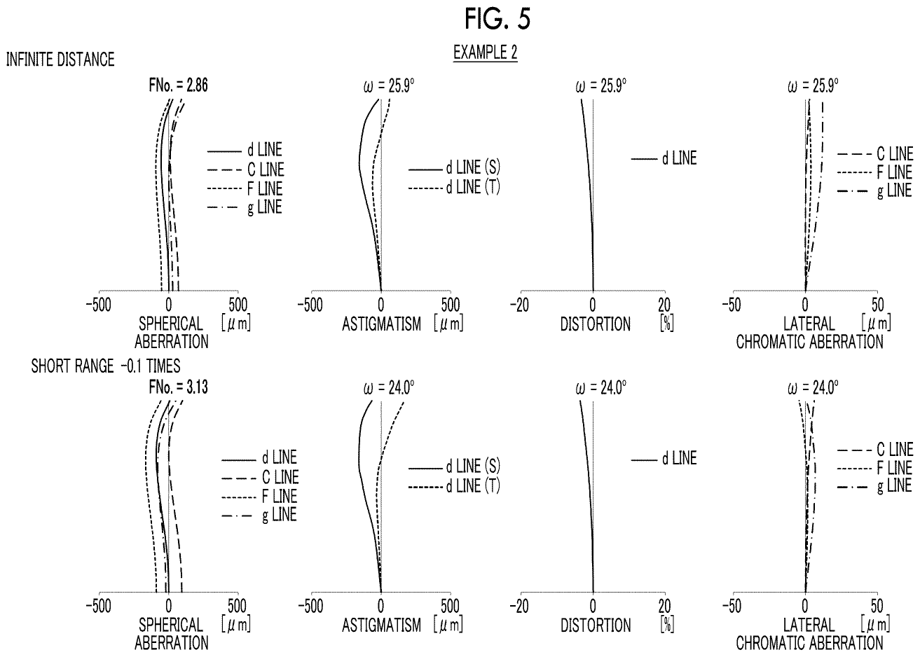

For the fixed-focal-length optical system of Example 2, Table 4 shows basic lens data, Table 5 shows specifications and variable surface spacings, and FIG. 5 shows each aberration diagram.

TABLE 4
Example 2

| Sn | R | D | Nd | νd | θgF | Material | ED |
|---|---|---|---|---|---|---|---|
| 1 | 34.3262 | 4.275 | 2.00266 | 31.67 | 0.5851 | N200.Glass | 31.67 |
| 2 | 66.8687 | 0.072 | | | | | 29.59 |
| 3 | 20.8023 | 5.210 | 1.48749 | 70.24 | 0.5301 | S-FSL5.OHARA | 25.00 |
| 4 | 81.5070 | 0.050 | | | | | 22.18 |
| 5 | 71.4296 | 1.600 | 1.69895 | 30.13 | 0.6030 | S-TIM35.OHARA | 21.80 |
| 6 | 15.4525 | 7.908 | | | | | 17.25 |
| 7 (St) | ∞ | 10.211 | | | | | 15.52 |
| 8 | −18.1789 | 2.360 | 1.59282 | 68.62 | 0.5441 | FCD515.HOYA | 16.78 |
| 9 | −15.6330 | 1.050 | 1.59270 | 35.31 | 0.5934 | S-FTM16.OHARA | 18.56 |
| 10 | −39.9853 | 0.680 | | | | | 21.90 |
| 11 | −59.5014 | 2.960 | 1.78800 | 47.37 | 0.5560 | S-LAH64.OHARA | 23.84 |
| 12 | −32.4883 | 0.100 | | | | | 25.56 |
| 13 | −93.3949 | 3.650 | 1.81600 | 46.62 | 0.5568 | S-LAH59.OHARA | 27.80 |
| 14 | −32.4022 | DD[14] | | | | | 28.85 |
| 15 | 200.7689 | 6.930 | 1.69680 | 55.53 | 0.5434 | S-LAL14.OHARA | 34.59 |
| 16 | −42.0100 | 1.470 | 1.60342 | 38.03 | 0.5836 | S-TIM5.OHARA | 35.24 |
| 17 | ∞ | 4.870 | | | | | 36.54 |
| 18 | −85.0921 | 1.440 | 1.51633 | 64.14 | 0.5353 | S-BSL7.OHARA | 37.63 |
| 19 | −328.1791 | 32.592 | | | | | 38.87 |

TABLE 5
Example 2

| | Infinite | |
|---|---|---|
| | Distance | Short Range −0.1x |
| Focal Length | 61.65 | 62.23 |
| Back Focus | 32.592 | 32.592 |
| Open F-Number | 2.86 | 3.13 |
| Maximum Full Angle of View [°] | 51.8 | 48.0 |
| DD[14] | 1.260 | 8.733 |

### Example 3

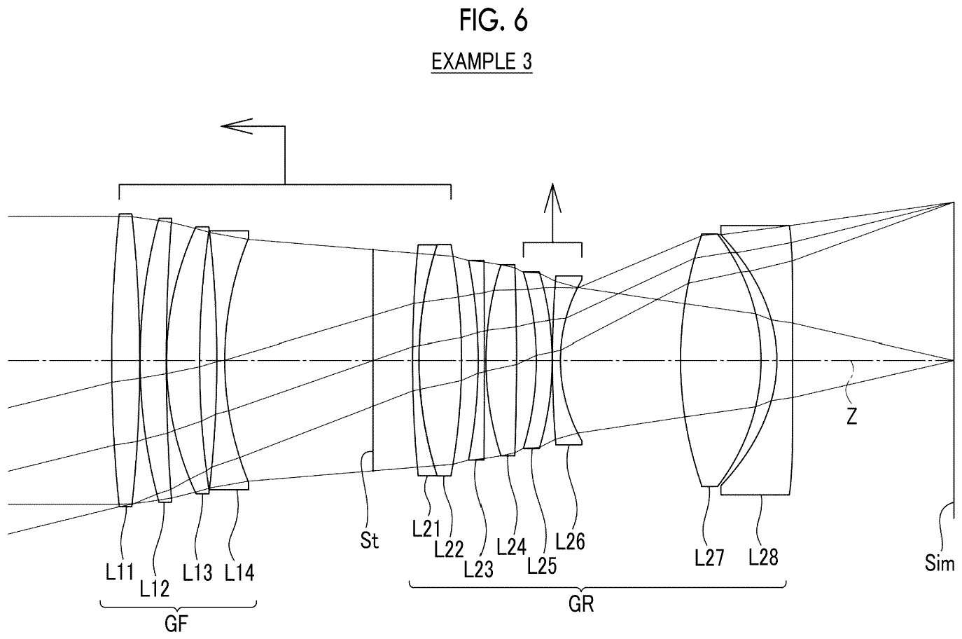

FIG. 6 shows a cross-sectional view of a configuration and luminous fluxes of a fixed-focal-length optical system of Example 3. The fixed-focal-length optical system consists of, in order from the object side to the image side, the front group GF having positive refractive power, the aperture stop St, and the rear group GR having positive refractive power. The front group GF consists of, in order from the object side to the image side, four lenses including lenses L11 to L14. The rear group GR consists of, in order from the object side to the image side, eight lenses including lenses L21 to L28. The fixed-focal-length optical system includes only one focus lens group. The focus lens group consists of the lenses L11 to L14, the aperture stop St, and the lenses L21 and L22 and moves to the object side during focusing from the infinite distance object to the short range object. The vibration-proof group consists of the lenses L25 and L26. In FIG. 6, a bracket and an upward arrow are given to lenses corresponding to the vibration-proof group. The above illustration method related to the vibration-proof group also applies to the drawings of other examples.

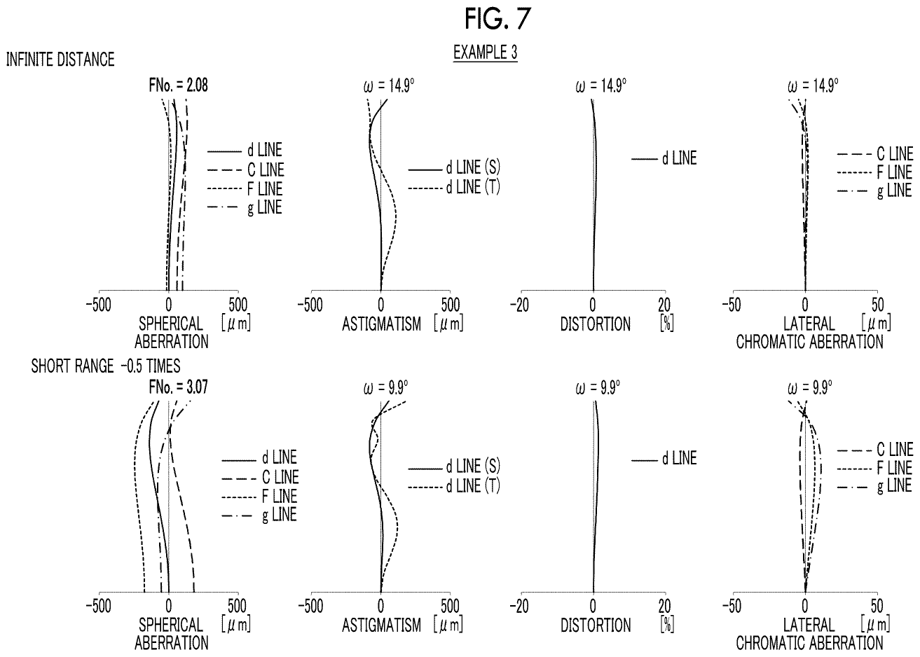

For the fixed-focal-length optical system of Example 3, Table 6 shows basic lens data, Table 7 shows specifications and variable surface spacings, Table 8 shows aspherical coefficients, and FIG. 7 shows each aberration diagram.

TABLE 6
Example 3

| Sn | R | D | Nd | νd | θgF | Material | ED |
|---|---|---|---|---|---|---|---|
| 1 | 212.3631 | 3.539 | 1.75500 | 52.32 | 0.5476 | S-LAH97.OHARA | 40.00 |
| 2 | −199.8287 | 0.050 | | | | | 39.86 |
| 3 | 80.2666 | 3.300 | 1.65160 | 58.54 | 0.5390 | S-LAL7Q.OHARA | 38.79 |
| 4 | 272.7531 | 0.050 | | | | | 38.17 |
| 5 | 46.6946 | 4.169 | 1.43875 | 94.66 | 0.5340 | S-FPL55.OHARA | 36.47 |
| 6 | 132.5706 | 2.180 | | | | | 35.41 |
| 7 | −166.5526 | 1.000 | 1.59551 | 39.24 | 0.5804 | S-TIM8.OHARA | 35.37 |
| 8 | 47.7867 | 18.750 | | | | | 33.40 |
| 9 (St) | ∞ | 5.000 | | | | | 30.36 |
| 10 | 174.5972 | 0.814 | 1.80518 | 25.42 | 0.6162 | S-TIH6.OHARA | 31.48 |
| 11 | 55.4090 | 5.383 | 1.80400 | 46.53 | 0.5578 | S-LAH65VS.OHARA | 31.54 |
| 12 | −93.8306 | DD[12] | | | | | 31.59 |
| 13 | −76.9405 | 0.714 | 1.60342 | 38.03 | 0.5836 | S-TIM5.OHARA | 27.22 |
| 14 | −2017.0270 | 0.200 | | | | | 26.82 |
| 15 | 46.0369 | 3.862 | 2.00266 | 31.67 | 0.5851 | N200.Glass | 26.06 |
| 16 | −384.9515 | 2.500 | | | | | 25.23 |
| 17 | −45.0603 | 1.997 | 2.16217 | 21.24 | 0.6276 | N216.Glass | 24.00 |
| 18 | −45.7024 | 0.050 | | | | | 24.14 |
| 19 | 157.1923 | 1.000 | 1.90525 | 35.04 | 0.5849 | S-LAH93.OHARA | 23.04 |
| 20 | 23.6399 | 15.199 | | | | | 22.00 |
| 21 | 56.2019 | 10.176 | 1.60300 | 65.44 | 0.5402 | S-PHM53.OHARA | 34.00 |
| 22 | −29.7345 | 2.000 | | | | | 34.51 |
| *23 | −21.6017 | 2.000 | 1.51633 | 64.06 | 0.5334 | L-BSL7.OHARA | 34.29 |
| *24 | 4559.2227 | 20.376 | | | | | 36.77 |

TABLE 7
Example 3

| | Infinite | |
|---|---|---|
| | Distance | Short Range −0.5x |
| Focal Length | 81.50 | 70.66 |
| Back Focus | 20.376 | 20.376 |
| Open F-Number | 2.08 | 3.07 |
| Maximum Full Angle of View [°] | 29.8 | 19.8 |
| DD[12] | 2.100 | 30.612 |

TABLE 8
Example 3

| Sn | 23 | 24 |
|---|---|---|
| KA | 1.0000000E+00 | 1.0000000E+00 |
| A4 | 7.5063632E−06 | −1.1811228E−06 |
| A6 | 4.6799678E−08 | −3.2770292E−09 |
| A8 | −1.6625416E−10 | −3.6213924E−11 |
| A10 | 3.5468015E−13 | 6.3262953E−14 |

### Example 4

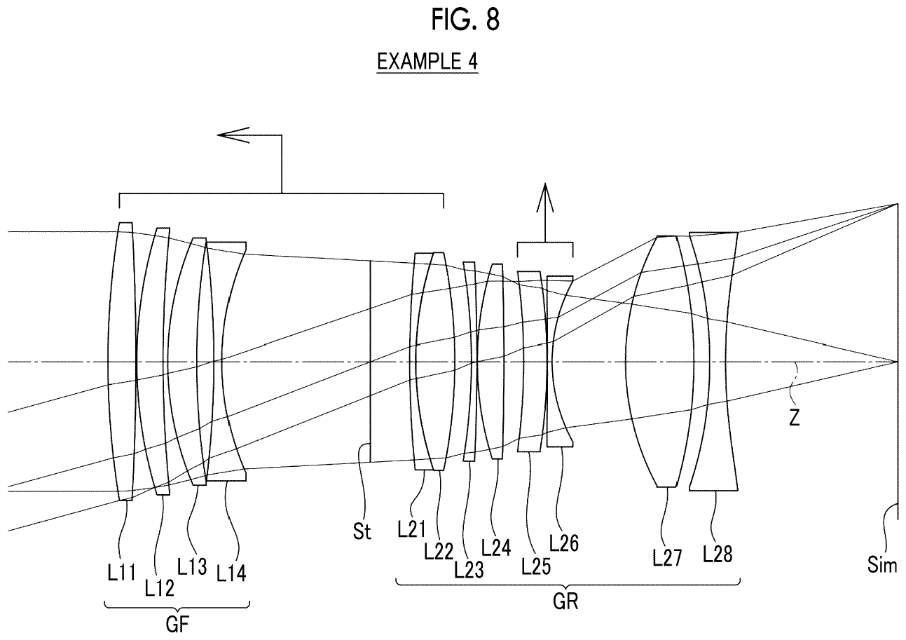

FIG. 8 shows a cross-sectional view of a configuration and luminous fluxes of a fixed-focal-length optical system of Example 4. The fixed-focal-length optical system consists of, in order from the object side to the image side, the front group GF having positive refractive power, the aperture stop St, and the rear group GR having positive refractive power. The front group GF consists of, in order from the object side to the image side, four lenses including the lenses L11 to L14. The rear group GR consists of, in order from the object side to the image side, eight lenses including the lenses L21 to L28. The fixed-focal-length optical system includes only one focus lens group. The focus lens group consists of the lenses L11 to L14, the aperture stop St, and the lenses L21 and L22 and moves to the object side during focusing from the infinite distance object to the short range object. The vibration-proof group consists of the lenses L25 and L26.

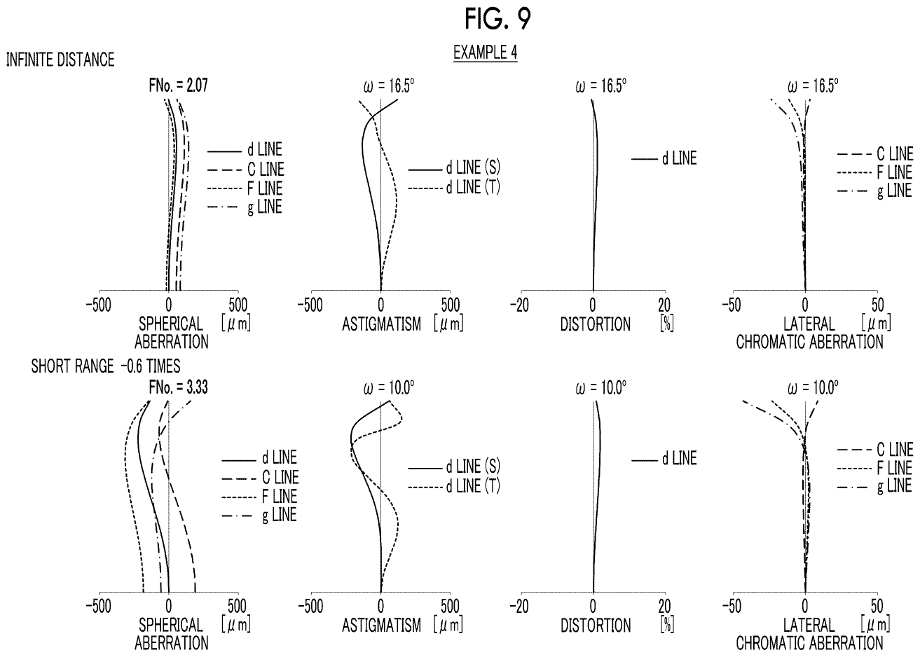

For the fixed-focal-length optical system of Example 4, Table 9 shows basic lens data, Table 10 shows specifications and variable surface spacings, Table 11 shows aspherical coefficients, and FIG. 9 shows each aberration diagram.

TABLE 9
Example 4

| Sn | R | D | Nd | νd | θgF | Material | ED |
|---|---|---|---|---|---|---|---|
| 1 | 124.7815 | 3.545 | 1.75500 | 52.32 | 0.5476 | S-LAH97.OHARA | 38.00 |
| 2 | −366.8188 | 0.122 | | | | | 37.72 |
| 3 | 66.6434 | 3.322 | 1.65160 | 58.54 | 0.5390 | S-LAL7Q.OHARA | 36.50 |
| 4 | 194.2757 | 0.588 | | | | | 35.76 |
| 5 | 46.0942 | 3.675 | 1.43875 | 94.66 | 0.5340 | S-FPL55.OHARA | 33.83 |
| 6 | 114.5541 | 2.167 | | | | | 32.70 |
| 7 | −143.0553 | 1.000 | 1.59551 | 39.24 | 0.5804 | S-TIM8.OHARA | 32.65 |
| 8 | 40.3443 | 18.750 | | | | | 30.55 |
| 9 (St) | ∞ | 5.000 | | | | | 27.53 |
| 10 | 160.5759 | 0.765 | 1.80518 | 25.42 | 0.6162 | S-TIH6.OHARA | 29.40 |
| 11 | 50.1781 | 4.940 | 1.80400 | 46.53 | 0.5578 | S-LAH65VS.OHARA | 29.63 |
| 12 | −79.2507 | DD[12] | | | | | 29.75 |
| 13 | −89.3964 | 0.709 | 1.60342 | 38.03 | 0.5836 | S-TIM5.OHARA | 27.21 |
| 14 | −317.6076 | 0.050 | | | | | 27.08 |
| 15 | 47.9414 | 3.370 | 2.00266 | 31.67 | 0.5851 | N200.Glass | 26.64 |
| 16 | −459.9702 | 2.500 | | | | | 26.14 |
| 17 | −97.9307 | 2.954 | 2.16217 | 21.24 | 0.6276 | N216.Glass | 24.63 |
| 18 | −86.0075 | 0.049 | | | | | 24.05 |
| 19 | −1611.7610 | 0.607 | 1.90525 | 35.04 | 0.5849 | S-LAH93.OHARA | 23.34 |
| 20 | 24.2942 | 9.301 | | | | | 22.00 |
| 21 | 38.3097 | 8.592 | 1.60300 | 65.44 | 0.5402 | S-PHM53.OHARA | 33.95 |
| 22 | −67.4655 | 2.000 | | | | | 34.34 |
| *23 | −62.4692 | 2.000 | 1.51633 | 64.06 | 0.5334 | L-BSL7.OHARA | 34.25 |
| *24 | 80.0187 | 21.838 | | | | | 35.34 |

TABLE 10
Example 4

| | Infinite | |
|---|---|---|
| | Distance | Short Range −0.6x |
| Focal Length | 73.17 | 63.10 |
| Back Focus | 21.838 | 21.838 |
| Open F-Number | 2.07 | 3.33 |
| Maximum Full Angle of View [°] | 33.0 | 20.0 |
| DD[12] | 2.100 | 38.025 |

TABLE 11
Example 4

| Sn | 23 | 24 |
|---|---|---|
| KA | 1.0000000E+00 | 1.0000000E+00 |
| A4 | −3.8991520E−06 | −5.3985449E−07 |
| A6 | 1.4096532E−08 | −1.9809215E−08 |
| A8 | −3.5381398E−11 | 3.5045712E−11 |
| A10 | 3.7656602E−14 | −3.1428810E−14 |

### Example 5

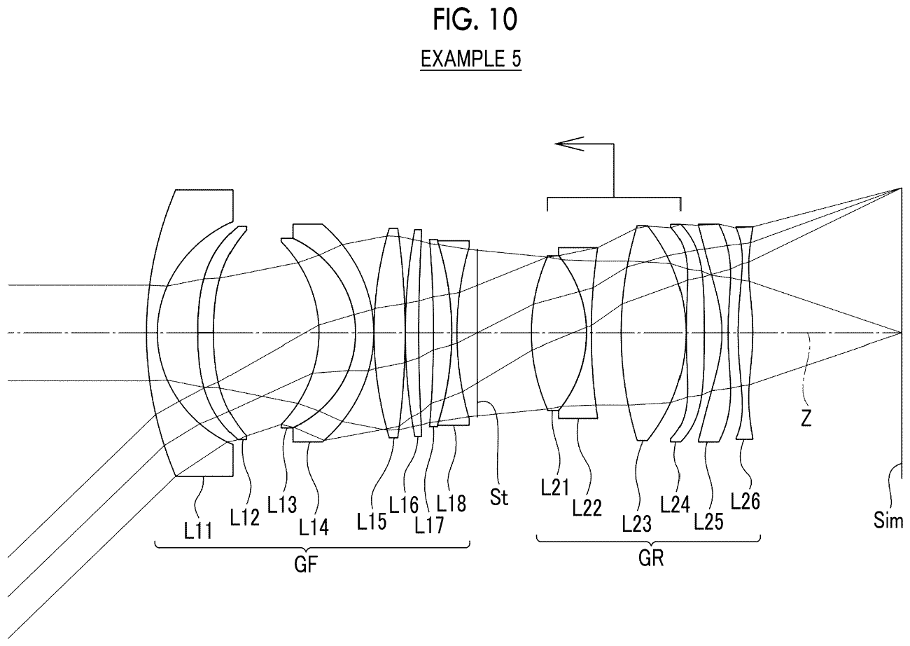

FIG. 10 shows a cross-sectional view of a configuration and luminous fluxes of a fixed-focal-length optical system of Example 5. The fixed-focal-length optical system consists of, in order from the object side to the image side, the front group GF having positive refractive power, the aperture stop St, and the rear group GR having positive refractive power. The front group GF consists of, in order from the object side to the image side, eight lenses including lenses L11 to L18. The rear group GR consists of, in order from the object side to the image side, six lenses including the lenses L21 to L26. The fixed-focal-length optical system includes only one focus lens group. The focus lens group consists of the lenses L21 to L24 and moves to the object side during focusing from the infinite distance object to the short range object.

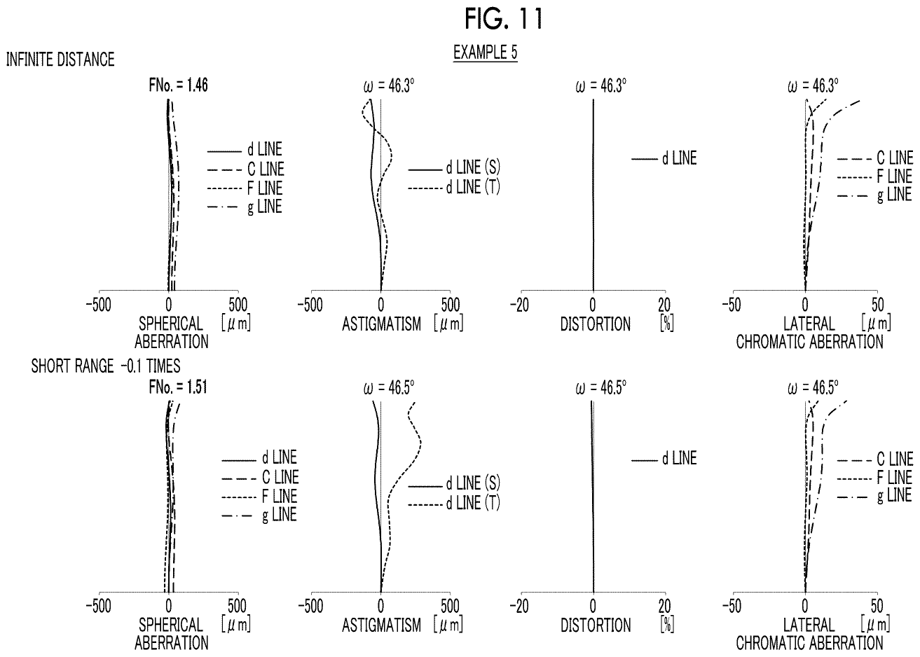

For the fixed-focal-length optical system of Example 5, Table 12 shows basic lens data, Table 13 shows specifications and variable surface spacings, Table 14 shows aspherical coefficients, and FIG. 11 shows each aberration diagram.

TABLE 12
Example 5

| Sn | R | D | Nd | νd | θgF | Material | ED |
|---|---|---|---|---|---|---|---|
| 1 | 58.4385 | 1.500 | 1.70154 | 41.24 | 0.5766 | S-BAH27.OHARA | 42.68 |
| 2 | 18.4680 | 5.585 | | | | | 32.45 |
| *3 | 54.2099 | 2.164 | 1.49700 | 81.54 | 0.5375 | S-FPL51.OHARA | 31.74 |
| *4 | 52.1408 | 14.505 | | | | | 30.62 |
| 5 | −20.3335 | 5.066 | 1.88300 | 39.22 | 0.5729 | H-ZLAF68N.CDGM | 27.20 |
| 6 | −15.8261 | 2.500 | 2.30909 | 17.89 | 0.6452 | N231.Glass | 28.22 |
| 7 | −22.0555 | 0.045 | | | | | 32.43 |
| 8 | 59.0814 | 4.285 | 2.16217 | 21.24 | 0.6276 | N216.Glass | 31.20 |
| 9 | −120.2475 | DD[9] | | | | | 30.99 |
| 10 | 91.9374 | 1.849 | 1.59522 | 67.73 | 0.5443 | S-FPM2.OHARA | 29.40 |
| 11 | 276.7228 | DD[11] | | | | | 28.82 |
| 12 | −179.2254 | 2.526 | 1.88300 | 39.22 | 0.5729 | H-ZLAF68N.CDGM | 27.86 |
| 13 | −48.7019 | 0.721 | 1.69895 | 30.13 | 0.6030 | S-TIM35.OHARA | 27.47 |
| 14 | 49.1829 | 2.824 | | | | | 25.46 |
| 15 (St) | ∞ | DD[15] | | | | | 24.99 |
| 16 | 30.0197 | 7.625 | 1.43875 | 94.66 | 0.5340 | S-FPL55.OHARA | 22.60 |
| 17 | −19.1588 | 0.659 | 1.69895 | 30.13 | 0.6030 | S-TIM35.OHARA | 23.03 |
| 18 | 92.4917 | 4.120 | | | | | 25.43 |
| 19 | 58.9178 | 8.893 | 1.53775 | 74.70 | 0.5394 | S-FPM3.OHARA | 31.24 |
| 20 | −26.8735 | 0.032 | | | | | 31.87 |
| *21 | 98.7921 | 2.490 | 1.95150 | 29.83 | 0.5956 | MP-TAFD405.HOYA | 31.42 |
| *22 | −230.0646 | DD[22] | | | | | 32.40 |
| *23 | −20.1030 | 0.835 | 1.68948 | 31.02 | 0.5987 | L-TIM28.OHARA | 32.09 |
| *24 | 50.3282 | 1.403 | | | | | 32.44 |
| *25 | 58.1406 | 2.014 | 1.85400 | 40.38 | 0.5689 | L-LAH85V.OHARA | 31.29 |
| *26 | −38.0320 | 20.582 | | | | | 31.64 |

TABLE 13
Example 5

| | Infinite | |
|---|---|---|
| | Distance | Short Range −0.1x |
| Focal Length | 20.70 | 20.23 |
| Back Focus | 20.582 | 20.582 |
| Open F-Number | 1.46 | 1.51 |
| Maximum Full Angle of View [°] | 92.6 | 93.0 |
| DD[9] | 0.038 | 0.038 |
| DD[11] | 2.032 | 2.032 |
| DD[15] | 7.459 | 5.996 |
| DD[22] | 2.437 | 3.900 |

TABLE 14
Example 5

| Sn | 3 | 4 | 21 | 22 |
|---|---|---|---|---|
| KA | 1.0000000E+00 | 1.0000000E+00 | 1.0000000E+00 | 1.0000000E+00 |
| A4 | 5.7705938E−05 | 5.5708426E−05 | −2.8614881E−05 | −1.7031552E−05 |
| A6 | −9.1925147E−08 | −1.2082437E−07 | −5.7214924E−08 | −6.5952952E−08 |
| A8 | 3.0251490E−10 | 3.8746309E−10 | −3.8921881E−10 | −2.0635069E−10 |
| A10 | −2.5866883E−13 | −6.7061304E−13 | 7.7327800E−13 | 5.3483700E−13 |
| Sn | 23 | 24 | 25 | 26 |
| KA | 1.0000000E+00 | 1.0000000E+00 | 1.0000000E+00 | 1.0000000E+00 |
| A4 | 9.9864074E−05 | −7.6951011E−05 | −2.0065224E−05 | 9.1065731E−05 |
| A6 | −1.0919599E−07 | 7.8120183E−08 | −1.3190475E−07 | −9.2389426E−08 |
| A8 | −2.7248494E−10 | −1.3032194E−11 | 2.2632139E−10 | −4.3255682E−10 |
| A10 | 1.0441941E−12 | 1.6656460E−15 | −1.2308463E−13 | 9.2511074E−13 |

### Example 6

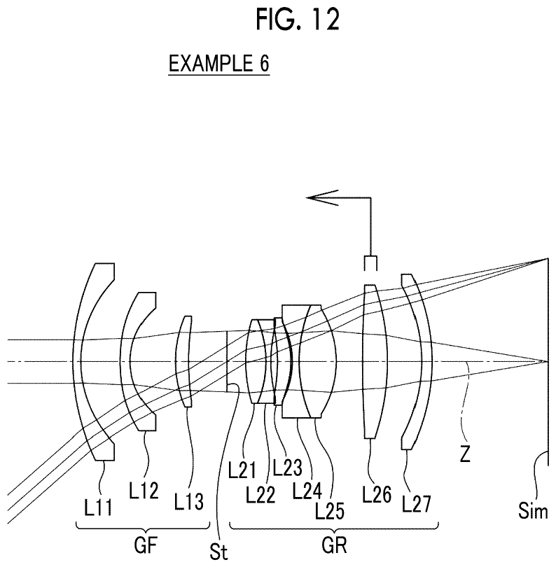

FIG. 12 shows a cross-sectional view of a configuration and luminous fluxes of a fixed-focal-length optical system of Example 6. The fixed-focal-length optical system consists of, in order from the object side to the image side, the front group GF having negative refractive power, the aperture stop St, and the rear group GR having positive refractive power. The front group GF consists of, in order from the object side to the image side, three lenses including the lenses L11 to L13. The rear group GR consists of, in order from the object side to the image side, seven lenses including the lenses L21 to L27. The fixed-focal-length optical system includes only one focus lens group. The focus lens group consists of the lens L26 and moves to the object side during focusing from the infinite distance object to the short range object.

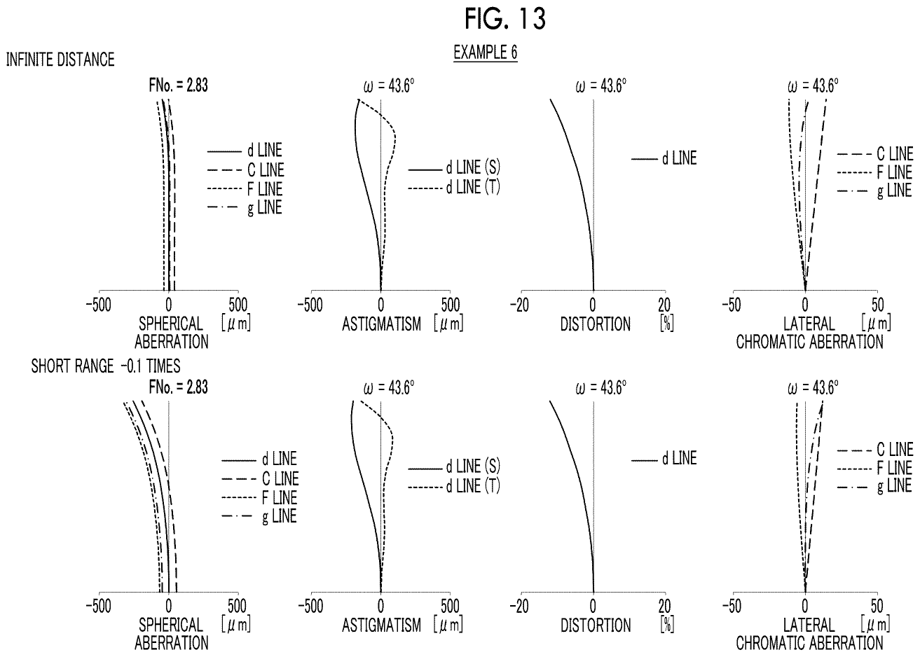

For the fixed-focal-length optical system of Example 6, Table 15 shows basic lens data, Table 16 shows specifications and variable surface spacings, Table 17 shows aspherical coefficients, and FIG. 13 shows each aberration diagram.

TABLE 15
Example 6

| Sn | R | D | Nd | νd | θgF | Material | ED |
|---|---|---|---|---|---|---|---|
| 1 | 33.3558 | 1.000 | 1.53996 | 59.72 | 0.5445 | H-BAK2.CDGM | 24.25 |
| 2 | 17.0104 | 5.000 | | | | | 20.93 |
| *3 | 27.9259 | 1.250 | 1.51633 | 64.06 | 0.5334 | L-BSL7.OHARA | 16.66 |
| *4 | 11.0756 | 5.700 | | | | | 13.89 |
| 5 | 17.0625 | 1.660 | 1.72916 | 54.68 | 0.5445 | S-LAL18.OHARA | 10.44 |
| 6 | 39.8785 | 4.866 | | | | | 9.59 |
| 7 (St) | ∞ | 2.385 | | | | | 8.34 |
| 8 | 21.7185 | 2.560 | 2.00266 | 31.67 | 0.5851 | N200.Glass | 9.31 |
| 9 | −15.9381 | 0.640 | 1.72916 | 54.68 | 0.5445 | S-LAL18.OHARA | 9.23 |
| 10 | 22.3381 | 0.831 | | | | | 9.08 |
| *11 | −24.6776 | 1.690 | 1.58313 | 59.38 | 0.5424 | L-BAL42.OHARA | 9.06 |
| *12 | −12.5742 | 0.203 | | | | | 9.90 |
| 13 | −12.2044 | 0.850 | 1.84666 | 23.78 | 0.6205 | S-TIH53.OHARA | 9.92 |
| 14 | 21.0220 | 4.720 | 1.72916 | 54.68 | 0.5445 | S-LAL18.OHARA | 12.29 |
| 15 | −14.5619 | DD[15] | | | | | 14.18 |
| 16 | 174.8995 | 3.160 | 1.83481 | 42.74 | 0.5649 | S-LAH55VS.OHARA | 18.79 |
| 17 | −35.4106 | DD[17] | | | | | 19.39 |
| 18 | −23.3523 | 1.320 | 2.16217 | 21.24 | 0.6276 | N216.Glass | 20.17 |
| 19 | −29.4007 | 14.761 | | | | | 21.17 |

TABLE 16
Example 6

| | Infinite | |
|---|---|---|
| | Distance | Short Range −0.1x |
| Focal Length | 16.94 | 16.34 |
| Back Focus | 14.761 | 14.761 |
| Open F-Number | 2.83 | 2.83 |
| Maximum Full Angle of View [°] | 87.2 | 87.2 |
| DD[15] | 3.339 | 1.704 |
| DD[17] | 4.272 | 5.907 |

TABLE 17
Example 6

| Sn | 3 | 4 | 11 | 12 |
|---|---|---|---|---|
| KA | 1.0000000E+00 | 1.0000000E+00 | 1.0000000E+00 | 1.0000000E+00 |
| A4 | 2.0475055E−04 | 2.2955992E−04 | 1.9239198E−05 | 1.4097228E−04 |
| A6 | −2.8858581E−06 | −2.8272217E−06 | 3.6727167E−07 | 5.1002854E−07 |
| A8 | 2.6924719E−08 | 2.6938117E−08 | 1.5572212E−07 | 1.3065139E−07 |
| A10 | −1.1080869E−10 | −1.4157104E−10 | −1.0598583E−09 | −2.3152786E−10 |

### Example 7

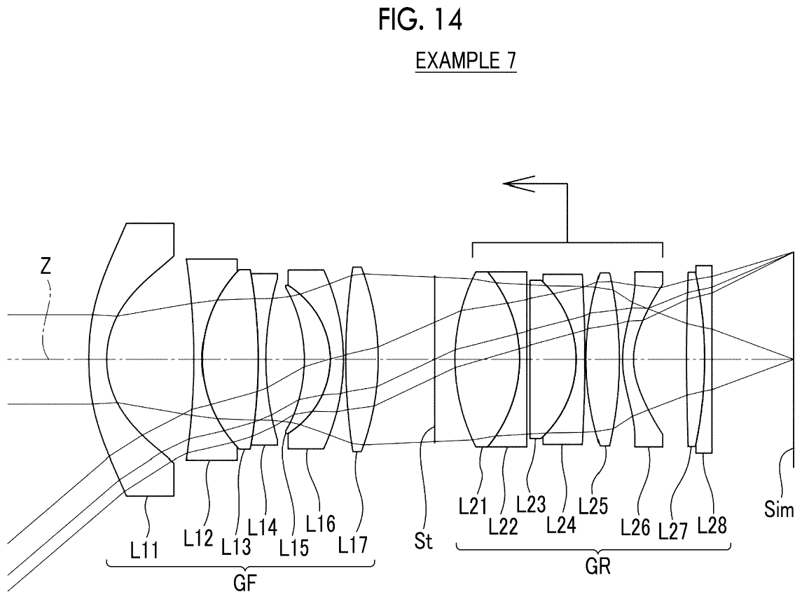

FIG. 14 shows a cross-sectional view of a configuration and luminous fluxes of a fixed-focal-length optical system of Example 7. The fixed-focal-length optical system consists of, in order from the object side to the image side, the front group GF having positive refractive power, the aperture stop St, and the rear group GR having positive refractive power. The front group GF consists of, in order from the object side to the image side, seven lenses including the lenses L11 to L17. The rear group GR consists of, in order from the object side to the image side, eight lenses including the lenses L21 to L28. The fixed-focal-length optical system includes only one focus lens group. The focus lens group consists of the lenses L21 to L26 and moves to the object side during focusing from the infinite distance object to the short range object.

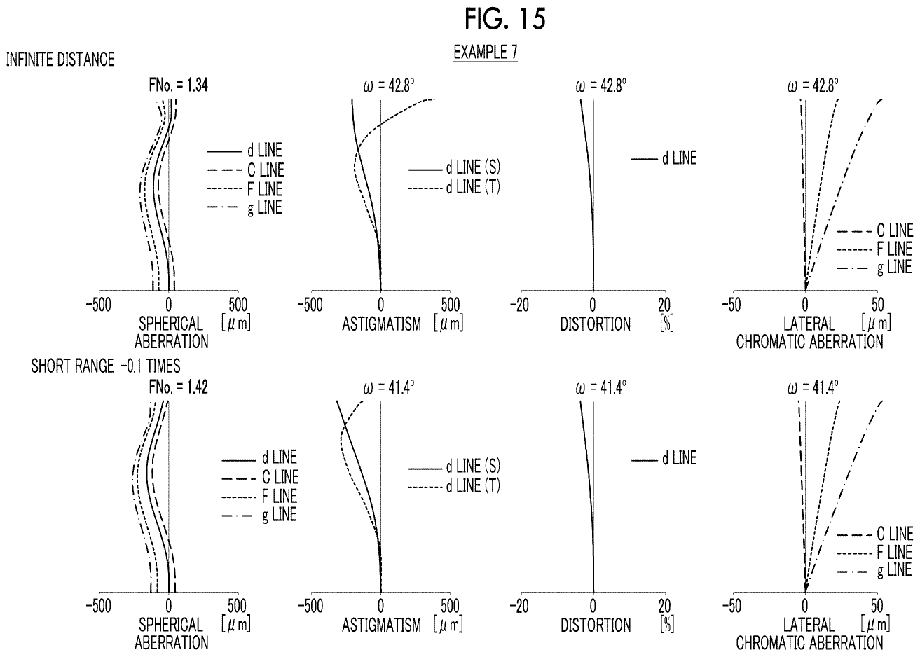

For the fixed-focal-length optical system of Example 7, Table 18 shows basic lens data, Table 19 shows specifications and variable surface spacings, Table 20 shows aspherical coefficients, and FIG. 15 shows each aberration diagram.

TABLE 18
Example 7

| Sn | R | D | Nd | νd | θgF | Material | ED |
|---|---|---|---|---|---|---|---|
| *1 | 42.5066 | 2.260 | 1.58313 | 59.46 | 0.5406 | M-BACD12.HOYA | 36.05 |
| *2 | 14.3565 | 11.029 | | | | | 27.78 |
| 3 | −100.1648 | 1.020 | 1.58313 | 59.46 | 0.5429 | H-ZK2.CDGM | 25.65 |
| 4 | 18.6299 | 7.050 | 1.89190 | 37.13 | 0.5781 | S-LAH92.OHARA | 23.05 |
| 5 | −75.4980 | 0.970 | 1.48749 | 70.44 | 0.5293 | H-QK3L.CDGM | 21.78 |
| 6 | 42.5062 | 4.867 | | | | | 19.52 |
| *7 | −22.4273 | 3.280 | 1.58913 | 61.15 | 0.5382 | L-BAL35.OHARA | 18.42 |
| 8 | −12.3432 | 1.660 | 2.00266 | 31.67 | 0.5851 | N200.Glass | 18.68 |
| 9 | −31.3711 | 0.300 | | | | | 21.47 |
| 10 | 89.0372 | 4.110 | 1.95375 | 32.31 | 0.5907 | H-ZLAF89L.CDGM | 23.59 |
| 11 | −38.4770 | 7.139 | | | | | 23.88 |
| 12 (St) | ∞ | DD[12] | | | | | 22.54 |
| 13 | 28.6629 | 8.180 | 1.59282 | 68.62 | 0.5441 | FCD515.HOYA | 22.07 |
| 14 | −19.7999 | 0.910 | 1.85451 | 25.15 | 0.6103 | NBFD25.HOYA | 20.99 |
| 15 | ∞ | 0.401 | | | | | 20.53 |
| 16 | ∞ | 5.850 | 1.77250 | 49.60 | 0.5516 | H-LAF50B.CDGM | 20.52 |
| 17 | −15.4540 | 1.090 | 1.85451 | 25.15 | 0.6103 | NBFD25.HOYA | 20.49 |
| 18 | −209.9846 | 0.139 | | | | | 20.89 |
| 19 | 41.6316 | 4.160 | 2.16217 | 21.24 | 0.6276 | N216.Glass | 21.90 |
| 20 | −57.3197 | 0.400 | | | | | 21.93 |
| *21 | 16.1711 | 1.386 | 1.80610 | 40.73 | 0.5694 | M-NBFD130.HOYA | 20.67 |
| *22 | 11.0173 | DD[22] | | | | | 19.80 |
| 23 | 363.2443 | 2.280 | 1.60300 | 65.46 | 0.5407 | H-ZPK2A.CDGM | 21.67 |
| 24 | −62.1067 | 0.920 | 1.84666 | 23.78 | 0.6192 | FDS90-SG.HOYA | 22.05 |
| 25 | ∞ | 10.359 | | | | | 22.70 |

TABLE 19
Example 7

| | Infinite | |
|---|---|---|
| | Distance | Short Range −0.1x |
| Focal Length | 16.46 | 16.35 |
| Back Focus | 10.359 | 10.359 |
| Open F-Number | 1.34 | 1.42 |
| Maximum Full Angle of View [°] | 85.6 | 82.8 |
| DD[12] | 2.578 | 1.002 |
| DD[22] | 6.718 | 8.294 |

TABLE 20
Example 7

| Sn | 1 | 2 | 7 | 21 |
|---|---|---|---|---|
| KA | 3.8510739E+00 | −4.3296751E+00 | −4.8908378E−01 | −5.0000027E+00 |
| A3 | 0.0000000E+00 | 0.0000000E+00 | 0.0000000E+00 | 0.0000000E+00 |
| A4 | 8.2101298E−05 | 3.1069943E−04 | −2.0245660E−05 | −1.5689881E−05 |
| A5 | −9.5739997E−06 | −1.0193003E−05 | 5.6543052E−06 | −6.5802732E−06 |
| A6 | 5.9588626E−07 | −9.9029127E−07 | −2.4338268E−06 | −6.9255100E−07 |
| A7 | −3.0455959E−08 | 7.4165898E−09 | 4.5621132E−07 | 1.4479909E−08 |
| A8 | −1.9480492E−09 | 5.8171636E−09 | −3.4597779E−08 | 1.4122715E−08 |
| A9 | 4.0864450E−10 | 1.7037688E−10 | −2.3925488E−09 | −3.4964926E−10 |
| A10 | −1.4919699E−11 | −1.6321215E−11 | 3.7150512E−10 | −7.5590845E−11 |
| A11 | −1.8257720E−13 | −1.4903567E−12 | 3.9066924E−11 | 6.1173246E−12 |
| A12 | −2.7147724E−14 | −2.8746210E−13 | −6.3944827E−12 | −9.6603698E−13 |
| A13 | 3.4618551E−15 | 5.1753338E−14 | −1.9955542E−13 | 7.7251258E−14 |
| A14 | −2.7227826E−18 | −2.5285882E−15 | 7.4206532E−14 | 1.1107596E−15 |
| A15 | −6.6705344E−18 | 4.0808858E−17 | −4.3654680E−15 | −3.0214962E−16 |
| A16 | 1.4994304E−19 | −8.7993111E−21 | 7.9424441E−17 | 7.8465436E−18 |

| Sn | 22 |
|---|---|
| KA | −1.4211109E+00 |
| A3 | 0.0000000E+00 |
| A4 | 3.0065970E−05 |
| A5 | −1.9431301E−05 |
| A6 | 3.3138973E−06 |
| A7 | −4.3716353E−07 |
| A8 | 2.8105186E−08 |
| A9 | 1.7441042E−09 |
| A10 | −1.5417488E−10 |
| A11 | −2.3068826E−11 |
| A12 | 1.2815061E−12 |
| A13 | 2.3110962E−13 |
| A14 | −2.7371328E−14 |
| A15 | 1.2010839E−15 |
| A16 | −2.1499728E−17 |

### Example 8

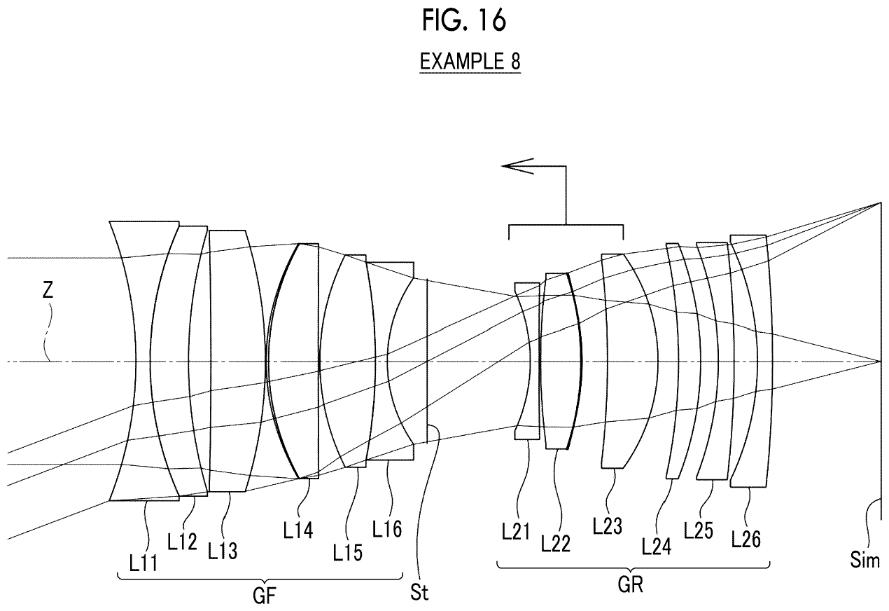

FIG. 16 shows a cross-sectional view of a configuration and luminous fluxes of a fixed-focal-length optical system of Example 8. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, six lenses including the lenses L21 to L26. The fixed-focal-length optical system includes only one focus lens group. The focus lens group consists of the lenses L21 to L23 and moves to the object side during focusing from the infinite distance object to the short range object.

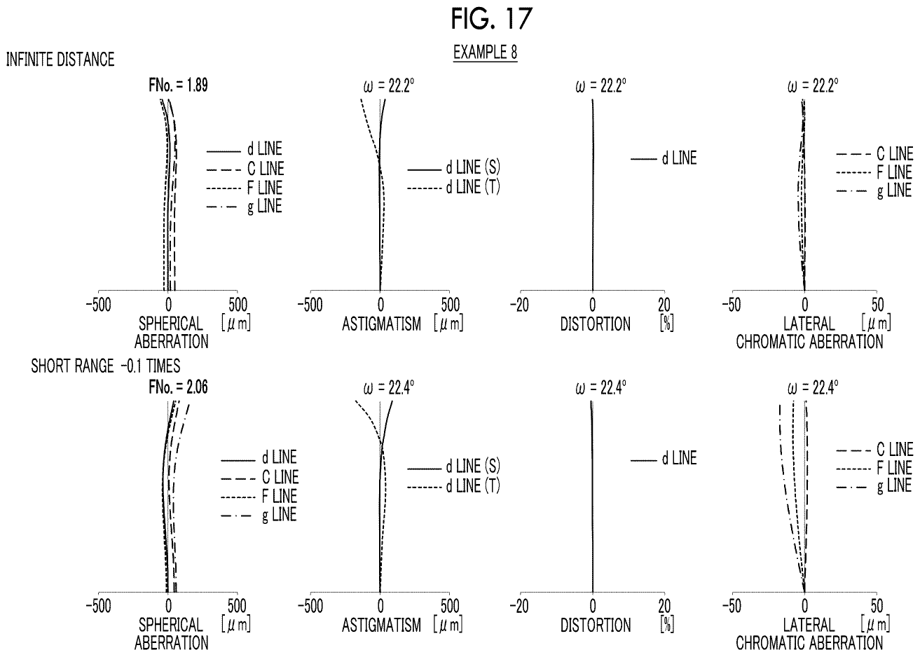

For the fixed-focal-length optical system of Example 8, Table 21 shows basic lens data, Table 22 shows specifications and variable surface spacings, Table 23 shows aspherical coefficients, and FIG. 17 shows each aberration diagram. In the table of the basic lens data, both sides of the surface number of a surface corresponding to a composite aspherical surface of a composite aspherical lens are marked with *.

TABLE 21
Example 8

| Sn | R | D | Nd | νd | θgF | Material | ED |
|---|---|---|---|---|---|---|---|
| 1 | −55.2083 | 1.800 | 1.63980 | 34.47 | 0.5923 | S-TIM27.OHARA | 38.06 |
| 2 | 47.9065 | 4.852 | 2.30909 | 17.89 | 0.6452 | N231.Glass | 36.79 |
| 3 | 67.7771 | 2.830 | | | | | 35.58 |
| 4 | −757.1676 | 6.805 | 1.75500 | 52.32 | 0.5476 | S-LAH97.OHARA | 35.57 |
| 5 | −63.1384 | 0.100 | | | | | 35.47 |
| *6* | 32.3715 | 0.300 | 1.56093 | 36.60 | 0.5809 | Plastic | 32.00 |
| 7 | 34.7866 | 6.291 | 1.75500 | 52.32 | 0.5476 | S-LAH97.OHARA | 31.97 |
| 8 | 3421.8081 | 0.200 | | | | | 31.09 |
| 9 | 34.2134 | 7.021 | 1.59522 | 67.73 | 0.5443 | S-FPM2.OHARA | 28.89 |
| 10 | −76.8072 | 1.500 | 1.63980 | 34.47 | 0.5923 | S-TIM27.OHARA | 26.90 |
| 11 | 20.9054 | 5.045 | | | | | 22.60 |
| 12 (St) | ∞ | DD[12] | | | | | 21.92 |
| 13 | −23.9982 | 1.100 | 1.67270 | 32.10 | 0.5989 | S-TIM25.OHARA | 19.00 |
| 14 | 814.4503 | 0.200 | | | | | 21.30 |
| 15 | 93.4478 | 5.100 | 1.80400 | 46.53 | 0.5578 | S-LAH65VS.OHARA | 22.47 |
| 16 | −40.1605 | 0.152 | 1.56093 | 36.60 | 0.5809 | Plastic | 23.88 |
| *17* | −34.6067 | 3.204 | | | | | 24.00 |
| 18 | −128.3014 | 6.400 | 1.49700 | 81.54 | 0.5375 | S-FPL51.OHARA | 27.49 |
| 19 | −26.3128 | DD[19] | | | | | 29.15 |
| 20 | −80.3395 | 2.798 | 2.30909 | 17.89 | 0.6452 | N231.Glass | 31.56 |
| 21 | −46.6253 | 2.232 | | | | | 32.06 |
| 22 | −46.7396 | 2.000 | 1.67270 | 32.10 | 0.5989 | S-TIM25.OHARA | 31.63 |
| 23 | −150.5524 | 2.958 | | | | | 32.33 |
| 24 | −40.0000 | 1.900 | 1.67270 | 32.10 | 0.5989 | S-TIM25.OHARA | 32.39 |
| 25 | −179.8713 | 13.521 | | | | | 34.37 |

TABLE 22
Example 8

| | Infinite | |
|---|---|---|
| | Distance | Short Range −0.1x |
| Focal Length | 52.86 | 47.28 |
| Back Focus | 13.521 | 13.521 |
| Open F-Number | 1.89 | 2.06 |
| Maximum Full Angle of View [°] | 44.4 | 44.8 |
| DD[12] | 13.036 | 7.304 |
| DD[19] | 2.500 | 8.232 |

TABLE 23
Example 8

| Sn | 6 | 17 |
|---|---|---|
| KA | 1.0000000E+00 | 1.0000000E+00 |
| A4 | −1.8236900E−06 | 1.6171100E−05 |
| A6 | −1.7372600E−09 | 1.1089900E−08 |
| A8 | 2.0073500E−12 | 3.8196400E−11 |
| A10 | −4.3270000E−15 | −1.1994900E−13 |

### Example 9

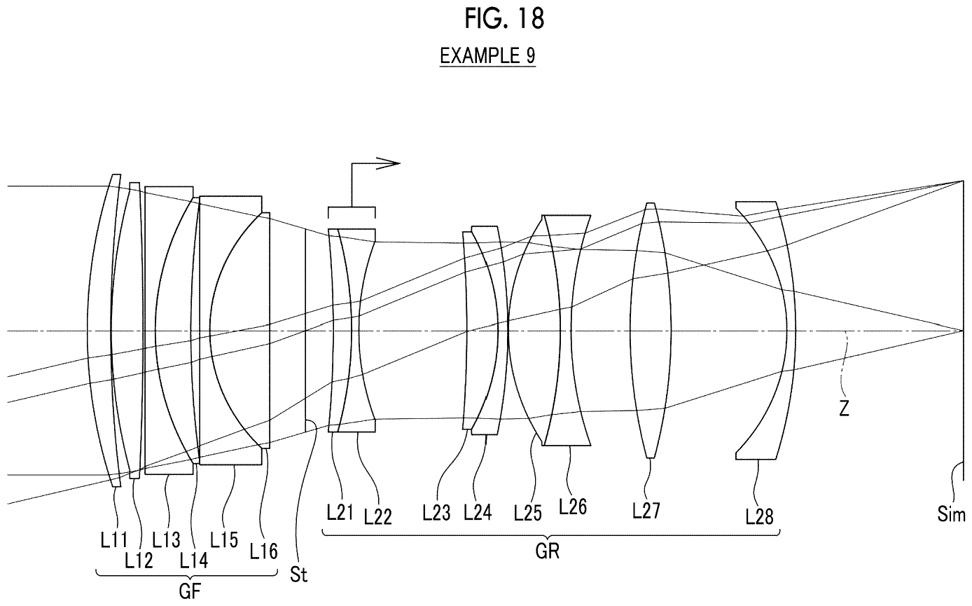

FIG. 18 shows a cross-sectional view of a configuration and luminous fluxes of a fixed-focal-length optical system of Example 9. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, eight lenses including the lenses L21 to L28. The fixed-focal-length optical system includes only one focus lens group. The focus lens group consists of the lenses L21 and L22 and moves to the image side during focusing from the infinite distance object to the short range object.

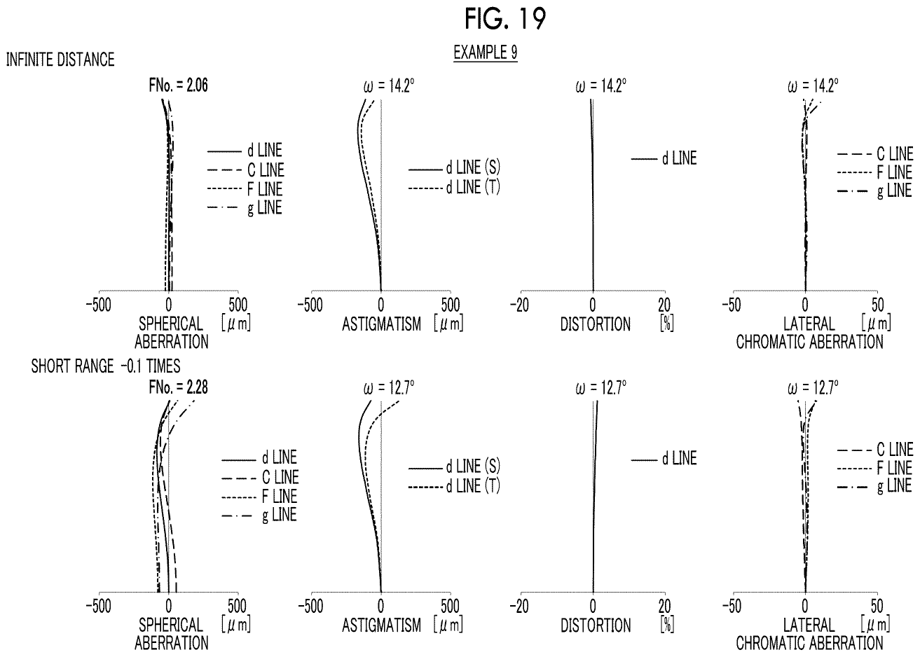

For the fixed-focal-length optical system of Example 9, Table 24 shows basic lens data, Table 25 shows specifications and variable surface spacings, and FIG. 19 shows each aberration diagram.

TABLE 24
Example 9

| Sn | R | D | Nd | νd | θgF | Material | ED |
|---|---|---|---|---|---|---|---|
| 1 | 97.2976 | 3.950 | 2.00266 | 31.67 | 0.5851 | N200.Glass | 54.51 |
| 2 | 241.2192 | 0.100 | | | | | 53.66 |
| 3 | 106.1474 | 5.320 | 1.55032 | 75.50 | 0.5400 | FCD705.HOYA | 52.00 |
| 4 | −625.6445 | 0.360 | | | | | 51.29 |
| 5 | ∞ | 1.730 | 1.56732 | 42.81 | 0.5757 | H-QF56.CDGM | 50.60 |
| 6 | 49.3830 | 5.980 | 1.88300 | 39.22 | 0.5729 | H-ZLAF68N.CDGM | 47.15 |
| 7 | 192.1886 | 1.490 | | | | | 46.41 |
| 8 | ∞ | 1.700 | 1.63980 | 34.46 | 0.5924 | H-F51.CDGM | 46.34 |
| 9 | 30.7780 | 10.100 | 1.55032 | 75.50 | 0.5400 | FCD705.HOYA | 41.68 |
| 10 | 8 | 6.010 | | | | | 40.90 |
| 11 (St) | ∞ | DD[11] | | | | | 37.05 |
| 12 | −201.6144 | 3.070 | 2.30909 | 17.89 | 0.6452 | N231.Glass | 34.53 |
| 13 | −74.4524 | 1.220 | 1.85150 | 40.78 | 0.5696 | S-LAH89.OHARA | 34.23 |
| 14 | 49.7977 | DD[14] | | | | | 32.33 |
| 15 | −230.3817 | 5.180 | 1.55032 | 75.50 | 0.5400 | FCD705.HOYA | 32.44 |
| 16 | −39.2300 | 1.630 | 1.68893 | 31.16 | 0.6000 | H-ZF10.CDGM | 32.69 |
| 17 | −102.2608 | 0.100 | | | | | 33.40 |
| 18 | 39.2188 | 8.750 | 1.59282 | 68.62 | 0.5441 | FCD515.HOYA | 37.35 |
| 19 | −82.6540 | 1.800 | 1.90366 | 31.34 | 0.5964 | S-LAH95.OHARA | 37.25 |
| 20 | 67.7479 | 9.960 | | | | | 37.46 |
| 21 | 98.0103 | 6.894 | 2.00266 | 31.67 | 0.5851 | N200.Glass | 44.22 |
| 22 | −97.2882 | 19.510 | | | | | 44.40 |
| 23 | −33.2876 | 1.470 | 1.51680 | 64.20 | 0.5359 | H-K9L.CDGM | 41.73 |
| 24 | −84.0655 | 28.286 | | | | | 44.13 |

TABLE 25
Example 9

| | Infinite | |
|---|---|---|
| | Distance | Short Range −0.1x |
| Focal Length | 108.54 | 107.64 |
| Back Focus | 28.286 | 28.286 |
| Open F-Number | 2.06 | 2.28 |
| Maximum Full Angle of View [°] | 28.4 | 25.4 |
| DD[11] | 4.700 | 11.600 |
| DD[14] | 18.190 | 11.290 |

### Example 10

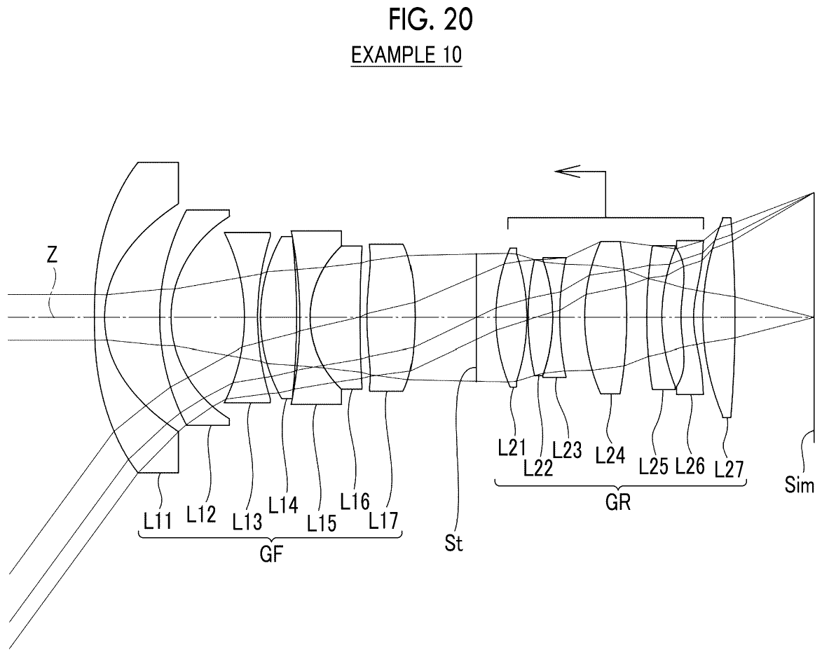

FIG. 20 shows a cross-sectional view of a configuration and luminous fluxes of a fixed-focal-length optical system of Example 10. The fixed-focal-length optical system consists of, in order from the object side to the image side, the front group GF having negative refractive power, the aperture stop St, and the rear group GR having positive refractive power. The front group GF consists of, in order from the object side to the image side, seven lenses including the lenses L11 to L17. The rear group GR consists of, in order from the object side to the image side, seven lenses including the lenses L21 to L27. The fixed-focal-length optical system includes only one focus lens group. The focus lens group consists of the lenses L21 to L26 and moves to the object side during focusing from the infinite distance object to the short range object.

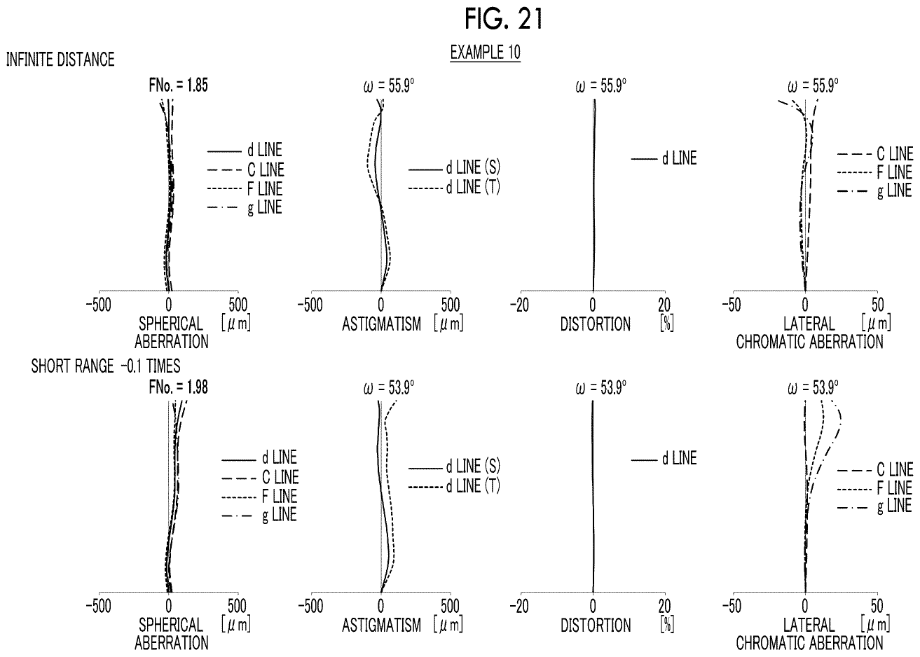

For the fixed-focal-length optical system of Example 10, Table 26 shows basic lens data, Table 27 shows specifications and variable surface spacings, Tables 28A and 28B show aspherical coefficients, and FIG. 21 shows each aberration diagram.

TABLE 26
Example 10

| Sn | R | D | Nd | νd | θgF | Material | ED |
|---|---|---|---|---|---|---|---|
| *1 | 185.8846 | 1.636 | 1.67798 | 54.89 | 0.5448 | Q-LAK52S.HIKARI | 53.75 |
| *2 | 22.2430 | 8.844 | | | | | 39.45 |
| 3 | 42.5222 | 1.806 | 1.59282 | 68.62 | 0.5441 | FCD515.HOYA | 37.25 |
| 4 | 21.0228 | 11.778 | | | | | 31.12 |
| 5 | −35.0760 | 2.110 | 1.55200 | 70.70 | 0.5422 | S-FPM5.OHARA | 29.44 |
| 6 | 49.2367 | 0.458 | | | | | 27.99 |
| 7 | 30.6065 | 5.793 | 1.85478 | 24.80 | 0.6123 | S-NBH56.OHARA | 28.02 |
| 8 | −140.3371 | 0.513 | | | | | 27.24 |
| 9 | −82.2038 | 1.656 | 2.00272 | 19.32 | 0.6451 | E-FDS2.HOYA | 27.19 |
| 10 | 17.7444 | 8.001 | 1.92286 | 18.90 | 0.6499 | H-ZF72A.CDGM | 24.73 |
| 11 | 218.4316 | 1.109 | | | | | 23.88 |
| *12 | 53.0121 | 7.662 | 1.83461 | 37.29 | 0.5764 | MP-NBFD10-20.HOYA | 24.09 |
| *13 | −70.2383 | 9.797 | | | | | 25.41 |
| 14 (St) | ∞ | DD[14] | | | | | 22.16 |
| 15 | 32.8817 | 4.963 | 1.49782 | 82.57 | 0.5386 | J-FKH1.HIKARI | 22.22 |
| 16 | −37.3438 | 0.200 | | | | | 21.94 |
| 17 | 48.7896 | 3.956 | 1.56907 | 71.30 | 0.5443 | H-ZPK7.CDGM | 20.00 |
| 18 | −32.3193 | 1.108 | 2.16217 | 21.24 | 0.6276 | N216.Glass | 20.01 |
| 19 | 52.0062 | 4.008 | | | | | 20.68 |
| 20 | 35.0985 | 6.755 | 1.95906 | 17.47 | 0.6599 | S-NPH3.OHARA | 26.24 |
| 21 | −80.6392 | 3.201 | | | | | 26.30 |
| 22 | 84.9840 | 2.434 | 1.90460 | 21.49 | 0.6324 | K-PSFN190.SUMITA | 24.84 |
| 23 | 34.1603 | 3.064 | | | | | 23.78 |
| *24 | 26.2658 | 2.017 | 2.00178 | 19.32 | 0.6448 | M-FDS2.HOYA | 23.81 |
| *25 | 18.6567 | DD[25] | | | | | 26.59 |
| 26 | 47.0315 | 5.161 | 1.51741 | 52.16 | 0.5621 | H-KF6.NHG | 33.97 |
| 27 | −221.3488 | 12.688 | | | | | 34.59 |

TABLE 27
Example 10

| | Infinite | |
|---|---|---|
| | Distance | Short Range −0.1x |
| Focal Length | 14.58 | 14.99 |
| Back Focus | 12.688 | 12.688 |
| Open F-Number | 1.85 | 1.98 |
| Maximum Full Angle of View [°] | 111.8 | 107.8 |
| DD[14] | 3.149 | 0.824 |
| DD[25] | 1.485 | 3.810 |

TABLE 28A
Example 10

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 4.3841234E−04 | 4.7597238E−04 | −2.9198417E−05 | −4.5168388E−05 |
| A4 | −8.6713541E−06 | −2.2447535E−05 | −2.2015300E−05 | −7.8054903E−06 |
| A5 | −1.1067483E−09 | 1.5198548E−06 | −1.3170398E−06 | −6.7455444E−07 |
| A6 | −4.4432043E−09 | −2.1143289E−08 | 2.0503289E−08 | −7.9610523E−08 |
| A7 | 1.6750042E−10 | −4.5540581E−09 | −1.1450118E−09 | 3.8084624E−09 |
| A8 | 8.6206199E−12 | 1.5733836E−10 | −2.7533454E−10 | 4.5525739E−11 |
| A9 | 7.6449323E−14 | 1.1485219E−12 | −8.9191641E−12 | −5.2239056E−12 |
| A10 | −9.6039654E−15 | 5.7389207E−14 | 5.0709501E−13 | −3.8463448E−13 |
| A11 | −5.4177712E−17 | 4.5490034E−15 | 2.2342378E−15 | −1.0921684E−13 |
| A12 | −1.5366299E−18 | −1.9116769E−16 | 2.3501179E−15 | 6.0988021E−15 |
| A13 | −2.4174581E−20 | −5.7822874E−18 | −5.5532164E−16 | 1.0084431E−17 |
| A14 | 2.7573987E−21 | −7.9771469E−19 | 1.9813531E−17 | 2.4874558E−17 |
| A15 | 1.5938385E−22 | −2.4958785E−20 | 7.4879691E−18 | 1.0201064E−18 |
| A16 | 2.4042552E−24 | 4.0379365E−22 | −1.8864450E−19 | −9.1852345E−20 |
| A17 | −8.4067320E−27 | 1.0519608E−22 | −5.7011408E−20 | 1.9657126E−21 |
| A18 | −3.9678882E−27 | 7.6450414E−24 | −3.6342191E−21 | −2.5323804E−21 |
| A19 | −1.2351388E−28 | −1.8226458E−25 | 6.8249474E−22 | 1.4420763E−22 |
| A20 | 3.4214824E−30 | −9.5232943E−27 | −1.7883435E−23 | −9.9482520E−26 |

TABLE 28B
Example 10

| Sn | 24 | 25 |
|---|---|---|
| KA | 1.0000000E+00 | 1.0000000E+00 |
| A3 | −1.5209502E−04 | −9.6316818E−05 |
| A4 | −1.5350091E−04 | −1.5728045E−04 |
| A5 | −3.5589191E−06 | −3.8156991E−06 |
| A6 | 1.4481554E−08 | 3.2880515E−07 |
| A7 | −2.1758842E−09 | 4.4210189E−09 |
| A8 | 3.4101451E−09 | 2.7552670E−09 |
| A9 | 4.1872621E−11 | 2.1594493E−11 |
| A10 | −2.5000972E−11 | −2.1225413E−11 |
| A11 | 1.4663047E−13 | 1.8926998E−14 |
| A12 | 6.8306223E−14 | 4.4187263E−14 |
| A13 | −4.6271135E−16 | −5.0312628E−17 |
| A14 | −1.0870510E−16 | 3.5983321E−17 |
| A15 | 9.5036210E−19 | −2.7504529E−18 |
| A16 | 5.0795554E−19 | −5.1768738E−20 |
| A17 | −5.1939195E−20 | 2.5309117E−21 |
| A18 | 1.1620779E−21 | −1.5254231E−22 |
| A19 | 4.5229560E−22 | −3.8127595E−23 |
| A20 | −3.5877457E−23 | 1.6974355E−24 |

### Example 11

FIG. 22 shows a cross-sectional view of a configuration and luminous fluxes of a fixed-focal-length optical system of Example 11. The fixed-focal-length optical system consists of, in order from the object side to the image side, the front group GF having positive refractive power, the aperture stop St, and the rear group GR having negative refractive power. The front group GF consists of, in order from the object side to the image side, seven lenses including the lenses L11 to L17. The rear group GR consists of, in order from the object side to the image side, 18 lenses including lenses L21 to L38. The fixed-focal-length optical system includes only one focus lens group. The focus lens group consists of the lens L21 and moves to the image side during focusing from the infinite distance object to the short range object. The vibration-proof group consists of the lenses L24 to L26.

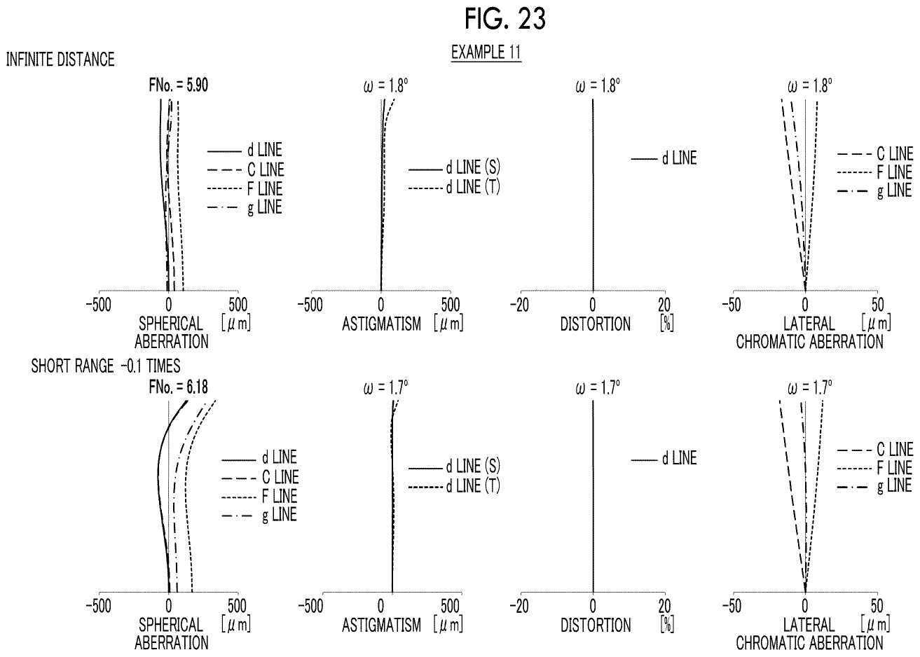

For the fixed-focal-length optical system of Example 11, Tables 29A and 29B show basic lens data, Table 30 shows specifications and variable surface spacings, and FIG. 23 shows each aberration diagram. The basic lens data is divided and shown in two tables to avoid one lengthy table.

TABLE 29A
Example 11

| Sn | R | D | Nd | νd | θgF | Material | ED |
|---|---|---|---|---|---|---|---|
| 1 | 152.1379 | 15.000 | 1.60300 | 65.44 | 0.5402 | S-PHM53.OHARA | 123.61 |
| 2 | 737.6562 | 94.179 | | | | | 122.00 |
| 3 | 96.4681 | 16.784 | 1.43875 | 94.66 | 0.5340 | S-FPL55.OHARA | 78.07 |
| 4 | −306.8332 | 1.423 | | | | | 74.50 |
| 5 | −290.5815 | 2.752 | 1.80100 | 34.97 | 0.5864 | S-LAM66.OHARA | 73.08 |
| 6 | 74.3021 | 5.184 | | | | | 67.92 |
| 7 | 75.4391 | 9.535 | 1.43875 | 94.66 | 0.5340 | S-FPL55.OHARA | 68.46 |
| 8 | −13679.7694 | 12.847 | | | | | 68.16 |
| 9 | 67.4242 | 5.653 | 1.89286 | 20.36 | 0.6394 | S-NPH4.OHARA | 61.25 |
| 10 | 126.4202 | 1.370 | | | | | 60.01 |
| 11 | 70.3027 | 1.967 | 1.85026 | 32.27 | 0.5930 | S-LAH71.OHARA | 56.98 |
| 12 | 40.1337 | 10.173 | 1.43875 | 94.66 | 0.5340 | S-FPL55.OHARA | 52.27 |
| 13 | 135.1994 | 6.948 | | | | | 50.48 |
| 14 (St) | ∞ | DD[14] | | | | | 47.10 |
| 15 | −669.8096 | 1.136 | 1.61800 | 63.32 | 0.5427 | S-PHM52Q.OHARA | 44.35 |
| 16 | 59.4765 | DD[16] | | | | | 42.59 |
| 17 | 100.0711 | 1.823 | 2.16217 | 21.24 | 0.6276 | N216.Glass | 41.05 |
| 18 | 77.1216 | 7.205 | 1.51742 | 52.43 | 0.5565 | S-NSL36.OHARA | 40.47 |
| 19 | −94.9801 | 0.807 | | | | | 40.20 |
| 20 | 91.9446 | 5.255 | 1.80100 | 34.97 | 0.5864 | S-LAM66.OHARA | 38.12 |
| 21 | −108.2242 | 1.417 | 1.52841 | 76.45 | 0.5395 | S-FPM4.OHARA | 37.43 |
| 22 | 37.1198 | 6.855 | | | | | 33.40 |

TABLE 29B
Example 11

| Sn | R | D | Nd | νd | θgF | Material | ED |
|---|---|---|---|---|---|---|---|
| 23 | −83.0175 | 0.857 | 1.72916 | 54.68 | 0.5445 | S-LAL18.OHARA | 32.96 |
| 24 | 70.2604 | 2.774 | | | | | 32.82 |
| 25 | 135.3202 | 6.150 | 1.63980 | 34.47 | 0.5923 | S-TIM27.OHARA | 33.38 |
| 26 | −1071.2604 | 0.694 | | | | | 33.81 |
| 27 | 70.1987 | 9.812 | 1.72342 | 37.95 | 0.5837 | S-BAH28.OHARA | 34.16 |
| 28 | −39.2811 | 1.291 | 1.80809 | 22.76 | 0.6307 | S-NPH1W.OHARA | 33.60 |
| 29 | −359.1852 | 3.417 | | | | | 33.19 |
| 30 | 137.0559 | 1.308 | 1.90525 | 35.04 | 0.5849 | S-LAH93.OHARA | 32.07 |
| 31 | 67.7227 | 5.889 | 1.49700 | 81.54 | 0.5375 | S-FPL51.OHARA | 31.54 |
| 32 | −67.1455 | 4.408 | | | | | 31.17 |
| 33 | −91.7609 | 0.757 | 1.77250 | 49.60 | 0.5521 | S-LAH66.OHARA | 28.49 |
| 34 | 24.5517 | 9.168 | 1.72047 | 34.71 | 0.5835 | S-NBH8.OHARA | 27.61 |
| 35 | −32.5911 | 1.083 | | | | | 27.41 |
| 36 | −25.6182 | 1.000 | 1.72916 | 54.68 | 0.5445 | S-LAL18.OHARA | 27.19 |
| 37 | 32.2078 | 15.790 | 1.51742 | 52.43 | 0.5565 | S-NSL36.OHARA | 27.66 |
| 38 | −23.3910 | 0.332 | | | | | 29.21 |
| 39 | −37.6436 | 1.000 | 1.65160 | 58.54 | 0.5390 | S-LAL7Q.OHARA | 27.51 |
| 40 | 49.1812 | 1.898 | | | | | 27.42 |
| 41 | 38.1136 | 11.623 | 1.72342 | 37.95 | 0.5837 | S-BAH28.OHARA | 28.41 |
| 42 | −26.7655 | 1.000 | 2.00266 | 31.67 | 0.5851 | N200.Glass | 27.73 |
| 43 | −1256.8923 | 73.401 | | | | | 28.00 |

TABLE 30
Example 11

| | Infinite | Short |
|---|---|---|
| | Distance | Range −0.1x |
| Focal Length | 700.40 | 471.45 |
| Back Focus | 73.401 | 73.401 |
| Open F-Number | 5.90 | 6.18 |
| Maximum Full Angle of View [°] | 3.6 | 3.4 |
| DD[14] | 5.084 | 9.955 |
| DD[16] | 31.510 | 26.639 |

### Example 12

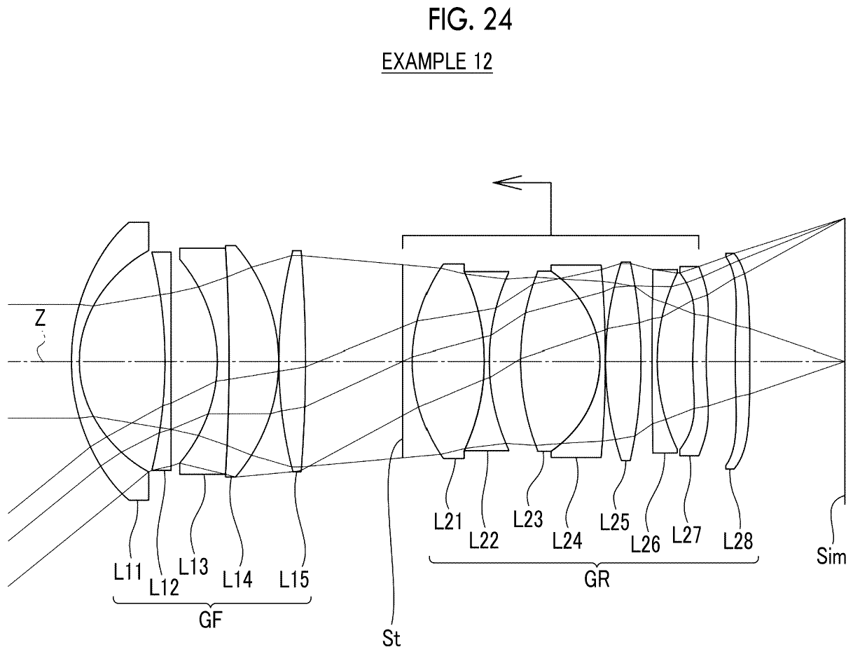

FIG. 24 shows a cross-sectional view of a configuration and luminous fluxes of a fixed-focal-length optical system of Example 12. The fixed-focal-length optical system consists of, in order from the object side to the image side, the front group GF having positive refractive power, the aperture stop St, and the rear group GR having positive refractive power. The front group GF consists of, in order from the object side to the image side, five lenses including the lenses L11 to L15. The rear group GR consists of, in order from the object side to the image side, eight lenses including the lenses L21 to L28. The fixed-focal-length optical system includes only one focus lens group. The focus lens group consists of the aperture stop St and the lenses L21 to L27 and moves to the object side during focusing from the infinite distance object to the short range object.

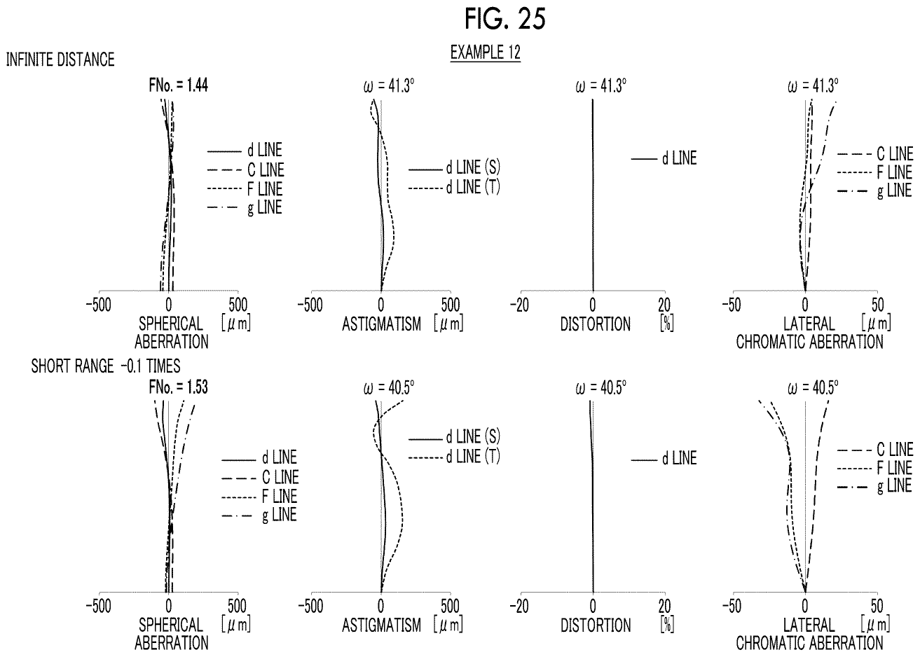

For the fixed-focal-length optical system of Example 12, Table 31 shows basic lens data, Table 32 shows specifications and variable surface spacings, Table 33 shows aspherical coefficients, and FIG. 25 shows each aberration diagram.

TABLE 31
Example 12

| Sn | R | D | Nd | νd | θgF | Material | ED |
|---|---|---|---|---|---|---|---|
| *1 | 33.6303 | 1.101 | 1.76450 | 49.10 | 0.5529 | L-LAH91.OHARA | 40.11 |
| *2 | 18.6110 | 11.991 | | | | | 33.44 |
| 3 | −74.7096 | 0.848 | 1.43875 | 94.66 | 0.5340 | S-FPL55.OHARA | 32.97 |
| 4 | 97468.4873 | 6.474 | | | | | 31.66 |
| 5 | −25.1372 | 1.639 | 2.16217 | 21.24 | 0.6276 | N216.Glass | 30.79 |
| 6 | −291.8593 | 6.931 | 1.88300 | 39.22 | 0.5729 | H-ZLAF68N.CDGM | 34.16 |
| 7 | −28.4401 | 0.046 | | | | | 34.99 |
| 8 | 72.3120 | 3.723 | 2.30909 | 17.89 | 0.6452 | N231.Glass | 33.40 |
| 9 | −227.6654 | DD[9] | | | | | 33.31 |
| 10 (St) | ∞ | 1.353 | | | | | 29.16 |
| 11 | 27.3569 | 10.005 | 1.53775 | 74.70 | 0.5394 | S-FPM3.OHARA | 28.54 |
| 12 | −33.9057 | 0.699 | 1.84666 | 23.78 | 0.6205 | S-TIH53W.OHARA | 27.03 |
| 13 | 34.3752 | 4.384 | | | | | 25.67 |
| 14 | 39.3953 | 11.099 | 1.59522 | 67.73 | 0.5443 | S-FPM2.OHARA | 26.80 |
| 15 | −16.9634 | 0.751 | 1.62004 | 36.26 | 0.5880 | S-TIM2.OHARA | 27.22 |
| 16 | −183.5013 | 0.048 | | | | | 29.07 |
| 17 | 52.2084 | 4.946 | 2.16217 | 21.24 | 0.6276 | N216.Glass | 30.00 |
| 18 | −75.7721 | 1.560 | | | | | 29.89 |
| 19 | 887.0186 | 0.717 | 1.84666 | 23.78 | 0.6205 | S-TIH53W.OHARA | 27.69 |
| 20 | 33.0497 | 4.969 | | | | | 26.61 |
| *21 | 54.9051 | 1.873 | 2.00178 | 19.32 | 0.6448 | MC-FDS2.HOYA | 26.67 |
| *22 | 49.2723 | DD[22] | | | | | 28.59 |
| *23 | 145.7366 | 2.000 | 1.51633 | 64.06 | 0.5334 | L-BSL7.OHARA | 31.51 |
| *24 | 8351.1107 | 13.357 | | | | | 32.60 |

TABLE 32
Example 12

| | Infinite | Short |
|---|---|---|
| | Distance | Range −0.1x |
| Focal Length | 24.68 | 24.56 |
| Back Focus | 13.357 | 13.357 |
| Open F-Number | 1.44 | 1.53 |
| Maximum Full Angle of View [°] | 82.6 | 81.0 |
| DD[9] | 13.581 | 10.693 |
| DD[22] | 4.079 | 6.967 |

TABLE 33
Example 12

| Sn | 1 | 2 | 21 | 22 |
|---|---|---|---|---|
| KA | 1.0000000E+00 | 1.0000000E+00 | 1.0000000E+00 | 1.0000000E+00 |
| A4 | 5.9392900E−06 | 3.7923669E−06 | −8.8063223E−05 | −7.1652843E−05 |
| A6 | −4.0665394E−08 | −7.7042320E−08 | −3.5075785E−07 | −3.8083795E−07 |
| A8 | 1.6820825E−10 | 3.2233008E−10 | 1.0100800E−09 | 2.5834972E−09 |
| A10 | −3.6627557E−13 | −1.0512210E−12 | 2.8406122E−12 | −4.4199135E−12 |
| A12 | 3.7583680E−16 | 9.8754650E−16 | −6.8824360E−15 | 2.3455090E−15 |

| Sn | 23 | 24 |
|---|---|---|
| KA | 1.0000000E+00 | 1.0000000E+00 |
| A4 | −1.6960646E−05 | −1.7223224E−05 |
| A6 | −1.0568733E−07 | −3.8533054E−08 |
| A8 | 4.2092347E−10 | 8.2936512E−11 |
| A10 | −1.1765931E−12 | −5.0421784E−13 |

### Example 13

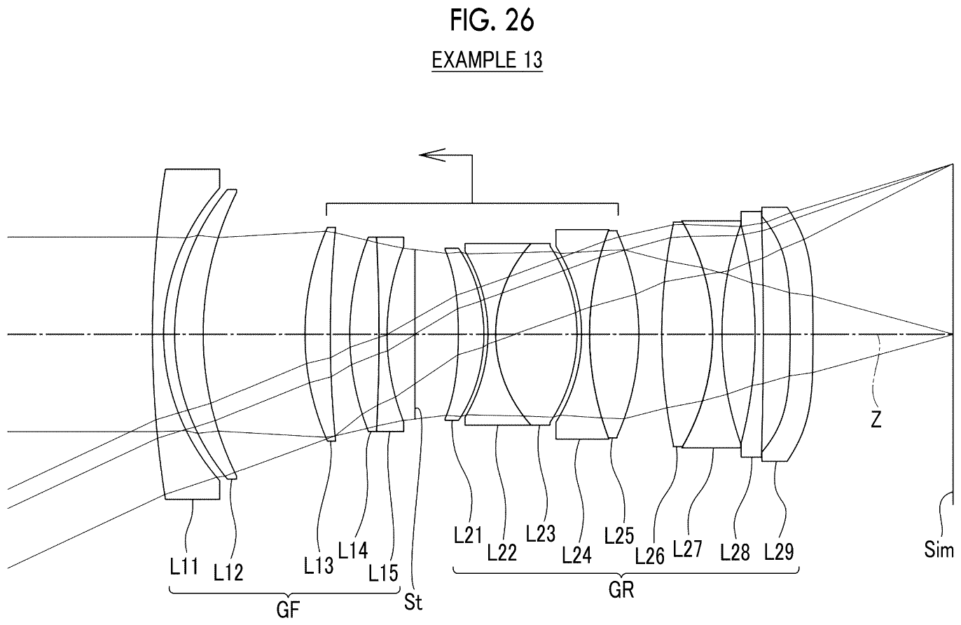

FIG. 26 shows a cross-sectional view of a configuration and luminous fluxes of a fixed-focal-length optical system of Example 13. The fixed-focal-length optical system consists of, in order from the object side to the image side, the front group GF having positive refractive power, the aperture stop St, and the rear group GR having positive refractive power. The front group GF consists of, in order from the object side to the image side, five lenses including the lenses L11 to L15. The rear group GR consists of, in order from the object side to the image side, nine lenses including the lenses L21 to L29. The fixed-focal-length optical system includes only one focus lens group. The focus lens group consists of the lenses L13 to L15, the aperture stop St, and the lenses L21 to L25 and moves to the object side during focusing from the infinite distance object to the short range object.

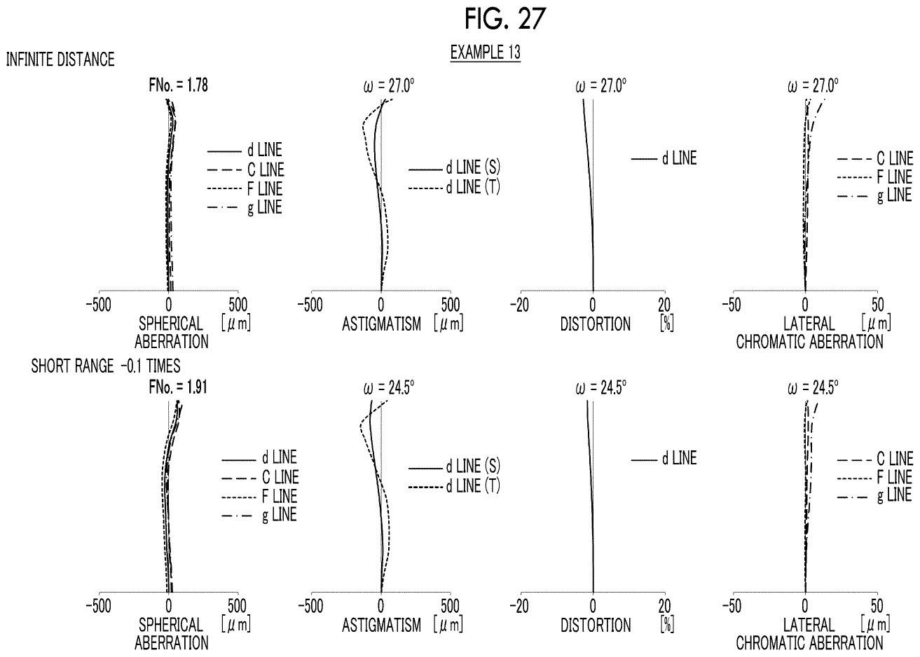

For the fixed-focal-length optical system of Example 13, Table 34 shows basic lens data, Table 35 shows specifications and variable surface spacings, Table 36 shows aspherical coefficients, and FIG. 27 shows each aberration diagram.

TABLE 34
Example 13

| Sn | R | D | Nd | νd | θgF | Material | ED |
|---|---|---|---|---|---|---|---|
| 1 | 189.7752 | 1.700 | 1.59270 | 35.45 | 0.5927 | FF5.HOYA | 52.99 |
| 2 | 38.4658 | 1.680 | | | | | 47.27 |
| 3 | 39.5586 | 4.370 | 2.00266 | 31.67 | 0.5851 | N200.Glass | 46.90 |
| 4 | 56.4529 | DD[4] | | | | | 45.65 |
| 5 | 47.1747 | 3.880 | 2.05091 | 26.95 | 0.6047 | H-ZLAF95.NHG | 34.60 |
| 6 | 195.3507 | 2.980 | | | | | 34.09 |
| 7 | 46.9048 | 4.470 | 1.49700 | 81.61 | 0.5389 | FCD1.HOYA | 31.27 |
| 8 | −330.2990 | 1.220 | 1.78880 | 28.43 | 0.6009 | S-NBH58.OHARA | 30.42 |
| 9 | 42.5483 | 4.260 | | | | | 28.51 |
| 10 (St) | ∞ | 6.650 | | | | | 27.98 |
| *11 | −67.7803 | 3.880 | 1.77400 | 49.59 | 0.5548 | D-LAF50.CDGM | 27.09 |
| *12 | −29.6594 | 0.640 | | | | | 27.59 |
| 13 | −28.4983 | 1.170 | 1.62588 | 35.70 | 0.5895 | H-F13.CDGM | 27.12 |
| 14 | 23.5438 | 12.440 | 1.59283 | 68.63 | 0.5429 | H-FK69.NHG | 28.21 |
| 15 | −27.7112 | 0.700 | | | | | 28.78 |
| 16 | −28.8287 | 1.230 | 1.78880 | 28.43 | 0.6009 | S-NBH58.OHARA | 28.74 |
| 17 | 52.3351 | 7.520 | 2.00069 | 25.43 | 0.6142 | H-ZLAF90.CDGM | 32.39 |
| 18 | −44.4459 | DD[18] | | | | | 33.00 |
| 19 | 94.8433 | 7.760 | 1.84850 | 43.79 | 0.5620 | J-LASFH22.HIKARI | 36.20 |
| 20 | −39.6921 | 1.360 | 1.59551 | 39.22 | 0.5811 | H-QF14.CDGM | 36.31 |
| 21 | 58.6314 | 5.060 | | | | | 35.64 |
| 22 | −76.6425 | 1.240 | 1.54072 | 47.23 | 0.5656 | H-QF8.CDGM | 35.68 |
| 23 | −750.3849 | 4.110 | | | | | 36.73 |
| *24 | −299.9968 | 3.500 | 1.68948 | 31.02 | 0.5987 | L-TIM28.OHARA | 37.08 |
| *25 | −593.4954 | 21.392 | | | | | 40.20 |

TABLE 35
Example 13

| | Infinite | Short |
|---|---|---|
| | Distance | Range −0.1x |
| Focal Length | 56.92 | 58.06 |
| Back Focus | 21.392 | 21.392 |
| Open F-Number | 1.78 | 1.91 |
| Maximum Full Angle of View [°] | 54.0 | 49.0 |
| DD[4] | 15.470 | 8.738 |
| DD[18] | 3.510 | 10.242 |

TABLE 36
Example 13

| Sn | 11 | 12 | 24 | 25 |
|---|---|---|---|---|
| KA | 1.0000000E+00 | 1.0000000E+00 | 1.0000000E+00 | 1.0000000E+00 |
| A4 | −9.7134740E−06 | −1.9062669E−06 | −2.3970257E−05 | −1.9100502E−05 |
| A6 | −1.5209098E−07 | −1.2250081E−07 | −9.8719288E−09 | −2.9730877E−08 |
| A8 | 3.5418863E−09 | 2.8717554E−09 | −2.3513245E−11 | 3.1883941E−10 |
| A10 | −5.5997685E−11 | −4.4123528E−11 | 7.9437317E−13 | −1.9712131E−12 |
| A12 | 5.5503196E−13 | 4.2981705E−13 | −6.7634995E−15 | 7.8749013E−15 |
| A14 | −3.4564182E−15 | −2.6519418E−15 | 2.8013170E−17 | −2.0296268E−17 |
| A16 | 1.3078108E−17 | 1.0024634E−17 | −5.8875024E−20 | 3.3821126E−20 |
| A18 | −2.7329980E−20 | −2.1139450E−20 | 5.6671369E−23 | −3.3769127E−23 |
| A20 | 2.3977500E−23 | 1.8963057E−23 | −1.5057050E−26 | 1.5598490E−26 |

### Example 14

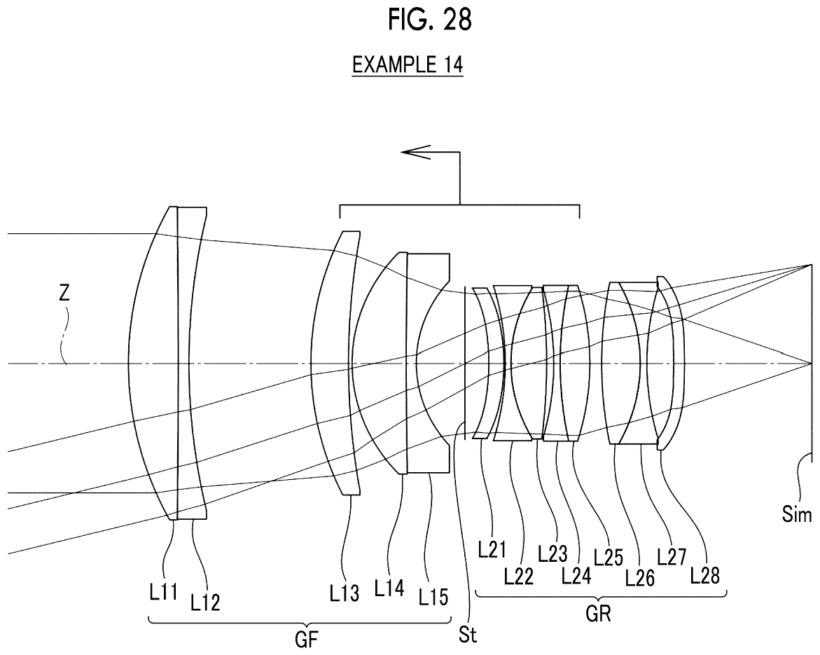

FIG. 28 shows a cross-sectional view of a configuration and luminous fluxes of a fixed-focal-length optical system of Example 14. The fixed-focal-length optical system consists of, in order from the object side to the image side, the front group GF having positive refractive power, the aperture stop St, and the rear group GR having positive refractive power. The front group GF consists of, in order from the object side to the image side, five lenses including the lenses L11 to L15. The rear group GR consists of, in order from the object side to the image side, eight lenses including the lenses L21 to L28. The fixed-focal-length optical system includes only one focus lens group. The focus lens group consists of the lenses L13 to L15, the aperture stop St, and the lenses L21 to L25 and moves to the object side during focusing from the infinite distance object to the short range object.

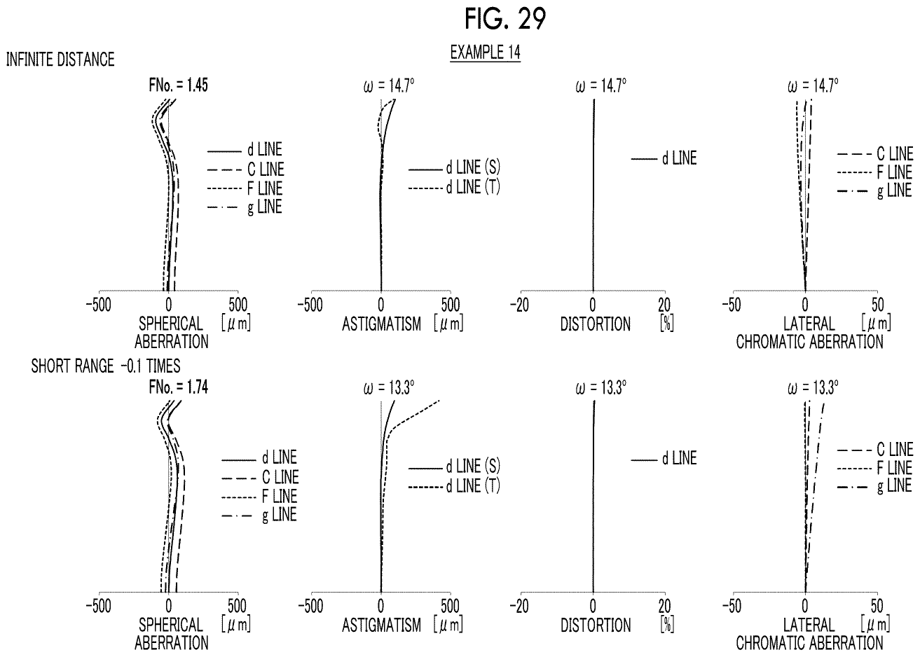

For the fixed-focal-length optical system of Example 14, Table 37 shows basic lens data, Table 38 shows specifications and variable surface spacings, Table 39 shows aspherical coefficients, and FIG. 29 shows each aberration diagram.

TABLE 37
Example 14

| Sn | R | D | Nd | νd | θgF | Material | ED |
|---|---|---|---|---|---|---|---|
| 1 | 51.6499 | 6.980 | 1.62041 | 60.36 | 0.5399 | H-ZK9A.NHG | 46.00 |
| 2 | −2367.2700 | 1.500 | 1.85451 | 25.15 | 0.6103 | NBFD25.HOYA | 45.37 |
| 3 | 102.5467 | DD[3] | | | | | 43.89 |
| 4 | 46.7616 | 5.270 | 2.30909 | 17.89 | 0.6452 | N231.Glass | 38.08 |
| 5 | 117.4113 | 0.500 | | | | | 36.40 |
| 6 | 24.6965 | 7.590 | 1.55032 | 75.50 | 0.5400 | FCD705.HOYA | 31.18 |
| 7 | 899.8530 | 1.330 | 1.96300 | 24.11 | 0.6213 | S-TIH57.OHARA | 28.39 |
| 8 | 19.0086 | 6.810 | | | | | 23.36 |
| 9 (St) | ∞ | 3.340 | | | | | 22.12 |
| *10 | −37.8423 | 2.100 | 1.58313 | 59.38 | 0.5424 | L-BAL42.OHARA | 21.61 |
| *11 | −32.7624 | 0.205 | | | | | 21.86 |
| 12 | −42.0952 | 0.810 | 1.78472 | 25.72 | 0.6158 | FD110.HOYA | 21.50 |
| 13 | 23.0954 | 4.990 | 1.81600 | 46.56 | 0.5575 | H-ZLAF69A.CDGM | 21.65 |
| 14 | −96.6818 | 1.000 | | | | | 21.68 |
| 15 | −42.9874 | 0.910 | 1.48749 | 70.24 | 0.5301 | S-FSL5.OHARA | 21.64 |
| 16 | 58.7355 | 4.150 | 2.00266 | 31.67 | 0.5851 | N200.Glass | 21.84 |
| 17 | −41.0867 | DD[17] | | | | | 21.76 |
| 18 | 65.9272 | 5.400 | 2.00266 | 31.67 | 0.5851 | N200.Glass | 22.60 |
| 19 | −26.1773 | 0.940 | 1.80000 | 29.84 | 0.6018 | S-NBH55.OHARA | 22.47 |
| 20 | 42.2791 | 3.759 | | | | | 21.67 |
| *21 | −120.4989 | 1.510 | 1.68948 | 31.02 | 0.5987 | L-TIM28.OHARA | 21.79 |
| *22 | −151.2953 | 17.853 | | | | | 22.78 |

TABLE 38
Example 14

| | Infinite | Short |
|---|---|---|
| | Distance | Range −0.1x |
| Focal Length | 56.67 | 56.28 |
| Back Focus | 17.853 | 17.853 |
| Open F-Number | 1.45 | 1.74 |
| Maximum Full Angle of View [°] | 29.4 | 26.6 |
| DD[3] | 17.100 | 9.203 |
| DD[17] | 1.657 | 9.554 |

TABLE 39
Example 14

| Sn | 10 | 11 | 21 | 22 |
|---|---|---|---|---|
| KA | 1.0000000E+00 | 1.0000000E+00 | 1.0000000E+00 | 1.0000000E+00 |
| A4 | −1.6629532E−05 | −5.5850107E−06 | −1.0498869E−04 | −9.7239880E−05 |
| A6 | −2.4779179E−07 | −2.8670654E−07 | −2.0333798E−08 | 2.6530661E−08 |
| A8 | 2.8495721E−09 | 4.3914053E−09 | 7.2338567E−09 | 5.8448709E−09 |
| A10 | −3.0879894E−11 | −5.3267884E−11 | −1.6262226E−10 | −9.8980563E−11 |
| A12 | 4.1121499E−13 | 4.6792544E−13 | 1.9444155E−12 | 6.1535940E−13 |
| A14 | −6.5697411E−15 | −4.1287142E−15 | −1.7852113E−14 | −1.3812612E−15 |
| A16 | 5.5116531E−17 | 2.4264915E−17 | 1.2589993E−16 | 7.5553668E−18 |
| A18 | −1.8211616E−19 | −2.9570812E−20 | −5.0640367E−19 | −7.7234991E−20 |
| A20 | 1.1644973E−22 | −1.7391770E−22 | 7.6178370E−22 | 2.0816641E−22 |

### Example 15

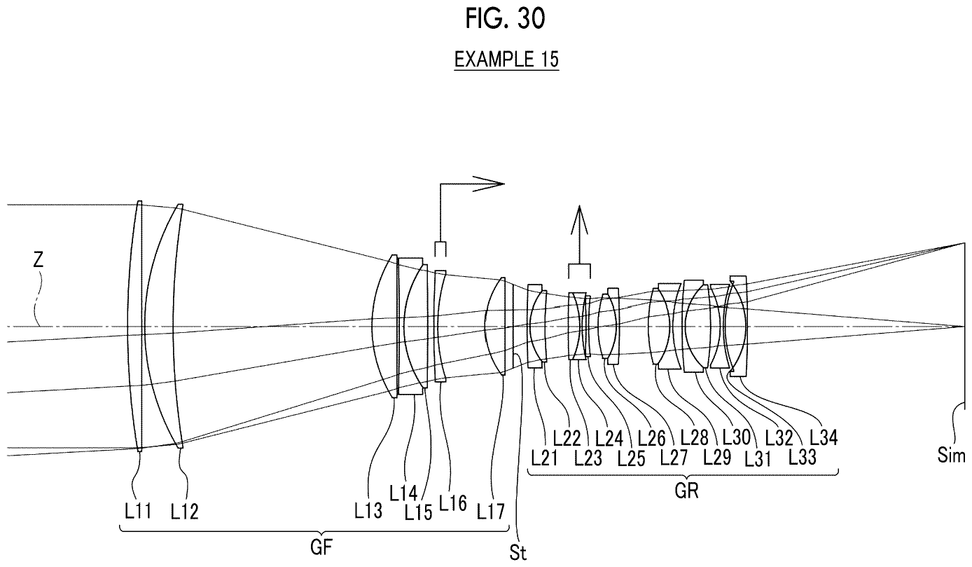

FIG. 30 shows a cross-sectional view of a configuration and luminous fluxes of a fixed-focal-length optical system of Example 15. The fixed-focal-length optical system consists of, in order from the object side to the image side, the front group GF having positive refractive power, the aperture stop St, and the rear group GR having negative refractive power. The front group GF consists of, in order from the object side to the image side, seven lenses including the lenses L11 to L17. The rear group GR consists of, in order from the object side to the image side, 14 lenses including the lenses L21 to L34. The fixed-focal-length optical system includes only one focus lens group. The focus lens group consists of the lens L16 and moves to the image side during focusing from the infinite distance object to the short range object. The vibration-proof group consists of the lenses L23 to L25.

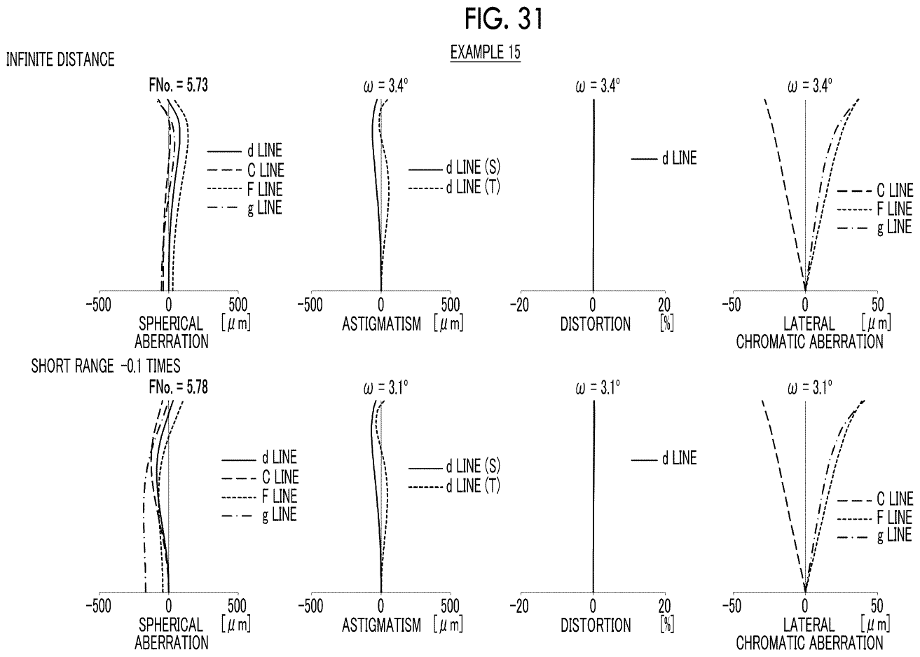

For the fixed-focal-length optical system of Example 15, Table 40 shows basic lens data, Table 41 shows specifications and variable surface spacings, and FIG. 31 shows each aberration diagram.

TABLE 40
Example 15

| Sn | R | D | Nd | νd | θgF | Material | ED |
|---|---|---|---|---|---|---|---|
| 1 | 287.9986 | 4.500 | 1.63980 | 34.47 | 0.5923 | S-TIM27.OHARA | 84.46 |
| 2 | ∞ | 0.951 | | | | | 84.20 |
| 3 | 88.2297 | 9.090 | 1.49700 | 81.61 | 0.5389 | FCD1.HOYA | 82.28 |
| 4 | 279.4780 | 63.524 | | | | | 81.43 |
| 5 | 49.8839 | 8.000 | 1.43700 | 95.10 | 0.5336 | FCD100.HOYA | 46.15 |
| 6 | ∞ | 0.697 | | | | | 44.55 |
| 7 | −1153.3576 | 1.500 | 1.80420 | 46.50 | 0.5573 | TAF3D.HOYA | 44.05 |
| 8 | 39.8871 | 7.590 | 1.43700 | 95.10 | 0.5336 | FCD100.HOYA | 40.36 |
| 9 | −1962.8727 | DD[9] | | | | | 39.66 |
| 10 | 395.3446 | 1.220 | 1.69680 | 55.46 | 0.5426 | LAC14.HOYA | 36.69 |
| 11 | 64.9927 | DD[11] | | | | | 35.52 |
| 12 | 29.4999 | 6.320 | 1.49700 | 81.61 | 0.5389 | FCD1.HOYA | 31.89 |
| 13 | ∞ | 2.559 | | | | | 30.99 |
| 14 (St) | ∞ | 4.486 | | | | | 28.80 |
| 15 | 345.1710 | 0.880 | 1.92119 | 23.96 | 0.6203 | FDS24-W.HOYA | 24.77 |
| 16 | 20.9662 | 4.870 | 1.55032 | 75.50 | 0.5400 | FCD705.HOYA | 22.91 |
| 17 | 140.5393 | 7.400 | | | | | 22.40 |
| 18 | 412.5627 | 3.670 | 1.84666 | 23.84 | 0.6201 | FDS90-SGP.HOYA | 20.08 |
| 19 | −29.6829 | 0.760 | 1.83481 | 42.72 | 0.5648 | TAFD5G.HOYA | 19.75 |
| 20 | 53.1839 | 1.215 | | | | | 19.15 |
| 21 | −328.4165 | 0.860 | 1.94595 | 17.98 | 0.6546 | FDS18-W.HOYA | 19.15 |
| 22 | 97.3150 | 2.999 | | | | | 19.17 |
| 23 | 38.1656 | 5.830 | 1.63980 | 34.47 | 0.5923 | S-TIM27.OHARA | 20.00 |
| 24 | −23.6923 | 1.000 | 1.77250 | 49.62 | 0.5504 | TAF1.HOYA | 20.28 |
| 25 | −247.6705 | 9.224 | | | | | 20.84 |
| 26 | 52.3373 | 6.860 | 1.59551 | 39.24 | 0.5804 | S-TIM8.OHARA | 24.05 |
| 27 | −24.1416 | 1.000 | 1.49700 | 81.61 | 0.5389 | FCD1.HOYA | 24.19 |
| 28 | 42.6014 | 2.913 | | | | | 24.15 |
| 29 | 167.7505 | 1.000 | 1.87070 | 40.73 | 0.5683 | TAFD32.HOYA | 24.63 |
| 30 | 20.3416 | 8.140 | 1.84666 | 23.84 | 0.6201 | FDS90-SGP.HOYA | 25.06 |
| 31 | −106.5394 | 3.067 | | | | | 25.39 |
| 32 | −30.0183 | 0.970 | 1.49700 | 81.61 | 0.5389 | FCD1.HOYA | 25.39 |
| 33 | 52.1636 | 0.600 | | | | | 27.07 |
| 34 | 42.7882 | 6.629 | 1.83481 | 42.74 | 0.5649 | S-LAH55VS.OHARA | 28.01 |
| 35 | −26.5413 | 0.525 | 2.16217 | 21.24 | 0.6276 | N216.Glass | 28.02 |
| 36 | −323.8347 | 69.506 | | | | | 29.01 |

TABLE 41
Example 15

| | Infinite | Short |
|---|---|---|
| | Distance | Range −0.1x |
| Focal Length | 480.44 | 358.87 |
| Back Focus | 69.506 | 69.506 |
| Open F-Number | 5.73 | 5.78 |
| Maximum Full Angle of View [°] | 6.8 | 6.2 |
| DD[9] | 2.001 | 8.305 |
| DD[11] | 15.000 | 8.696 |

### Example 16

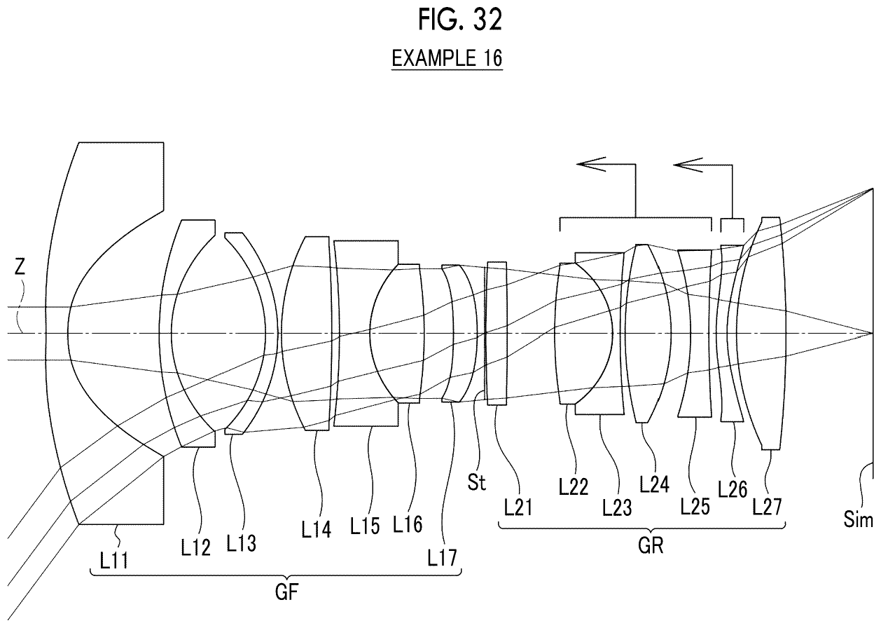

FIG. 32 shows a cross-sectional view of a configuration and luminous fluxes of a fixed-focal-length optical system of Example 16. The fixed-focal-length optical system consists of, in order from the object side to the image side, the front group GF having positive refractive power, the aperture stop St, and the rear group GR having positive refractive power. The front group GF consists of, in order from the object side to the image side, seven lenses including the lenses L11 to L17. The rear group GR consists of, in order from the object side to the image side, seven lenses including the lenses L21 to L27. The fixed-focal-length optical system includes two focus lens groups. The focus lens group on the object side consists of the lenses L22 to L25, and the focus lens group on the image side consists of the lens L26. During focusing from the infinite distance object to the short range object, the focus lens group on the object side and the focus lens group on the image side move to the object side by changing a mutual spacing.

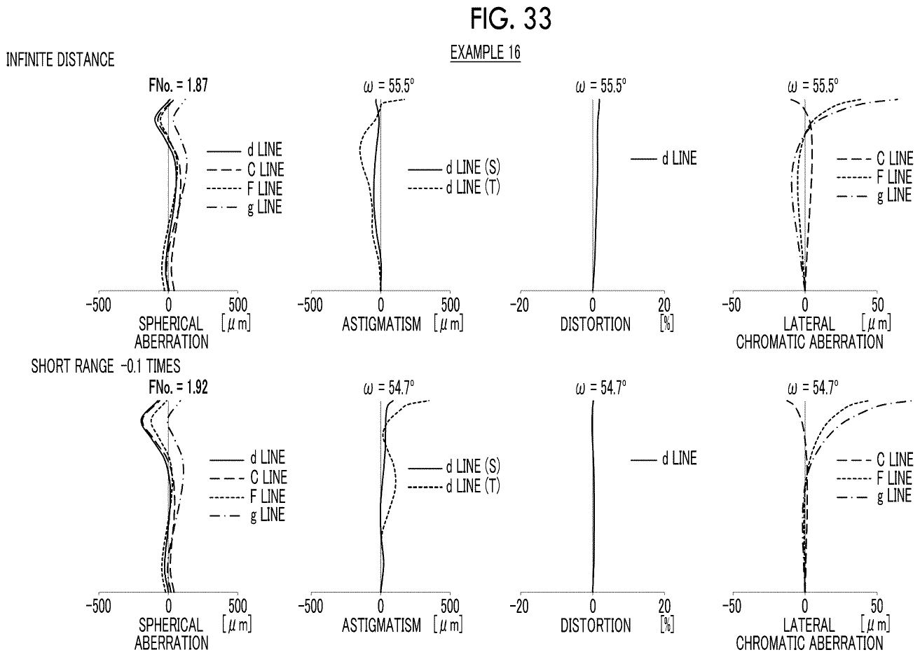

For the fixed-focal-length optical system of Example 16, Table 42 shows basic lens data, Table 43 shows specifications and variable surface spacings, Tables 44A and 44B show aspherical coefficients, and FIG. 33 shows each aberration diagram.

TABLE 42
Example 16

| Sn | R | D | Nd | νd | θgF | Material | ED |
|---|---|---|---|---|---|---|---|
| *1 | −73.0254 | 3.012 | 1.59245 | 66.92 | 0.5359 | Q-PSKH4S.HIKARI | 56.98 |
| *2 | 22.5107 | 12.622 | | | | | 36.67 |
| 3 | 47.8305 | 1.671 | 1.53775 | 74.70 | 0.5394 | S-FPM3.OHARA | 33.85 |
| 4 | 20.7796 | 12.927 | | | | | 29.27 |
| 5 | −20.9633 | 1.699 | 1.95906 | 17.47 | 0.6599 | S-NPH3.OHARA | 28.53 |
| 6 | −25.4371 | 0.492 | | | | | 30.01 |
| 7 | 33.1838 | 6.954 | 2.16217 | 21.24 | 0.6276 | N216.Glass | 28.86 |
| 8 | −225.7550 | 1.053 | | | | | 27.02 |
| 9 | −122.5543 | 4.192 | 2.00171 | 20.66 | 0.6347 | K-PSFN2.SUMITA | 25.60 |
| 10 | 15.5341 | 7.499 | 1.79504 | 28.69 | 0.6066 | J-LAFH3.HIKARI | 20.63 |
| 11 | −73.4014 | 4.046 | | | | | 19.33 |
| *12 | −64.9879 | 3.287 | 1.63860 | 63.43 | 0.5427 | K-LAFK63.SUMITA | 19.25 |
| *13 | −34.6075 | 1.000 | | | | | 20.38 |
| 14 (St) | ∞ | 0.200 | | | | | 19.72 |
| 15 | 253.9343 | 2.922 | 1.49700 | 81.55 | 0.5384 | H-FK61.NHG | 19.77 |
| 16 | −531.9646 | DD[16] | | | | | 19.91 |
| 17 | 70.2440 | 8.005 | 1.74099 | 52.71 | 0.5483 | H-LAK61.NHG | 20.34 |
| 18 | −13.2273 | 1.023 | 1.90682 | 21.17 | 0.6333 | K-PSFN1.SUMITA | 20.96 |
| 19 | 127.7910 | 0.700 | | | | | 24.10 |
| 20 | 58.3916 | 6.267 | 1.98613 | 16.48 | 0.6656 | FDS16-W.HOYA | 26.08 |
| 21 | −29.3448 | 2.694 | | | | | 26.53 |
| 22 | −43.6036 | 2.519 | 2.00680 | 26.19 | 0.6103 | K-BOC30.SUMITA | 24.56 |
| 23 | 203.4444 | DD[23] | | | | | 24.88 |
| *24 | 32.5248 | 1.506 | 2.30909 | 17.89 | 0.6452 | N231.Glass | 25.22 |
| *25 | 24.4227 | DD[25] | | | | | 26.27 |
| 26 | 41.5254 | 6.831 | 1.49710 | 81.56 | 0.5385 | FCD1B.HOYA | 33.35 |
| 27 | −172.6646 | 12.012 | | | | | 34.62 |

TABLE 43
Example 16

| | Infinite | Short |
|---|---|---|
| | Distance | Range −0.1x |
| Focal Length | 14.58 | 14.55 |
| Back Focus | 12.012 | 12.012 |
| Open F-Number | 1.87 | 1.92 |
| Maximum Full Angle of View [°] | 111.0 | 109.4 |
| DD[16] | 6.565 | 3.950 |
| DD[23] | 1.005 | 2.226 |
| DD[25] | 1.305 | 2.695 |

TABLE 44A
Example 16

| Sn | 1 | 2 | 12 | 13 |
|---|---|---|---|---|
| KA | 1.0000000E+00 | 4.0600000E−01 | 1.0000000E+00 | 1.0000000E+00 |
| A3 | 1.4686220E−03 | 1.6145353E−03 | −5.0009014E−05 | −7.7524813E−05 |
| A4 | −6.0489538E−05 | −8.5432591E−05 | −5.1455376E−05 | −3.2530910E−05 |
| A5 | 7.1535620E−07 | 4.4891358E−06 | −2.4175911E−06 | −3.0333663E−06 |
| A6 | 4.6906216E−09 | −7.8000258E−08 | −9.0318998E−08 | −1.2134769E−07 |
| A7 | 1.9823320E−10 | −6.2852734E−09 | −1.0953166E−08 | 3.4185261E−10 |
| A8 | −1.3086220E−12 | 6.4655659E−11 | −1.2945819E−09 | 3.8049611E−10 |
| A9 | −1.0761823E−14 | 6.5464300E−12 | 1.9764973E−10 | −2.6105758E−11 |
| A10 | −6.8772571E−15 | 1.1948706E−13 | −6.9959507E−13 | 3.2960973E−13 |
| A11 | −1.1685175E−17 | 2.6139174E−14 | −1.3710936E−12 | −3.3584088E−13 |
| A12 | −6.8234342E−18 | −3.1856553E−16 | 7.1411764E−14 | 5.4710013E−14 |
| A13 | 1.8618026E−19 | −5.0680725E−17 | −4.3062166E−15 | −5.0922514E−15 |
| A14 | 6.3635114E−21 | −2.1791732E−18 | 1.6558282E−15 | 1.9105978E−17 |
| A15 | 3.6942382E−23 | −1.6948937E−20 | −5.5036048E−17 | 3.2450646E−17 |
| A16 | −8.6778660E−25 | 3.0679439E−21 | −1.1817682E−17 | −6.1194659E−18 |
| A17 | −1.1599859E−26 | 3.0137393E−22 | 5.3089601E−19 | 1.0578082E−18 |
| A18 | −4.7687367E−27 | 1.5954458E−23 | −1.3084351E−19 | −8.4807143E−20 |
| A19 | −4.2835577E−29 | 1.4815713E−25 | 6.3985951E−21 | −3.7287447E−21 |
| A20 | 2.8337142E−30 | −7.7363944E−26 | −1.8354856E−22 | 3.4088804E−22 |

TABLE 44B
Example 16

| Sn | 24 | 25 |
|---|---|---|
| KA | 1.0000000E+00 | 1.0000000E+00 |
| A3 | −6.1639493E−05 | −7.9068744E−05 |
| A4 | −7.8459705E−05 | −7.1671246E−05 |
| A5 | −1.9476582E−06 | 4.5276240E−07 |
| A6 | 2.4689971E−07 | 1.0546004E−07 |
| A7 | 4.7455833E−09 | −1.4363677E−08 |
| A8 | −1.5463960E−10 | 2.5625309E−09 |
| A9 | −1.9972638E−11 | 4.9956931E−11 |
| A10 | −1.0063398E−12 | −1.8628468E−11 |
| A11 | −7.2757598E−15 | 1.3653652E−13 |
| A12 | 1.3368449E−15 | 4.3230141E−14 |
| A13 | 2.0223544E−16 | −4.5232818E−16 |
| A14 | 1.5469221E−17 | 1.1082563E−18 |
| A15 | 5.0389698E−19 | −4.7323400E−18 |
| A16 | −8.9851621E−20 | −9.9508330E−20 |
| A17 | −1.1632642E−20 | 3.9722033E−21 |
| A18 | −1.0779991E−21 | 4.8329051E−22 |
| A19 | −6.3880400E−24 | −2.0091580E−25 |
| A20 | 3.6009318E−24 | 5.6953397E−25 |

### Example 17

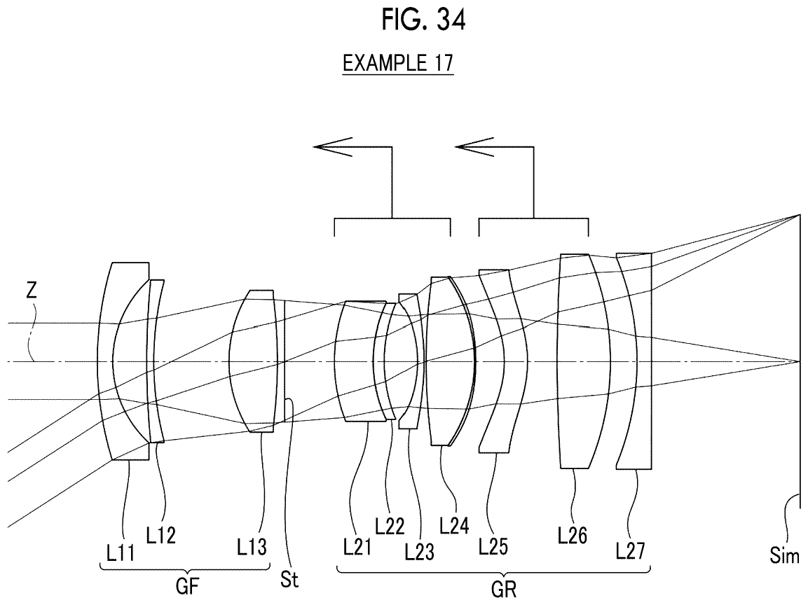

FIG. 34 shows a cross-sectional view of a configuration and luminous fluxes of a fixed-focal-length optical system of Example 17. The fixed-focal-length optical system consists of, in order from the object side to the image side, the front group GF having positive refractive power, the aperture stop St, and the rear group GR having positive refractive power. The front group GF consists of, in order from the object side to the image side, three lenses including the lenses L11 to L13. The rear group GR consists of, in order from the object side to the image side, seven lenses including the lenses L21 to L27. The fixed-focal-length optical system includes two focus lens groups. The focus lens group on the object side consists of the lenses L21 to L24, and the focus lens group on the image side consists of the lenses L25 and L26. During focusing from the infinite distance object to the short range object, the focus lens group on the object side and the focus lens group on the image side move to the object side by changing a mutual spacing.

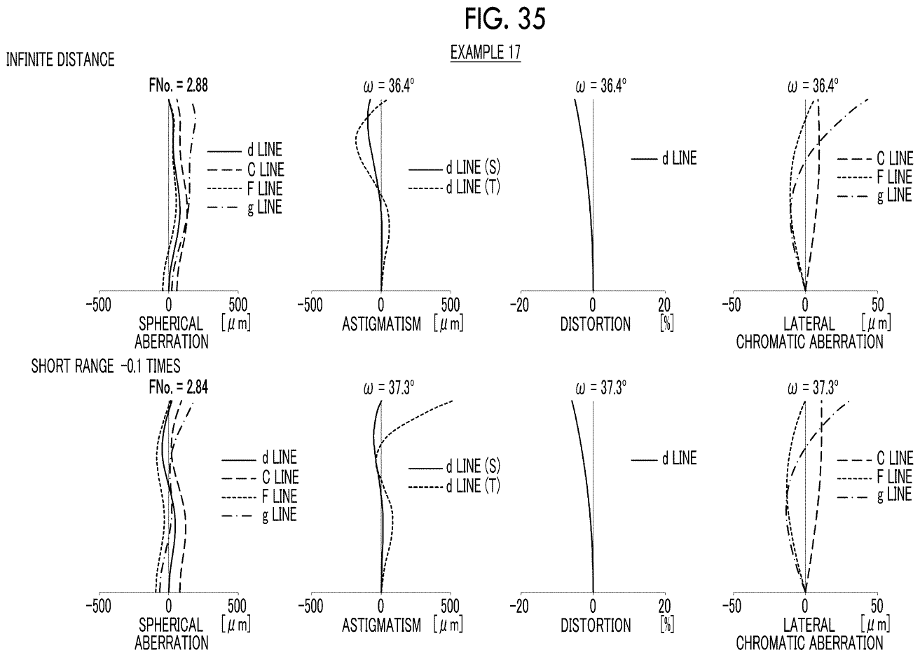

For the fixed-focal-length optical system of Example 17, Table 45 shows basic lens data, Table 46 shows specifications and variable surface spacings, Table 47 shows aspherical coefficients, and FIG. 35 shows each aberration diagram. In the table of the basic lens data, both sides of the surface number of a surface corresponding to a composite aspherical surface of a composite aspherical lens are marked with *.

TABLE 45
Example 17

| Sn | R | D | Nd | νd | θgF | Material | ED |
|---|---|---|---|---|---|---|---|
| 1 | 40.2501 | 1.592 | 1.77535 | 50.31 | 0.5504 | H-LAK77.NHG | 22.00 |
| 2 | 12.9562 | 3.510 | | | | | 18.22 |
| 3 | 100.1560 | 0.725 | 1.48749 | 70.32 | 0.5292 | J-FK5.HIKARI | 18.14 |
| 4 | 37.6938 | 7.769 | | | | | 17.71 |
| 5 | 15.5122 | 5.000 | 1.48749 | 70.32 | 0.5292 | J-FK5.HIKARI | 15.81 |
| 6 | −62.2016 | 0.750 | | | | | 14.63 |
| 7 (St) | ∞ | DD[7] | | | | | 13.54 |
| 8 | 19.7621 | 4.000 | 2.16217 | 21.24 | 0.6276 | N216.Glass | 13.38 |
| 9 | 16.3481 | 1.145 | 1.96300 | 24.11 | 0.6213 | S-TIH57.OHARA | 12.93 |
| 10 | 18.0163 | 3.376 | | | | | 12.90 |
| *11 | −14.8859 | 0.675 | 1.66121 | 20.35 | 0.6616 | Plastic | 13.16 |
| *12 | −29.1572 | 0.207 | | | | | 15.02 |
| 13 | 73.1107 | 5.000 | 1.77535 | 50.31 | 0.5504 | H-LAK77.NHG | 17.63 |
| 14 | −17.4787 | 0.140 | 1.56093 | 36.64 | 0.5885 | Plastic | 18.75 |
| *15* | −22.8888 | DD[15] | | | | | 18.89 |
| *16 | −12.2327 | 2.393 | 1.66121 | 20.35 | 0.6616 | Plastic | 19.17 |
| *17 | −14.6155 | 3.061 | | | | | 20.40 |
| 18 | 192.7128 | 5.500 | 1.77535 | 50.31 | 0.5504 | H-LAK77.NHG | 23.23 |
| 19 | −32.5865 | DD[19] | | | | | 23.90 |
| 20 | −32.4628 | 1.500 | 2.00266 | 31.67 | 0.5851 | N200.Glass | 23.09 |
| 21 | −15842.3302 | 15.344 | | | | | 24.09 |

TABLE 46
Example 17

| | Infinite | Short |
|---|---|---|
| | Distance | Range −0.1x |
| Focal Length | 24.48 | 22.66 |
| Back Focus | 15.344 | 15.344 |
| Open F-Number | 2.88 | 2.82 |
| Maximum Full Angle of View [°] | 69.8 | 72.0 |
| DD[7] | 5.138 | 4.680 |
| DD[15] | 2.947 | 1.552 |
| DD[19] | 2.743 | 4.596 |

TABLE 47
Example 17

| Sn | 11 | 12 | 15 | 16 |
|---|---|---|---|---|
| KA | 1.0000000E+00 | 1.0000000E+00 | 1.0000000E+00 | 1.0000000E+00 |
| A4 | −4.5123948E−05 | 1.2917597E−04 | −7.5379251E−05 | 1.9022643E−04 |
| A6 | 1.9625638E−07 | −6.2804339E−07 | −5.5163680E−07 | 1.0028126E−06 |
| A8 | −1.3243096E−07 | −7.9050144E−09 | 7.6109115E−09 | −2.5225404E−09 |
| A10 | 1.0542158E−09 | −3.7946699E−11 | 6.7924677E−12 | −7.5769236E−11 |
| A12 | 5.9233535E−11 | −1.5382597E−12 | −4.2518748E−13 | 3.2423706E−13 |
| A14 | −1.0620958E−12 | 1.5425321E−14 | 3.3155506E−15 | 2.2507516E−15 |
| A16 | −2.7981174E−14 | 7.2069383E−16 | −1.3447357E−17 | −1.9878013E−18 |
| A18 | 5.9469951E−16 | −2.3763749E−18 | 0.0000000E+00 | 0.0000000E+00 |

| Sn | 17 |
|---|---|
| KA | 1.0000000E+00 |
| A4 | 1.5978232E−04 |
| A6 | 9.8048438E−07 |
| A8 | −2.8620783E−09 |
| A10 | −5.6735637E−11 |
| A12 | 2.6265197E−13 |
| A14 | 8.7309655E−16 |
| A16 | −3.2891492E−18 |
| A18 | 0.0000000E+00 |

### Example 18

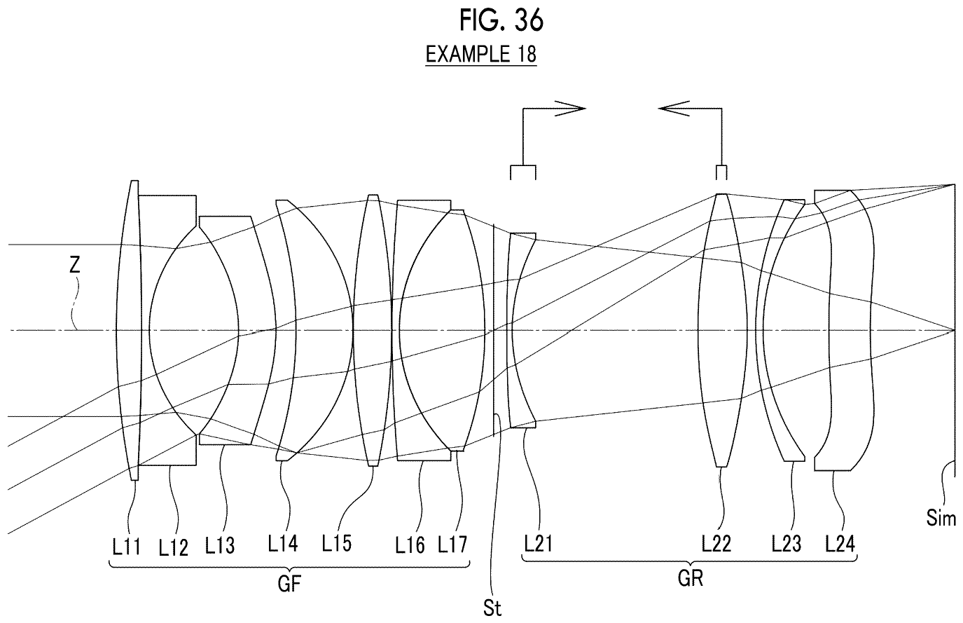

FIG. 36 shows a cross-sectional view of a configuration and luminous fluxes of a fixed-focal-length optical system of Example 18. The fixed-focal-length optical system consists of, in order from the object side to the image side, the front group GF having positive refractive power, the aperture stop St, and the rear group GR having positive refractive power. The front group GF consists of, in order from the object side to the image side, seven lenses including the lenses L11 to L17. The rear group GR consists of, in order from the object side to the image side, four lenses including the lenses L21 to L24. The fixed-focal-length optical system includes two focus lens groups. The focus lens group on the object side consists of the lens L21, and the focus lens group on the image side consists of the lens L22. During focusing from the infinite distance object to the short range object, the focus lens group on the object side moves to the image side, and the focus lens group on the image side moves to the object side.

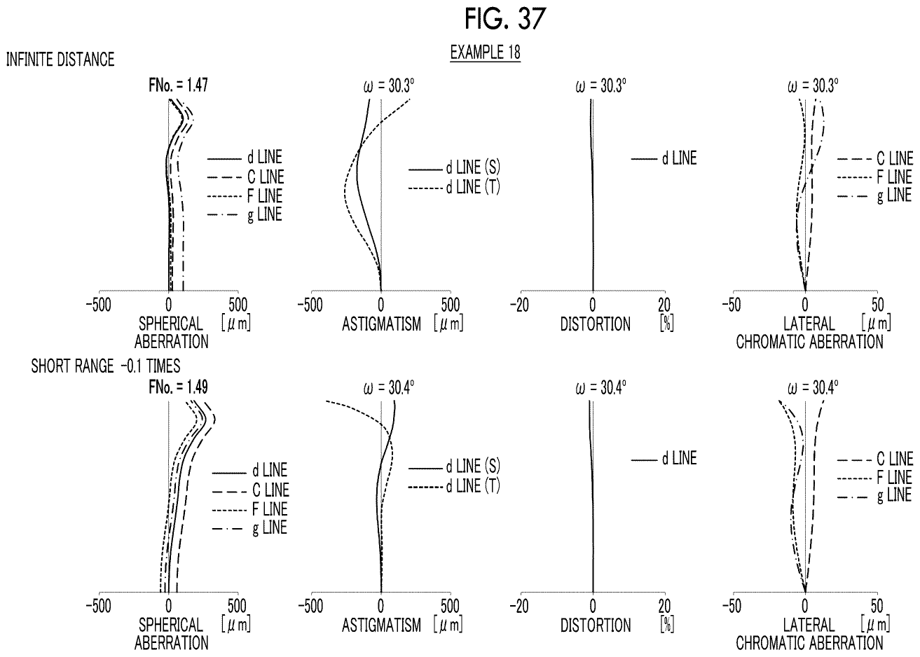

For the fixed-focal-length optical system of Example 18, Table 48 shows basic lens data, Table 49 shows specifications and variable surface spacings, Table 50 shows aspherical coefficients, and FIG. 37 shows each aberration diagram.

TABLE 48
Example 18

| Sn | R | D | Nd | νd | θgF | Material | ED |
|---|---|---|---|---|---|---|---|
| 1 | 113.8886 | 3.269 | 2.16217 | 21.24 | 0.6276 | N216.Glass | 38.66 |
| 2 | −414.4200 | 0.994 | 1.49700 | 81.54 | 0.5375 | S-FPL51.OHARA | 37.83 |
| 3 | 20.6608 | 11.594 | | | | | 29.28 |
| *4 | −20.8077 | 4.771 | 2.00266 | 31.67 | 0.5851 | N200.Glass | 28.94 |
| *5 | −27.8589 | 2.607 | | | | | 32.00 |
| 6 | −61.3129 | 7.392 | 1.59522 | 67.73 | 0.5443 | S-FPM2.OHARA | 35.27 |
| 7 | −23.8532 | 0.049 | | | | | 36.51 |
| 8 | 92.1965 | 4.976 | 1.88300 | 39.22 | 0.5729 | H-ZLAF68N.CDGM | 38.00 |
| 9 | −100.8649 | 0.048 | | | | | 37.89 |
| 10 | 230.1987 | 0.937 | 1.63980 | 34.47 | 0.5923 | S-TIM27.OHARA | 36.48 |
| 11 | 24.7122 | 11.104 | 1.53775 | 74.70 | 0.5394 | S-FPM3.OHARA | 33.77 |
| 12 | −51.6687 | 1.150 | | | | | 33.31 |
| 13 (St) | ∞ | DD[13] | | | | | 29.69 |
| *14 | 304.2981 | 0.705 | 1.82115 | 24.06 | 0.6237 | M-FDS910.HOYA | 27.27 |
| *15 | 26.5790 | DD[15] | | | | | 25.40 |
| *16 | 88.7215 | 6.317 | 2.00266 | 31.67 | 0.5851 | N200.Glass | 38.00 |
| *17 | −51.8311 | DD[17] | | | | | 38.25 |
| 18 | 47.2175 | 0.957 | 1.84666 | 23.78 | 0.6205 | S-TIH53W.OHARA | 36.64 |
| 19 | 31.5498 | 8.534 | | | | | 35.32 |
| *20 | 130.9363 | 5.378 | 1.73077 | 40.51 | 0.5728 | L-LAM69.OHARA | 35.57 |
| *21 | 83.7124 | 10.998 | | | | | 39.28 |

TABLE 49
Example 18

| | Infinite | |
|---|---|---|
| | Distance | Short Range −0.1x |
| Focal Length | 35.30 | 33.61 |
| Back Focus | 10.998 | 10.998 |
| Open F-Number | 1.47 | 1.49 |
| Maximum Full Angle of View [°] | 60.6 | 60.8 |
| DD[13] | 1.698 | 2.101 |
| DD[15] | 24.106 | 21.598 |
| DD[17] | 1.097 | 3.202 |

TABLE 50
Example 18

| Sn | 4 | 5 | 14 | 15 |
|---|---|---|---|---|
| KA | 1.0000000E+00 | 1.0000000E+00 | 1.0000000E+00 | 1.0000000E+00 |
| A4 | 1.7902087E−05 | 2.6093074E−05 | 6.4063800E−06 | −5.0683019E−06 |
| A6 | 4.4830550E−08 | 3.9596126E−08 | −1.1590914E−08 | −3.5001682E−08 |
| A8 | −2.6366823E−10 | −1.9290282E−10 | 3.0472168E−11 | 1.6208257E−10 |
| A10 | 1.9431762E−13 | 2.1188996E−13 | 5.8360773E−14 | −1.8243141E−13 |
| Sn | 16 | 17 | 20 | 21 |
| KA | 1.0000000E+00 | 1.0000000E+00 | 1.0000000E+00 | 1.0000000E+00 |
| A4 | 9.3799546E−06 | 1.9192341E−05 | 1.1746117E−05 | 2.1254793E−06 |
| A6 | −3.4948789E−08 | −5.9603555E−08 | −2.0596591E−07 | −2.0262568E−07 |
| A8 | 7.6665017E−11 | 1.1850959E−10 | 3.3504674E−10 | 4.2811318E−10 |
| A10 | −9.1600255E−14 | −1.2042832E−13 | −3.3815294E−13 | −3.5950467E−13 |

### Example 19

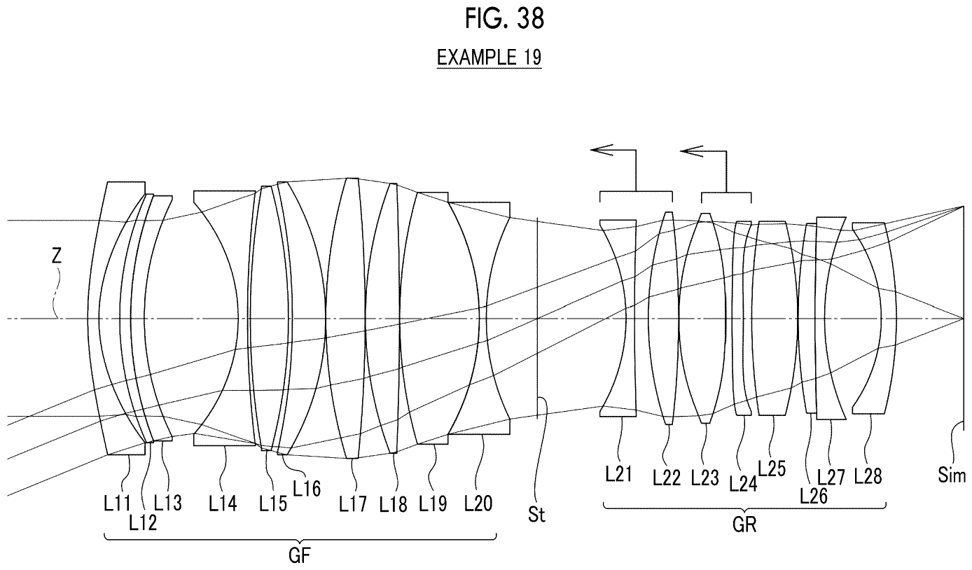

FIG. 38 shows a cross-sectional view of a configuration and luminous fluxes of a fixed-focal-length optical system of Example 19. The fixed-focal-length optical system consists of, in order from the object side to the image side, the front group GF having positive refractive power, the aperture stop St, and the rear group GR having positive refractive power. The front group GF consists of, in order from the object side to the image side, 10 lenses including the lenses L11 to L20. The rear group GR consists of, in order from the object side to the image side, eight lenses including the lenses L21 to L28. The fixed-focal-length optical system includes two focus lens groups. The focus lens group on the object side consists of the lenses L21 and L22, and the focus lens group on the image side consists of the lenses L23 and L24. During focusing from the infinite distance object to the short range object, the focus lens group on the object side and the focus lens group on the image side move to the object side by changing a mutual spacing.

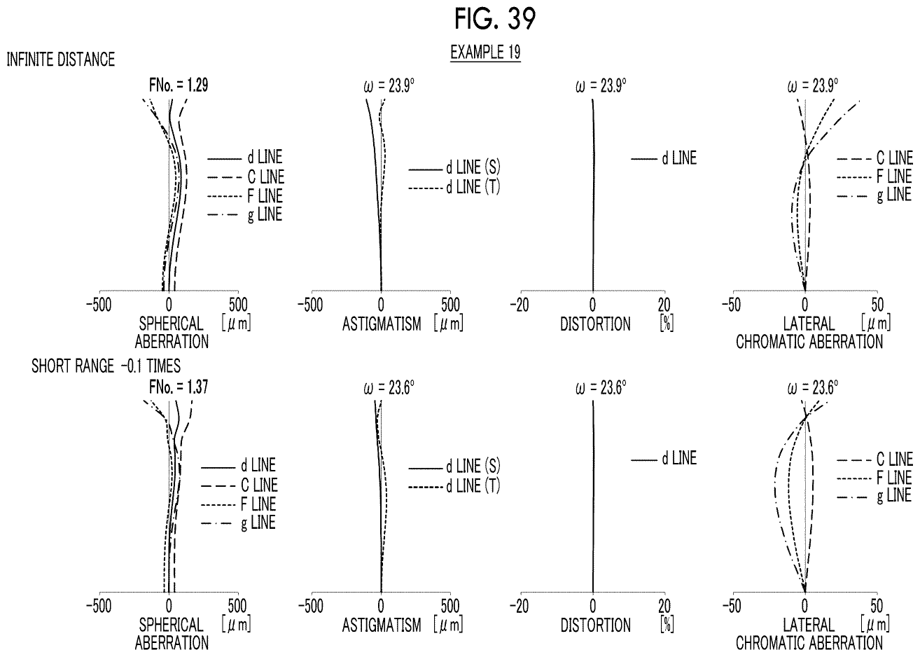

For the fixed-focal-length optical system of Example 19, Table 51 shows basic lens data, Table 52 shows specifications and variable surface spacings, Table 53 shows aspherical coefficients, and FIG. 39 shows each aberration diagram.

TABLE 51
Example 19

| Sn | R | D | Nd | νd | θgF | Material | ED |
|---|---|---|---|---|---|---|---|
| *1 | 68.5953 | 2.000 | 1.63858 | 55.18 | 0.5532 | M-PCD55AR.HOYA | 52.64 |
| *2 | 33.7513 | 3.705 | | | | | 48.00 |
| 3 | 62.7261 | 1.942 | 2.16217 | 21.24 | 0.6276 | N216.Glass | 47.94 |
| 4 | 70.7288 | 2.435 | 1.51680 | 64.20 | 0.5343 | BSC7.HOYA | 47.26 |
| 5 | 55.0202 | 16.719 | | | | | 45.70 |
| 6 | −35.5387 | 1.557 | 1.53996 | 59.46 | 0.5442 | S-BAL12.OHARA | 44.72 |
| 7 | 215.3226 | 0.503 | | | | | 49.13 |
| 8 | 158.8088 | 6.775 | 1.75500 | 52.32 | 0.5476 | S-LAH97.OHARA | 50.00 |
| 9 | −107.0292 | 0.726 | | | | | 50.98 |
| 10 | −126.4245 | 5.908 | 1.75500 | 52.32 | 0.5476 | S-LAH97.OHARA | 51.70 |
| 11 | −53.9141 | 0.050 | | | | | 52.62 |
| 12 | 101.6321 | 6.990 | 1.59522 | 67.73 | 0.5443 | S-FPM2.OHARA | 54.04 |
| 13 | −295.0201 | 0.050 | | | | | 53.78 |
| 14 | 79.3118 | 6.058 | 1.59522 | 67.73 | 0.5443 | S-FPM2.OHARA | 52.03 |
| 15 | −710.1477 | 0.050 | | | | | 51.49 |
| 16 | 95.1559 | 14.173 | 1.55200 | 70.70 | 0.5422 | S-FPM5.OHARA | 48.55 |
| 17 | −47.6538 | 1.237 | 1.67300 | 38.26 | 0.5758 | S-NBH52V.OHARA | 44.72 |
| 18 | 47.0241 | 9.097 | | | | | 38.82 |
| 19 (St) | ∞ | DD[19] | | | | | 37.57 |
| 20 | −37.0039 | 1.519 | 1.73800 | 32.33 | 0.5900 | S-NBH53V.OHARA | 35.97 |
| 21 | 572.3438 | 2.449 | | | | | 37.88 |
| 22 | 69.8147 | 5.396 | 1.72916 | 54.68 | 0.5445 | S-LAL18.OHARA | 40.89 |
| 23 | −187.4371 | DD[23] | | | | | 40.95 |
| *24 | 56.1945 | 8.289 | 1.59201 | 67.02 | 0.5359 | M-PCD51.HOYA | 40.47 |
| *25 | −174.1765 | 1.081 | | | | | 40.00 |
| *26 | 408.7488 | 2.000 | 1.76450 | 49.10 | 0.5529 | L-LAH91.OHARA | 37.36 |
| *27 | −217.3562 | DD[27] | | | | | 36.00 |
| 28 | 134.6195 | 8.178 | 1.49700 | 81.54 | 0.5375 | S-FPL51.OHARA | 37.31 |
| 29 | −80.3122 | 0.100 | | | | | 37.37 |
| 30 | 113.0081 | 3.000 | 2.30909 | 17.89 | 0.6452 | N231.Glass | 36.52 |
| 31 | 588.0992 | 1.696 | 1.72047 | 34.71 | 0.5835 | S-NBH8.OHARA | 36.01 |
| 32 | 51.3287 | 10.094 | | | | | 34.44 |
| 33 | −31.1814 | 2.690 | 1.71736 | 29.52 | 0.6048 | S-TIH1.OHARA | 34.21 |
| 34 | −80.3990 | 12.001 | | | | | 36.82 |

TABLE 52
Example 19

| | Infinite | |
|---|---|---|
| | Distance | Short Range −0.1x |
| Focal Length | 48.76 | 45.25 |
| Back Focus | 12.001 | 12.001 |
| Open F-Number | 1.29 | 1.37 |
| Maximum Full Angle of View [°] | 47.8 | 47.2 |
| DD[19] | 15.793 | 7.777 |
| DD[23] | 0.050 | 1.225 |
| DD[27] | 1.500 | 8.341 |

TABLE 53
Example 19

| Sn | 1 | 2 | 25 | 26 |
|---|---|---|---|---|
| KA | 1.0000000E+00 | 8.6370000E−01 | 1.0000000E+00 | 1.0000000E+00 |
| A4 | −5.7306967E−06 | −5.9779803E−06 | −2.1978435E−05 | −4.8641618E−06 |
| A6 | 4.2364772E−09 | 2.2257963E−09 | 4.6737351E−08 | 2.0090564E−08 |
| A8 | −1.5435334E−12 | 1.2355173E−13 | −4.5634837E−11 | 5.6856390E−12 |
| A10 | 0.0000000E+00 | 7.0757800E−17 | 1.0740400E−14 | 3.5950800E−15 |

| Sn | 24 | 27 |
|---|---|---|
| KA | 1.0000000E+00 | 1.0000000E+00 |
| A4 | 3.1713740E−06 | 1.9853060E−05 |
| A6 | 3.5044959E−09 | −5.4358380E−09 |
| A8 | −1.8578941E−11 | 2.5591911E−11 |

### Example 20

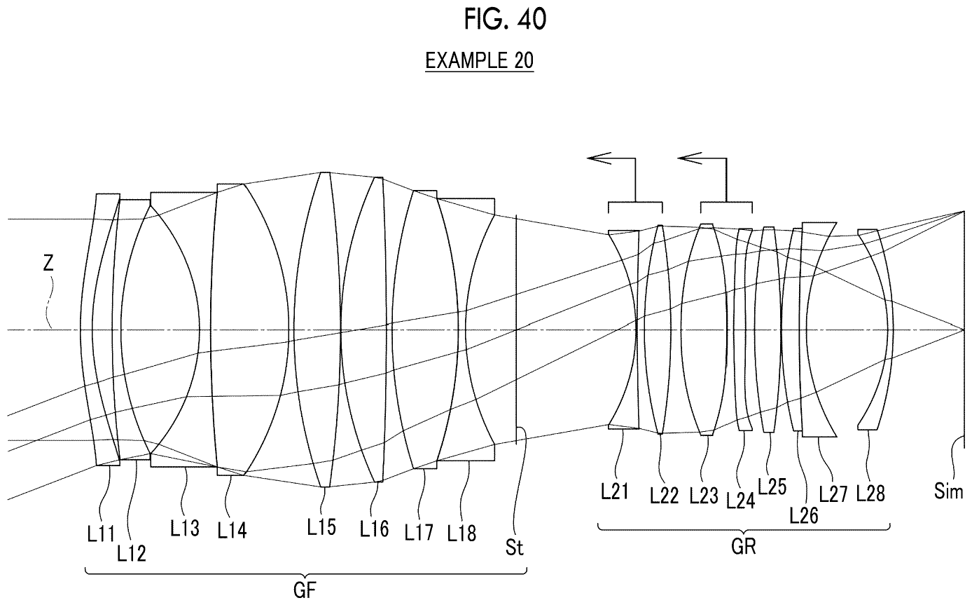

FIG. 40 shows a cross-sectional view of a configuration and luminous fluxes of a fixed-focal-length optical system of Example 20. The fixed-focal-length optical system consists of, in order from the object side to the image side, the front group GF having positive refractive power, the aperture stop St, and the rear group GR having positive refractive power. The front group GF consists of, in order from the object side to the image side, eight lenses including the lenses L11 to L18. The rear group GR consists of, in order from the object side to the image side, eight lenses including the lenses L21 to L28. The fixed-focal-length optical system includes two focus lens groups. The focus lens group on the object side consists of the lenses L21 and L22, and the focus lens group on the image side consists of the lenses L23 and L24. During focusing from the infinite distance object to the short range object, the focus lens group on the object side and the focus lens group on the image side move to the object side by changing a mutual spacing.

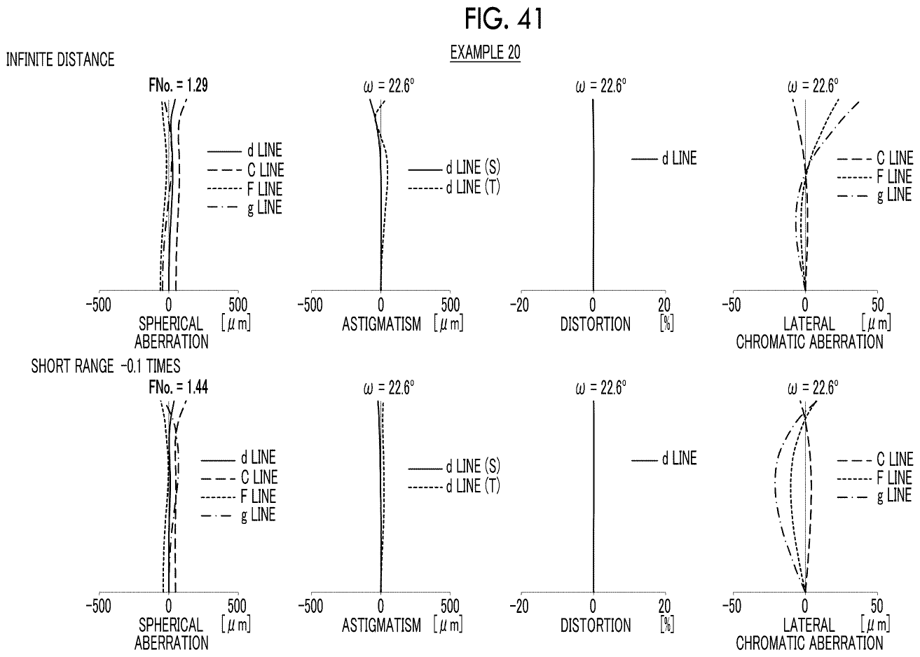

For the fixed-focal-length optical system of Example 20, Table 54 shows basic lens data, Table 55 shows specifications and variable surface spacings, Table 56 shows aspherical coefficients, and FIG. 41 shows each aberration diagram.

TABLE 54
Example 20

| Sn | R | D | Nd | νd | θgF | Material | ED |
|---|---|---|---|---|---|---|---|
| *1 | 63.3610 | 2.000 | 1.63858 | 55.18 | 0.5532 | M-PCD55AR.HOYA | 49.51 |
| *2 | 46.4034 | 3.364 | | | | | 47.43 |
| 3 | 213.1184 | 1.464 | 1.49700 | 81.54 | 0.5375 | S-FPL51.OHARA | 47.36 |
| 4 | 54.1061 | 13.257 | | | | | 45.16 |
| 5 | −35.0979 | 1.891 | 1.53996 | 59.46 | 0.5442 | S-BAL12.OHARA | 45.13 |
| 6 | 280.2545 | 13.092 | 1.75500 | 52.32 | 0.5476 | S-LAH97.OHARA | 50.00 |
| 7 | −50.5122 | 0.856 | | | | | 53.08 |
| 8 | 93.3044 | 7.833 | 1.59522 | 67.73 | 0.5443 | S-FPM2.OHARA | 57.28 |
| 9 | −226.6143 | 0.073 | | | | | 57.21 |
| 10 | 70.6167 | 7.682 | 1.59522 | 67.73 | 0.5443 | S-FPM2.OHARA | 55.51 |
| 11 | −620.9655 | 0.949 | | | | | 54.88 |
| 12 | 90.4201 | 11.177 | 1.55200 | 70.70 | 0.5422 | S-FPM5.OHARA | 50.63 |
| 13 | −80.6793 | 1.219 | 1.67300 | 38.26 | 0.5758 | S-NBH52V.OHARA | 47.73 |
| 14 | 46.9959 | 8.555 | | | | | 41.76 |
| 15 (St) | ∞ | DD[15] | | | | | 40.38 |
| 16 | −34.8217 | 0.217 | 1.73800 | 32.33 | 0.5900 | S-NBH53V.OHARA | 34.74 |
| 17 | 528.7089 | 1.199 | | | | | 36.14 |
| 18 | 79.7714 | 4.464 | 1.72916 | 54.68 | 0.5445 | S-LAL18.OHARA | 37.93 |
| 19 | −126.5557 | DD[19] | | | | | 38.00 |
| *20 | 65.6588 | 7.727 | 1.59201 | 67.02 | 0.5359 | M-PCD51.HOYA | 38.46 |
| *21 | −225.5118 | 1.094 | | | | | 38.00 |
| *22 | 200.2331 | 2.000 | 1.76450 | 49.10 | 0.5529 | L-LAH91.OHARA | 36.72 |
| *23 | −172.6671 | DD[23] | | | | | 36.00 |
| 24 | 112.4017 | 4.447 | 1.49700 | 81.54 | 0.5375 | S-FPL51.OHARA | 37.41 |
| 25 | −149.4825 | 0.100 | | | | | 37.39 |
| 26 | 84.2430 | 3.000 | 2.30909 | 17.89 | 0.6452 | N231.Glass | 36.91 |
| 27 | 327.3715 | 1.197 | 1.74077 | 27.79 | 0.6096 | S-TIH13.OHARA | 36.45 |
| 28 | 39.6017 | 13.707 | | | | | 34.65 |
| 29 | −32.5298 | 0.944 | 1.71736 | 29.52 | 0.6048 | S-TIH1.OHARA | 34.81 |
| 30 | −62.3486 | 11.857 | | | | | 36.52 |

TABLE 55
Example 20

| | Infinite | |
|---|---|---|
| | Distance | Short Range −0.1x |
| Focal Length | 51.91 | 47.62 |
| Back Focus | 11.857 | 11.857 |
| Open F-Number | 1.29 | 1.44 |
| Maximum Full Angle of View [°] | 45.2 | 45.2 |
| DD[15] | 20.185 | 11.381 |
| DD[19] | 1.694 | 3.082 |
| DD[23] | 1.500 | 8.917 |

TABLE 56
Example 20

| Sn | 1 | 2 | 20 | 21 |
|---|---|---|---|---|
| KA | 1.0000000E+00 | 8.6370000E−01 | 1.0000000E+00 | 1.0000000E+00 |
| A4 | −7.3814636E−06 | −6.9955346E−06 | 3.9430219E−06 | −2.3226709E−05 |
| A6 | 3.1970387E−09 | 3.1763218E−09 | 5.5115144E−09 | 4.5550867E−08 |
| A8 | −2.0217876E−12 | −2.4287750E−12 | −1.8477609E−11 | −4.2525500E−11 |
| A10 | 0.0000000E+00 | 7.0757800E−17 | 0.0000000E+00 | 1.0740400E−14 |

| Sn | 22 | 23 |
|---|---|---|
| KA | 1.0000000E+00 | 1.0000000E+00 |
| A4 | −8.2041530E−06 | 1.7034423E−05 |
| A6 | 2.2572522E−08 | −3.1590444E−09 |
| A8 | 9.0779470E−12 | 3.4169246E−11 |
| A10 | 3.5950800E−15 | |

### Example 21

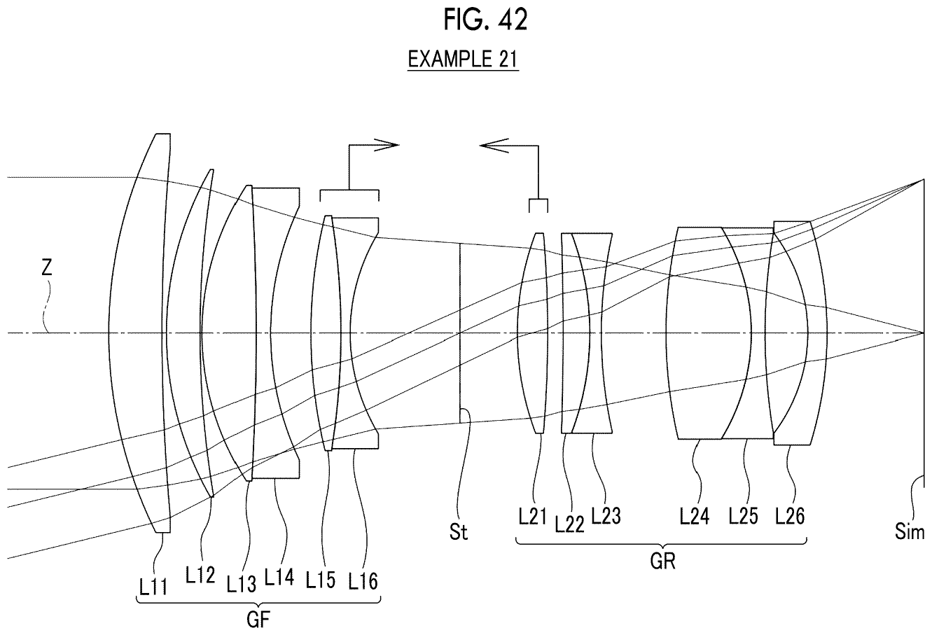

FIG. 42 shows a cross-sectional view of a configuration and luminous fluxes of a fixed-focal-length optical system of Example 21. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, six lenses including the lenses L21 to L26. The fixed-focal-length optical system includes two focus lens groups. The focus lens group on the object side consists of the lenses L15 and L16, and the focus lens group on the image side consists of the lens L21. During focusing from the infinite distance object to the short range object, the focus lens group on the object side moves to the image side, and the focus lens group on the image side moves to the object side.

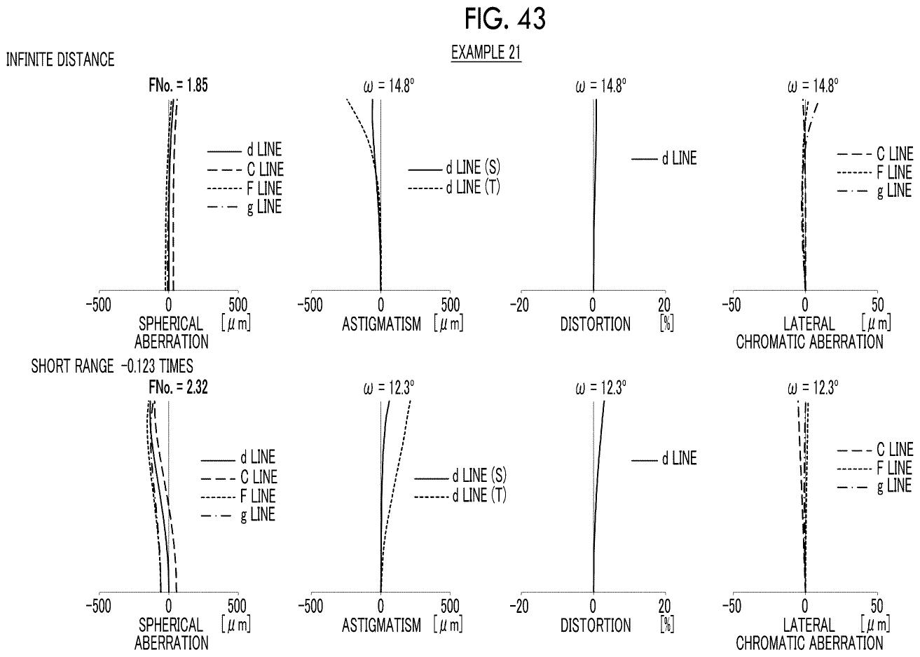

For the fixed-focal-length optical system of Example 21, Table 57 shows basic lens data, Table 58 shows specifications and variable surface spacings, and FIG. 43 shows each aberration diagram.

TABLE 57
Example 21

| Sn | R | D | Nd | νd | θgF | Material | ED |
|---|---|---|---|---|---|---|---|
| 1 | 67.1798 | 6.919 | 1.72916 | 54.68 | 0.5445 | S-LAL18.OHARA | 53.40 |
| 2 | 312.4324 | 0.571 | | | | | 51.76 |
| 3 | 49.2223 | 4.363 | 1.49700 | 81.54 | 0.5375 | S-FPL51.OHARA | 46.00 |
| 4 | 149.4064 | 0.250 | | | | | 45.69 |
| 5 | 40.5621 | 6.971 | 1.59522 | 67.73 | 0.5443 | S-FPM2.OHARA | 41.49 |
| 6 | −369.3860 | 1.881 | 1.90366 | 31.34 | 0.5964 | S-LAH95.OHARA | 40.74 |
| 7 | 44.4618 | DD[7] | | | | | 35.60 |
| 8 | 74.7861 | 3.900 | 1.89286 | 20.36 | 0.6394 | S-NPH4.OHARA | 32.94 |
| 9 | −110.6105 | 1.200 | 1.80100 | 34.97 | 0.5864 | S-LAM66.OHARA | 32.39 |
| 10 | 29.0325 | DD[10] | | | | | 28.24 |
| 11 (St) | ∞ | DD[11] | | | | | 25.20 |
| 12 | 42.7555 | 3.935 | 1.59522 | 67.73 | 0.5443 | S-FPM2.OHARA | 28.00 |
| 13 | −180.3484 | DD[13] | | | | | 28.05 |
| 14 | −474.7162 | 3.475 | 2.00266 | 31.67 | 0.5851 | N200.Glass | 28.00 |
| 15 | −42.4414 | 1.500 | 1.75520 | 27.51 | 0.6103 | S-TIH4.OHARA | 28.03 |
| 16 | 68.4190 | 8.400 | | | | | 27.63 |
| 17 | 70.3789 | 11.000 | 1.83481 | 42.74 | 0.5649 | S-LAH55VS.OHARA | 29.70 |
| 18 | −30.1875 | 1.792 | 1.57135 | 52.95 | 0.5554 | S-BAL3.OHARA | 29.55 |
| 19 | 92.1161 | 5.548 | | | | | 28.02 |
| 20 | −24.5364 | 2.500 | 1.62004 | 36.26 | 0.5880 | S-TIM2.OHARA | 28.00 |
| 21 | −57.0134 | 12.615 | | | | | 31.36 |

TABLE 58
Example 21

| | Infinite | |
|---|---|---|
| | Distance | Short Range −0.123x |
| Focal Length | 81.00 | 74.76 |
| Back Focus | 12.615 | 12.615 |
| Open F-Number | 1.85 | 2.32 |
| Maximum Full Angle of View [°] | 29.6 | 24.6 |
| DD[7] | 5.224 | 9.898 |
| DD[10] | 14.272 | 9.604 |
| DD[11] | 7.442 | 1.900 |
| DD[13] | 2.000 | 7.540 |

### Example 22

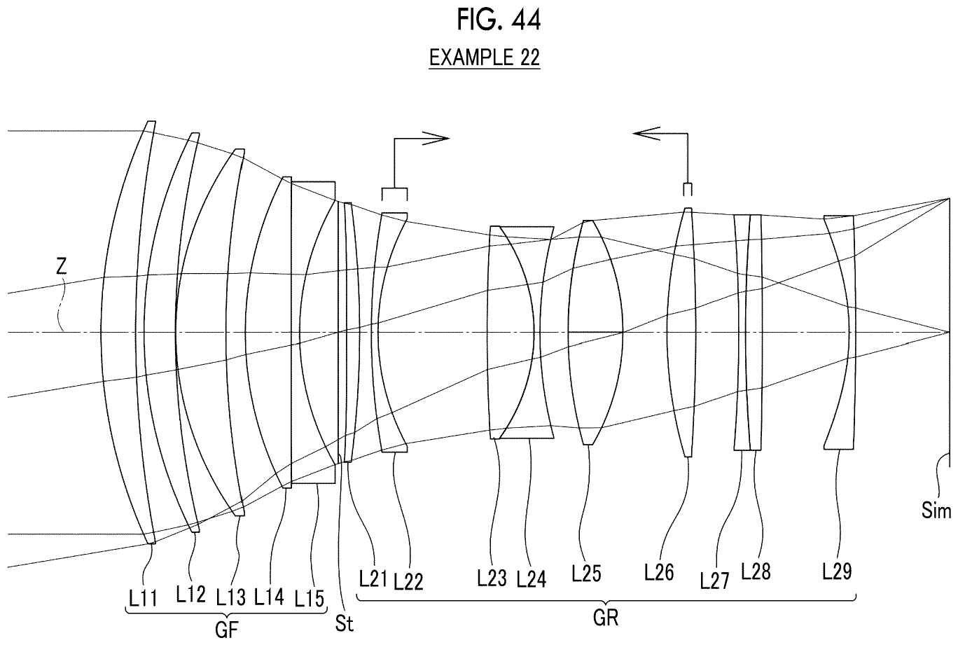

FIG. 44 shows a cross-sectional view of a configuration and luminous fluxes of a fixed-focal-length optical system of Example 22. The fixed-focal-length optical system consists of, in order from the object side to the image side, the front group GF having positive refractive power, the aperture stop St, and the rear group GR having negative refractive power. The front group GF consists of, in order from the object side to the image side, five lenses including the lenses L11 to L15. The rear group GR consists of, in order from the object side to the image side, nine lenses including the lenses L21 to L29. The fixed-focal-length optical system includes two focus lens groups. The focus lens group on the object side consists of the lens L22, and the focus lens group on the image side consists of the lens L26. During focusing from the infinite distance object to the short range object, the focus lens group on the object side moves to the image side, and the focus lens group on the image side moves to the object side.

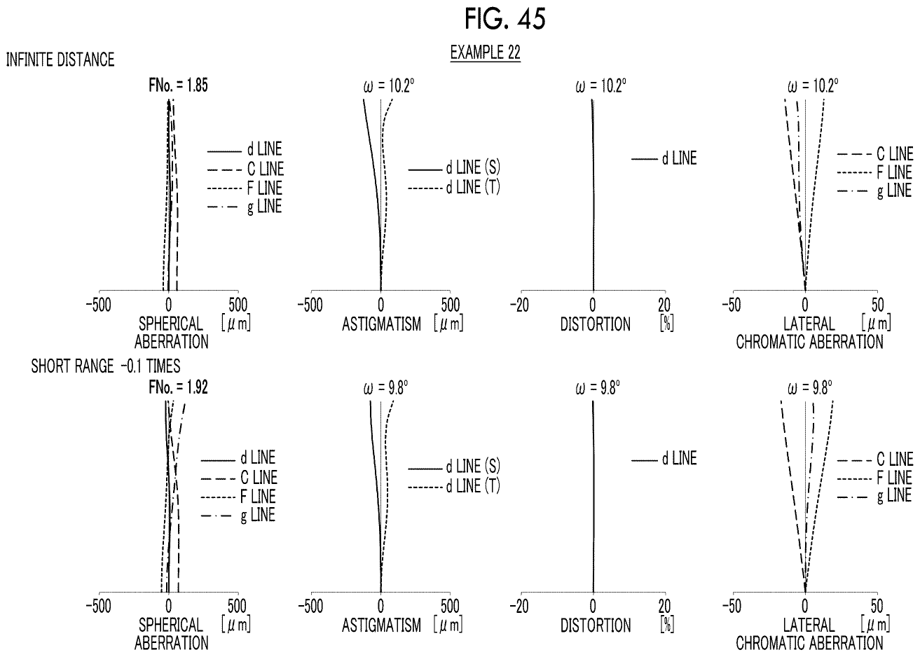

For the fixed-focal-length optical system of Example 22, Table 59 shows basic lens data, Table 60 shows specifications and variable surface spacings, Table 61 shows aspherical coefficients, and FIG. 45 shows each aberration diagram.

TABLE 59
Example 22

| Sn | R | D | Nd | νd | θgF | Material | ED |
|---|---|---|---|---|---|---|---|
| 1 | 86.1949 | 5.165 | 2.00266 | 31.67 | 0.5851 | N200.Glass | 68.00 |
| 2 | 194.2716 | 1.250 | | | | | 67.47 |
| 3 | 76.1257 | 4.674 | 1.49700 | 81.54 | 0.5375 | S-FPL51.OHARA | 64.23 |
| 4 | 143.1453 | 0.050 | | | | | 63.43 |
| 5 | 53.5108 | 7.466 | 1.49700 | 81.54 | 0.5375 | S-FPL51.OHARA | 58.98 |
| 6 | 158.0132 | 2.799 | | | | | 57.75 |
| 7 | 58.6763 | 6.843 | 1.49700 | 81.54 | 0.5375 | S-FPL51.OHARA | 50.04 |
| 8 | 8943.6290 | 1.241 | 1.84666 | 23.78 | 0.6205 | S-TIH53W.OHARA | 48.51 |
| 9 | 45.4366 | 5.750 | | | | | 42.53 |
| 10 (St) | ∞ | 1.250 | | | | | 42.15 |
| *11 | −26627.1099 | 1.937 | 1.51633 | 64.06 | 0.5334 | L-BSL7.OHARA | 41.72 |
| 12 | −172.8360 | DD[12] | | | | | 41.47 |
| 13 | 116.9364 | 0.987 | 1.61800 | 63.33 | 0.5441 | S-PHM52.OHARA | 38.44 |
| 14 | 40.6080 | DD[14] | | | | | 36.53 |
| 15 | 309.9713 | 6.986 | 1.85896 | 22.73 | 0.6284 | S-NPH5.OHARA | 34.19 |
| 16 | −30.7109 | 0.869 | 2.00266 | 31.67 | 0.5851 | N200.Glass | 34.00 |
| 17 | 69.8688 | 4.197 | | | | | 33.76 |
| 18 | 72.2942 | 8.155 | 1.49700 | 81.54 | 0.5375 | S-FPL51.OHARA | 35.79 |
| *19 | −38.5513 | DD[19] | | | | | 36.00 |
| 20 | 76.2014 | 4.270 | 1.49700 | 81.54 | 0.5375 | S-FPL51.OHARA | 38.69 |
| 21 | −312.9682 | DD[21] | | | | | 38.64 |
| 22 | −249.8693 | 1.010 | 1.80100 | 34.97 | 0.5864 | S-LAM66.OHARA | 37.84 |
| 23 | 250.0225 | 2.500 | 2.30909 | 17.89 | 0.6452 | N231.Glass | 37.84 |
| 24 | −833.3492 | 12.923 | | | | | 37.78 |
| *25 | −39.3984 | 0.964 | 1.80610 | 40.73 | 0.5694 | M-NBFD130.HOYA | 36.44 |
| 26 | −526.0427 | 14.005 | | | | | 37.53 |

TABLE 60
Example 22

| | Infinite | |
|---|---|---|
| | Distance | Short Range −0.1x |
| Focal Length | 120.01 | 100.61 |
| Back Focus | 14.005 | 14.005 |
| Open F-Number | 1.85 | 1.92 |
| Maximum Full Angle of View [°] | 20.4 | 19.6 |
| DD[12] | 1.750 | 8.161 |
| DD[14] | 16.250 | 9.839 |
| DD[19] | 6.565 | 2.067 |
| DD[21] | 6.332 | 10.830 |

TABLE 61
Example 22

| Sn | 11 | 19 | 25 |
|---|---|---|---|
| KA | 1.0000000E+00 | 1.0000000E+00 | 1.0000000E+00 |
| A4 | −2.0052457E−06 | −3.0481551E−07 | 6.0699292E−06 |
| A6 | 6.3400818E−10 | −5.6262276E−10 | 2.8884507E−09 |
| A8 | −3.9875093E−13 | 1.1253270E−12 | −7.7852281E−12 |
| A10 | 3.1360000E−16 | −1.1510000E−16 | 5.7240000E−15 |

### Example 23

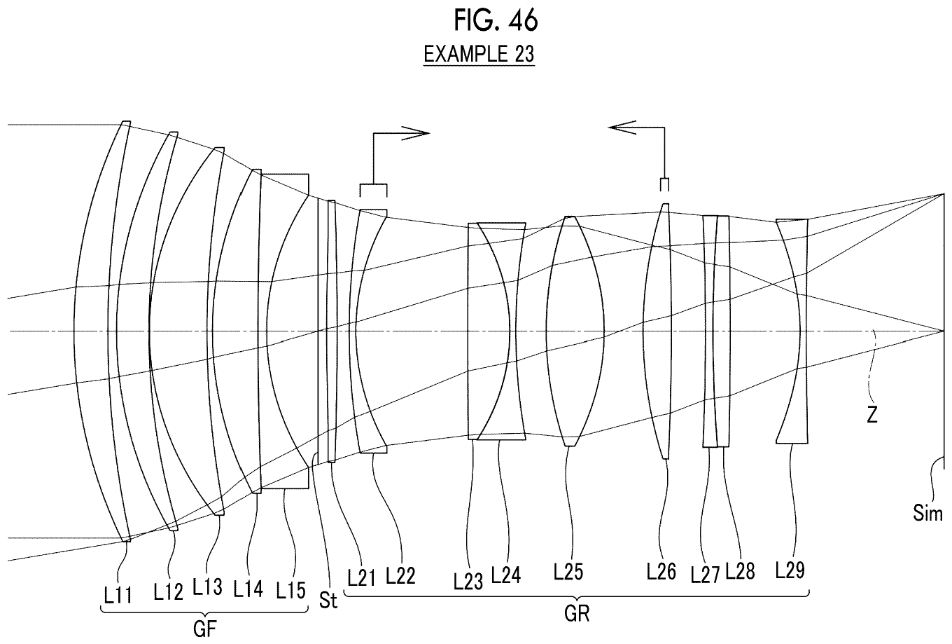

FIG. 46 shows a cross-sectional view of a configuration and luminous fluxes of a fixed-focal-length optical system of Example 23. The fixed-focal-length optical system consists of, in order from the object side to the image side, the front group GF having positive refractive power, the aperture stop St, and the rear group GR having negative refractive power. The front group GF consists of, in order from the object side to the image side, five lenses including the lenses L11 to L15. The rear group GR consists of, in order from the object side to the image side, nine lenses including the lenses L21 to L29. The fixed-focal-length optical system includes two focus lens groups. The focus lens group on the object side consists of the lens L22, and the focus lens group on the image side consists of the lens L26. During focusing from the infinite distance object to the short range object, the focus lens group on the object side moves to the image side, and the focus lens group on the image side moves to the object side.

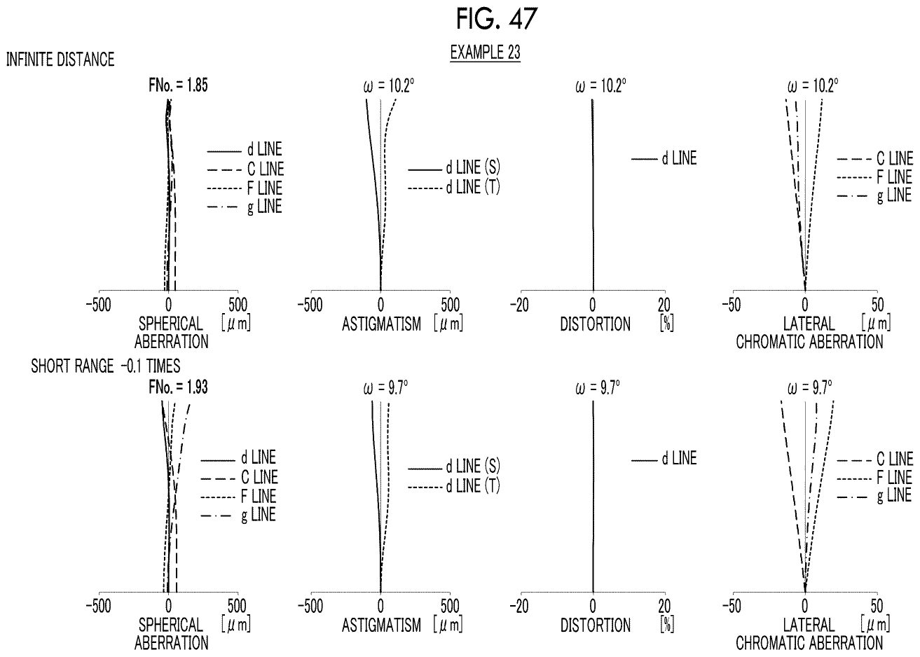

For the fixed-focal-length optical system of Example 23, Table 62 shows basic lens data, Table 63 shows specifications and variable surface spacings, Table 64 shows aspherical coefficients, and FIG. 47 shows each aberration diagram.

TABLE 62
Example 23

| Sn | R | D | Nd | νd | θgF | Material | ED |
|---|---|---|---|---|---|---|---|
| 1 | 80.3311 | 4.937 | 2.00100 | 29.14 | 0.5997 | S-LAH99W.OHARA | 66.00 |
| 2 | 165.1112 | 1.250 | | | | | 65.48 |
| 3 | 66.8784 | 4.704 | 1.49700 | 81.54 | 0.5375 | S-FPL51.OHARA | 62.55 |
| 4 | 116.0153 | 0.064 | | | | | 61.78 |
| 5 | 48.4042 | 8.375 | 1.49700 | 81.54 | 0.5375 | S-FPL51.OHARA | 57.71 |
| 6 | 163.2646 | 0.780 | | | | | 56.45 |
| 7 | 58.9605 | 6.534 | 1.49700 | 81.54 | 0.5375 | S-FPL51.OHARA | 50.86 |
| 8 | 646.5398 | 1.260 | 1.84666 | 23.78 | 0.6205 | S-TIH53W.OHARA | 49.34 |
| 9 | 40.5124 | 7.460 | | | | | 42.76 |
| 10 (St) | ∞ | 1.250 | | | | | 41.79 |
| *11 | 355.8858 | 1.522 | 1.51633 | 64.06 | 0.5334 | L-BSL7.OHARA | 41.08 |
| 12 | −679.9846 | DD[12] | | | | | 40.77 |
| 13 | 115.2060 | 0.981 | 1.61800 | 63.33 | 0.5441 | S-PHM52.OHARA | 38.18 |
| 14 | 38.6519 | DD[14] | | | | | 36.17 |
| 15 | 2200.5167 | 6.103 | 1.85896 | 22.73 | 0.6284 | S-NPH5.OHARA | 33.88 |
| 16 | −32.7658 | 0.871 | 2.00266 | 31.67 | 0.5851 | N200.Glass | 33.77 |
| 17 | 100.5559 | 4.411 | | | | | 33.83 |
| 18 | 60.3168 | 8.420 | 1.49700 | 81.54 | 0.5375 | S-FPL51.OHARA | 35.96 |
| *19 | −38.8222 | DD[19] | | | | | 36.00 |
| 20 | 70.7330 | 4.110 | 1.49700 | 81.54 | 0.5375 | S-FPL51.OHARA | 37.45 |
| 21 | −453.0894 | DD[21] | | | | | 37.32 |
| 22 | −446.3133 | 1.010 | 1.80100 | 34.97 | 0.5864 | S-LAM66.OHARA | 36.33 |
| 23 | 250.0225 | 2.500 | 2.30909 | 17.89 | 0.6452 | N231.Glass | 36.19 |
| 24 | −835.8039 | 10.144 | | | | | 36.04 |
| *25 | −39.7733 | 0.906 | 1.80610 | 40.73 | 0.5694 | M-NBFD130.HOYA | 34.22 |
| 26 | 754.7711 | 20.002 | | | | | 35.13 |

TABLE 63
Example 23

| | Infinite | |
|---|---|---|
| | Distance | Short Range −0.1x |
| Focal Length | 120.03 | 103.10 |
| Back Focus | 20.002 | 20.002 |
| Open F-Number | 1.85 | 1.93 |
| Maximum Full Angle of View [°] | 20.4 | 19.4 |
| DD[12] | 1.750 | 8.478 |
| DD[14] | 16.250 | 9.522 |
| DD[19] | 5.645 | 1.930 |
| DD[21] | 4.948 | 8.663 |

TABLE 64
Example 23

| Sn | 11 | 19 | 25 |
|---|---|---|---|
| KA | 1.0000000E+00 | 1.0000000E+00 | 1.0000000E+00 |
| A4 | −2.3193999E−06 | 1.1729265E−06 | 5.2926903E−06 |
| A6 | 3.3199423E−10 | −1.8166798E−11 | −6.4981092E−10 |
| A8 | −5.8104577E−14 | 2.6195757E−12 | −5.2676471E−12 |
| A10 | 3.1360000E−16 | −1.1510000E−16 | 5.7240000E−15 |

### Example 24

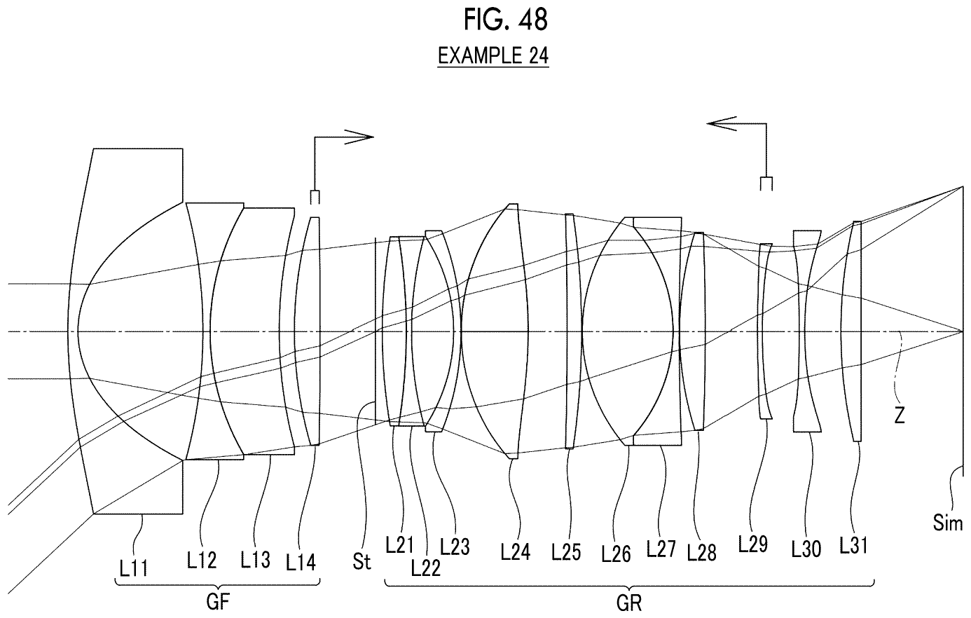

FIG. 48 shows a cross-sectional view of a configuration and luminous fluxes of a fixed-focal-length optical system of Example 24. The fixed-focal-length optical system consists of, in order from the object side to the image side, the front group GF having negative refractive power, the aperture stop St, and the rear group GR having positive refractive power. The front group GF consists of, in order from the object side to the image side, four lenses including the lenses L11 to L14. The rear group GR consists of, in order from the object side to the image side, 11 lenses including the lenses L21 to L31. The fixed-focal-length optical system includes two focus lens groups. The focus lens group on the object side consists of the lens L14, and the focus lens group on the image side consists of the lens L29. During focusing from the infinite distance object to the short range object, the focus lens group on the object side moves to the image side, and the focus lens group on the image side moves to the object side.

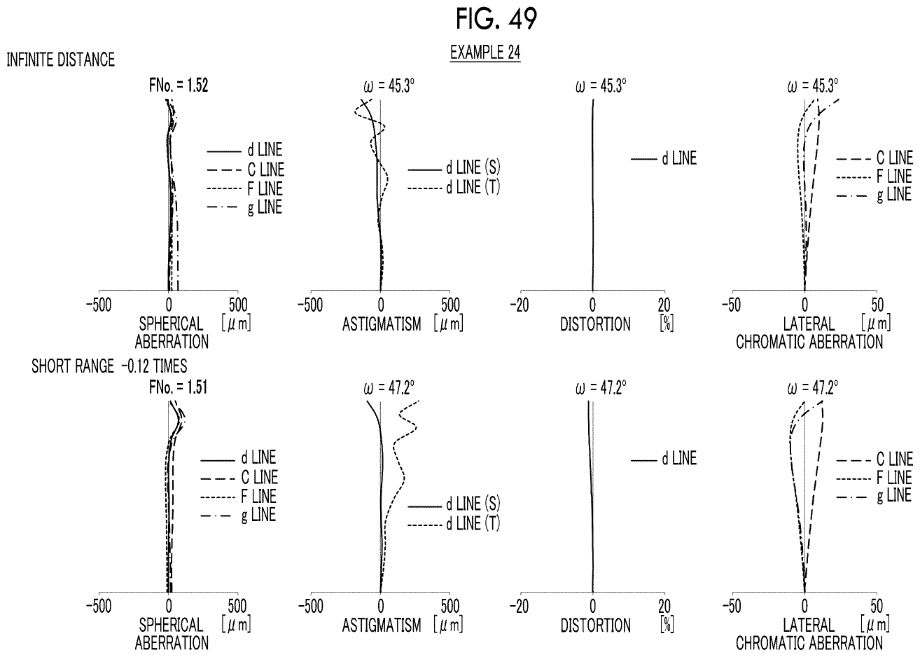

For the fixed-focal-length optical system of Example 24, Table 65 shows basic lens data, Table 66 shows specifications and variable surface spacings, Tables 67A and 67B show aspherical coefficients, and FIG. 49 shows each aberration diagram.

TABLE 65
Example 24

| Sn | R | D | Nd | νd | θgF | Material | ED |
|---|---|---|---|---|---|---|---|
| *1 | 75.3033 | 1.391 | 1.48749 | 70.24 | 0.5301 | S-FSL5.OHARA | 54.95 |
| *2 | 15.5023 | 17.259 | | | | | 38.62 |
| 3 | −78.8097 | 0.993 | 1.52841 | 76.45 | 0.5395 | S-FPM4.OHARA | 38.36 |
| 4 | 38.7202 | 9.462 | 1.84666 | 23.78 | 0.6205 | S-TIH53W.OHARA | 36.78 |
| 5 | 71.8794 | DD[5] | | | | | 35.15 |
| 6 | 65.3437 | 3.537 | 1.88300 | 39.22 | 0.5729 | H-ZLAF68N.CDGM | 34.72 |
| 7 | −1149.3174 | DD[7] | | | | | 34.29 |
| 8 (St) | ∞ | 0.941 | | | | | 27.75 |
| 9 | 90.7512 | 3.309 | 1.49700 | 81.54 | 0.5375 | S-FPL51.OHARA | 28.17 |
| 10 | −94.9551 | 0.740 | 1.54814 | 45.78 | 0.5686 | S-TIL1.OHARA | 28.18 |
| 11 | 58.3009 | 5.807 | | | | | 28.22 |
| 12 | −27.6043 | 1.012 | 2.16217 | 21.24 | 0.6276 | N216.Glass | 28.27 |
| 13 | −43.3776 | 0.048 | | | | | 30.12 |
| *14 | 31.5252 | 9.231 | 1.53775 | 74.70 | 0.5394 | S-FPM3.OHARA | 37.00 |
| *15 | −72.4624 | 5.381 | | | | | 36.83 |
| 16 | −718.9981 | 2.000 | 1.48749 | 70.24 | 0.5301 | S-FSL5.OHARA | 35.11 |
| 17 | −131.0972 | 0.100 | | | | | 34.94 |
| 18 | 27.5905 | 12.536 | 1.49700 | 81.54 | 0.5375 | S-FPL51.OHARA | 32.53 |
| 19 | −24.8904 | 0.850 | 1.84666 | 23.78 | 0.6205 | S-TIH53W.OHARA | 31.23 |
| 20 | 445.6019 | 0.049 | | | | | 30.00 |
| 21 | 52.4582 | 3.541 | 2.30909 | 17.89 | 0.6452 | N231.Glass | 29.53 |
| 22 | −407.3145 | DD[22] | | | | | 29.00 |
| *23 | 164.3659 | 0.676 | 1.85135 | 40.10 | 0.5695 | M-TAFD305.HOYA | 26.13 |
| *24 | 94.1189 | DD[24] | | | | | 25.55 |
| *25 | −154.4600 | 0.750 | 1.95150 | 29.83 | 0.5956 | M-TAFD405.HOYA | 25.53 |
| *26 | 61.6603 | 5.000 | | | | | 26.26 |
| 27 | 76.5938 | 2.798 | 1.75500 | 52.32 | 0.5476 | S-LAH97.OHARA | 32.18 |
| 28 | ∞ | 14.083 | | | | | 32.60 |

TABLE 66
Example 24

| | Infinite | |
|---|---|---|
| | Distance | Short Range −0.12x |
| Focal Length | 21.38 | 19.90 |
| Back Focus | 14.083 | 14.083 |
| Open F-Number | 1.52 | 1.51 |
| Maximum Full Angle of View [°] | 90.6 | 94.4 |
| DD[5] | 2.099 | 6.468 |
| DD[7] | 7.652 | 3.283 |
| DD[22] | 7.127 | 6.230 |
| DD[24] | 5.105 | 6.002 |

TABLE 67A
Example 24

| Sn | 1 | 14 | 15 |
|---|---|---|---|
| KA | 1.0000000E+00 | 1.0000000E+00 | 1.0000000E+00 |
| A4 | −3.6318253E−06 | −7.0010899E−08 | 7.0512112E−06 |
| A6 | 1.5972245E−09 | 6.8021453E−09 | 6.0943647E−09 |
| A8 | −9.0916477E−13 | −9.0115422E−12 | −6.6234967E−12 |
| A10 | 2.6247178E−16 | 1.7176008E−14 | −2.9152939E−15 |

| Sn | 2 | 23 | 24 | 25 |
|---|---|---|---|---|
| KA | −1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | 4.7106730E−05 | 4.7757518E−07 | 1.6453490E−05 | 2.9075903E−05 |
| A5 | −5.4364128E−08 | −1.1746858E−06 | −1.0313779E−07 | 1.4698644E−06 |
| A6 | −4.5231200E−08 | −1.5272707E−07 | −3.0333418E−07 | −7.2655894E−07 |
| A7 | 7.4689642E−10 | 3.5828669E−10 | 2.2195756E−10 | 1.8835137E−10 |
| A8 | 2.4731919E−12 | 1.8847226E−09 | 3.2417706E−09 | 3.7253915E−09 |
| A9 | −8.2694618E−14 | 2.3175859E−11 | 5.3501965E−12 | 4.3341154E−12 |
| A10 | 6.9486268E−14 | −7.4962645E−12 | −1.5463378E−11 | −1.0185460E−11 |
| A11 | 3.1927803E−15 | 1.1142006E−13 | 1.1250404E−13 | 5.2656576E−14 |
| A12 | 3.3405152E−16 | 5.0421536E−15 | 1.2922363E−14 | 5.6870704E−16 |
| A13 | 3.1871161E−18 | 1.8971866E−16 | 1.3716176E−15 | −2.3918757E−16 |
| A14 | −1.3619621E−18 | −3.9771183E−18 | 1.0768156E−16 | −3.3154450E−17 |
| A15 | −9.9593626E−20 | −3.5426556E−19 | 4.7901348E−18 | −1.7356910E−18 |
| A16 | −8.2539338E−22 | 2.0590432E−20 | −2.4433658E−21 | 1.9360881E−21 |
| A17 | 2.1461389E−22 | −5.6615333E−21 | −6.3435742E−20 | −2.5934524E−20 |
| A18 | 1.1518832E−23 | −1.7986158E−21 | −4.4666734E−21 | 9.5104522E−21 |
| A19 | −3.8908962E−26 | −3.0652134E−24 | −5.5448519E−22 | −1.4313565E−22 |
| A20 | −1.9150728E−26 | 1.0025582E−23 | 6.2727317E−23 | −1.8554496E−23 |

TABLE 67B
Example 24

| Sn | 26 |
|---|---|
| KA | 1.0000000E+00 |
| A3 | 0.0000000E+00 |
| A4 | 5.5747061E−05 |
| A5 | −9.0242042E−07 |
| A6 | −4.8965646E−07 |
| A7 | 4.1418735E−09 |
| A8 | 2.8025782E−09 |
| A9 | 2.5734010E−12 |
| A10 | −7.1969122E−12 |
| A11 | −9.1510625E−14 |
| A12 | −3.3181337E−15 |
| A13 | 8.6374456E−17 |
| A14 | 1.7818754E−17 |
| A15 | −2.2057237E−19 |
| A16 | 1.0449612E−19 |
| A17 | 5.9124913E−21 |
| A18 | −4.4603111E−22 |
| A19 | 1.7341740E−22 |
| A20 | −1.1436331E−23 |

### Example 25

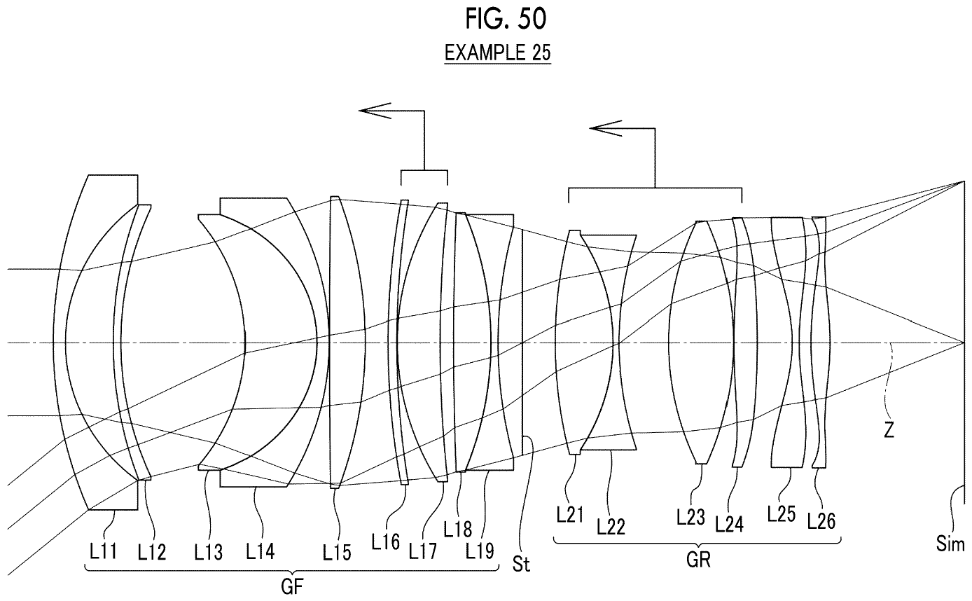

FIG. 50 shows a cross-sectional view of a configuration and luminous fluxes of a fixed-focal-length optical system of Example 25. The fixed-focal-length optical system consists of, in order from the object side to the image side, the front group GF having positive refractive power, the aperture stop St, and the rear group GR having positive refractive power. The front group GF consists of, in order from the object side to the image side, nine lenses including the lenses L11 to L19. The rear group GR consists of, in order from the object side to the image side, six lenses including the lenses L21 to L26. The fixed-focal-length optical system includes two focus lens groups. The focus lens group on the object side consists of the lenses L16 and L17, and the focus lens group on the image side consists of the lenses L21 to L24. During focusing from the infinite distance object to the short range object, the focus lens group on the object side and the focus lens group on the image side move to the object side by changing a mutual spacing.

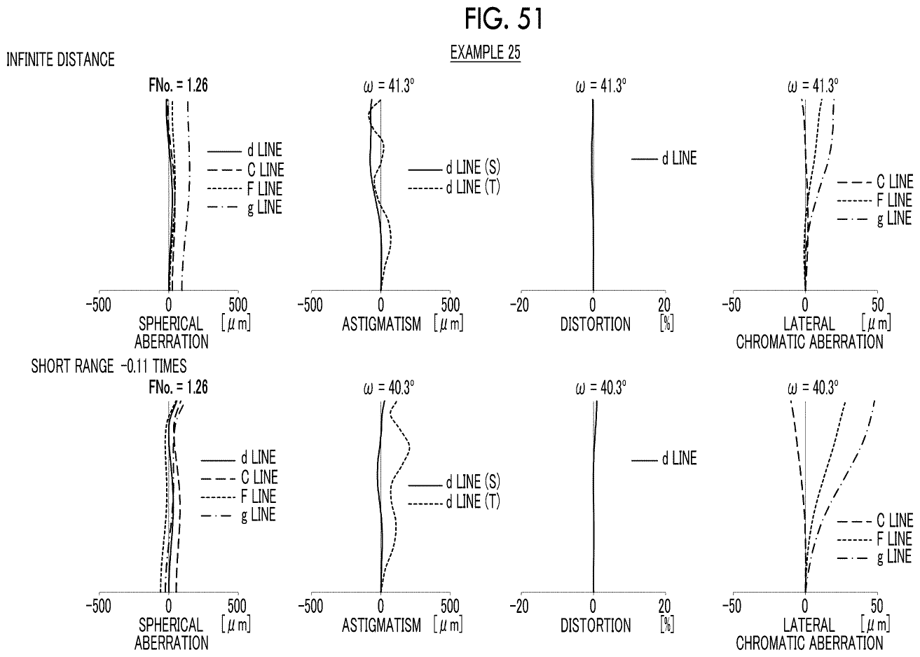

For the fixed-focal-length optical system of Example 25, Table 68 shows basic lens data, Table 69 shows specifications and variable surface spacings, Table 70 shows aspherical coefficients, and FIG. 51 shows each aberration diagram.

TABLE 68
Example 25

| Sn | R | D | Nd | νd | θgF | Material | ED |
|---|---|---|---|---|---|---|---|
| 1 | 59.7786 | 1.500 | 1.75500 | 52.32 | 0.5476 | S-LAH97.OHARA | 44.86 |
| 2 | 23.5933 | 5.931 | | | | | 37.00 |
| 3 | 55.0431 | 0.946 | 1.49700 | 81.54 | 0.5375 | S-FPL51.OHARA | 36.90 |
| 4 | 45.2656 | 15.378 | | | | | 35.93 |
| 5 | −26.4768 | 8.882 | 1.85026 | 32.27 | 0.5930 | S-LAH71.OHARA | 32.97 |
| 6 | −18.2438 | 1.500 | 1.89286 | 20.36 | 0.6394 | S-NPH4.OHARA | 34.24 |
| 7 | −38.0772 | 0.049 | | | | | 38.69 |
| 8 | 1600.1206 | 4.425 | 2.16217 | 21.24 | 0.6276 | N216.Glass | 38.80 |
| 9 | −59.5767 | DD[9] | | | | | 39.10 |
| 10 | 112.4570 | 1.084 | 1.48749 | 70.24 | 0.5301 | S-FSL5.OHARA | 38.13 |
| 11 | 126.4827 | 0.059 | | | | | 37.94 |
| 12 | 37.1317 | 5.302 | 1.59522 | 67.73 | 0.5443 | S-FPM2.OHARA | 37.34 |
| 13 | 182.2247 | DD[13] | | | | | 36.73 |
| 14 | 469.4689 | 4.627 | 1.88300 | 39.22 | 0.5729 | H-ZLAF68N.CDGM | 34.73 |
| 15 | −47.9643 | 0.888 | 1.69895 | 30.13 | 0.6030 | S-TIM35.OHARA | 34.25 |
| 16 | 63.3832 | 3.009 | | | | | 30.89 |
| 17 (St) | ∞ | DD[17] | | | | | 30.23 |
| 18 | 64.1540 | 7.175 | 1.43875 | 94.66 | 0.5340 | S-FPL55.OHARA | 29.16 |
| 19 | −27.4911 | 0.741 | 1.71736 | 29.52 | 0.6048 | S-TIH1.OHARA | 28.77 |
| 20 | 48.5061 | 6.145 | | | | | 28.65 |
| 21 | 39.4393 | 7.983 | 1.49700 | 81.54 | 0.5375 | S-FPL51.OHARA | 32.00 |
| 22 | −42.1733 | 0.050 | | | | | 32.50 |
| *23 | 101.0363 | 2.886 | 1.95150 | 29.83 | 0.5956 | MP-TAFD405.HOYA | 33.00 |
| *24 | −113.7738 | DD[24] | | | | | 33.40 |
| *25 | −21.7085 | 0.857 | 1.68948 | 31.02 | 0.5987 | L-TIM28.OHARA | 33.49 |
| *26 | 39.0206 | 1.470 | | | | | 33.39 |
| *27 | 48.2521 | 2.357 | 1.85135 | 40.10 | 0.5695 | MC-TAFD305.HOYA | 33.02 |
| *28 | −39.4415 | 16.664 | | | | | 33.61 |

TABLE 69
Example 25

| | Infinite | |
|---|---|---|
| | Distance | Short Range −0.11x |
| Focal Length | 24.70 | 24.52 |
| Back Focus | 16.664 | 16.664 |
| Open F-Number | 1.26 | 1.26 |
| Maximum Full Angle of View [°] | 82.6 | 80.6 |
| DD[9] | 2.835 | 0.886 |
| DD[13] | 1.677 | 3.626 |
| DD[17] | 4.082 | 2.749 |
| DD[24] | 4.337 | 5.670 |

TABLE 70
Example 25

| Sn | 23 | 24 | 25 | 26 | 27 | 28 |
|---|---|---|---|---|---|---|
| KA | 1.0000000E+00 | 1.0000000E+00 | 1.0000000E+00 | 1.0000000E+00 | 1.0000000E+00 | 1.0000000E+00 |
| A4 | −1.0923590E−05 | 4.0777487E−06 | 8.7570712E−05 | −6.3358918E−05 | −1.5265110E−05 | 7.4028000E−05 |
| A6 | 2.9956118E−09 | −3.8171780E−08 | −1.0882830E−07 | 1.1717386E−07 | −3.2512581E−08 | −4.8072317E−08 |
| A8 | −3.5753393E−10 | −1.7525009E−10 | 8.5095776E−12 | −2.6636257E−10 | −2.5706046E−10 | −4.5844052E−10 |
| A10 | 7.7327800E−13 | 5.3483700E−13 | 4.2998849E−13 | 3.7338836E−13 | 2.9085663E−13 | 7.2799637E−13 |

### Example 26

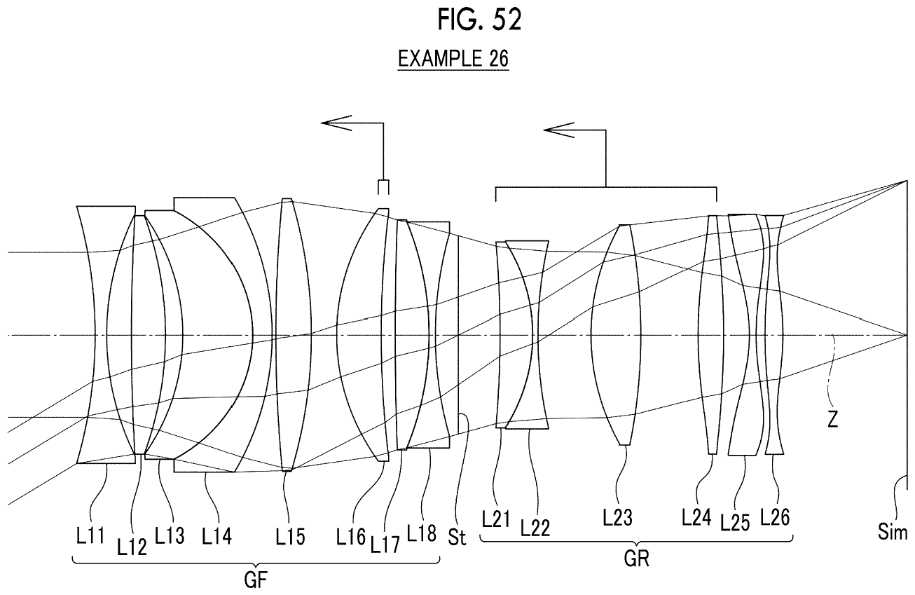

FIG. 52 shows a cross-sectional view of a configuration and luminous fluxes of a fixed-focal-length optical system of Example 26. The fixed-focal-length optical system consists of, in order from the object side to the image side, the front group GF having positive refractive power, the aperture stop St, and the rear group GR having positive refractive power. The front group GF consists of, in order from the object side to the image side, eight lenses including the lenses L11 to L18. The rear group GR consists of, in order from the object side to the image side, six lenses including the lenses L21 to L26. The fixed-focal-length optical system includes two focus lens groups. The focus lens group on the object side consists of the lens L16, and the focus lens group on the image side consists of the lenses L21 to L24. During focusing from the infinite distance object to the short range object, the focus lens group on the object side and the focus lens group on the image side move to the object side by changing a mutual spacing.

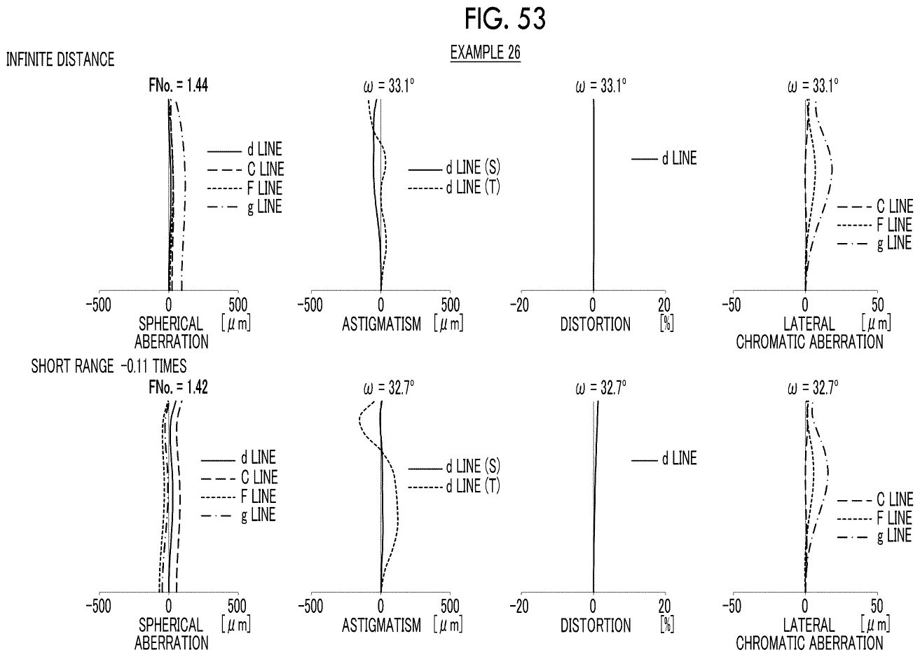

For the fixed-focal-length optical system of Example 26, Table 71 shows basic lens data, Table 72 shows specifications and variable surface spacings, Table 73 shows aspherical coefficients, and FIG. 53 shows each aberration diagram.

TABLE 71
Example 26

| Sn | R | D | Nd | νd | θgF | Material | ED |
|---|---|---|---|---|---|---|---|
| 1 | −68.6842 | 1.500 | 1.75500 | 52.32 | 0.5476 | S-LAH97.OHARA | 35.98 |
| 2 | 40.8182 | 3.207 | | | | | 33.36 |
| 3 | 308.8545 | 4.414 | 1.49700 | 81.54 | 0.5375 | S-FPL51.OHARA | 33.36 |
| 4 | −51.9595 | 2.247 | | | | | 33.35 |
| 5 | −30.6641 | 9.010 | 1.83400 | 37.21 | 0.5808 | S-LAH60V.OHARA | 33.32 |
| 6 | −19.9893 | 2.500 | 1.89286 | 20.36 | 0.6394 | S-NPH4.OHARA | 34.79 |
| 7 | −40.2636 | 0.486 | | | | | 38.39 |
| 8 | 216.4414 | 4.607 | 2.16217 | 21.24 | 0.6276 | N216.Glass | 38.00 |
| 9 | −71.5014 | DD[9] | | | | | 38.18 |
| 10 | 31.5587 | 5.782 | 1.43875 | 94.66 | 0.5340 | S-FPL55.OHARA | 35.34 |
| 11 | 152.0735 | DD[11] | | | | | 34.54 |
| 12 | 465.3403 | 4.388 | 1.88300 | 39.22 | 0.5729 | H-ZLAF68N.CDGM | 32.18 |
| 13 | −44.7404 | 0.825 | 1.69895 | 30.13 | 0.6030 | S-TIM35.OHARA | 31.65 |
| 14 | 56.0738 | 2.973 | | | | | 28.44 |
| 15 (St) | ∞ | DD[15] | | | | | 27.74 |
| 16 | −153.8648 | 4.231 | 1.53775 | 74.70 | 0.5394 | S-FPM3.OHARA | 26.00 |
| 17 | −25.6423 | 0.681 | 1.69895 | 30.13 | 0.6030 | S-TIM35.OHARA | 25.94 |
| 18 | 62.2880 | 6.886 | | | | | 26.31 |
| 19 | 33.2685 | 6.455 | 1.49700 | 81.54 | 0.5375 | S-FPL51.OHARA | 30.40 |
| 20 | −83.8369 | 7.365 | | | | | 30.79 |
| *21 | 69.4372 | 3.307 | 2.00266 | 31.67 | 0.5851 | N200.Glass | 33.31 |
| *22 | −112.1335 | DD[22] | | | | | 33.35 |
| *23 | −24.5882 | 0.868 | 1.68948 | 31.02 | 0.5987 | L-TIM28.OHARA | 33.32 |
| *24 | 35.5218 | 1.162 | | | | | 33.74 |
| *25 | 75.4761 | 2.319 | 1.85135 | 40.10 | 0.5695 | MC-TAFD305.HOYA | 33.32 |
| *26 | −37.5132 | 16.116 | | | | | 33.43 |

TABLE 72
Example 26

| | Infinite | Short |
|---|---|---|
| | Distance | Range −0.11x |
| Focal Length | 33.17 | 32.17 |
| Back Focus | 16.116 | 16.116 |
| Open F-Number | 1.44 | 1.42 |
| Maximum Full Angle of View [°] | 66.2 | 65.4 |
| DD[9] | 3.279 | 1.107 |
| DD[11] | 1.815 | 3.987 |
| DD[15] | 5.415 | 3.691 |
| DD[22] | 3.336 | 5.060 |

TABLE 73
Example 26

| Sn | 21 | 22 | 23 | 24 | 25 | 26 |
|---|---|---|---|---|---|---|
| KA | 1.0000000E+00 | 1.0000000E+00 | 1.0000000E+00 | 1.0000000E+00 | 1.0000000E+00 | 1.0000000E+00 |
| A4 | −6.2105404E−06 | 1.0065522E−05 | 5.5177737E−05 | −5.2241177E−05 | 7.6728477E−06 | 6.5336960E−05 |
| A6 | 4.3816990E−08 | −8.3034440E−09 | 4.1359961E−08 | −9.0191543E−09 | −2.1457645E−07 | 6.1500922E−09 |
| A8 | −4.0352456E−10 | −1.9280716E−10 | −3.4268752E−10 | −8.3582365E−11 | 3.6375975E−10 | −3.1046518E−10 |
| A10 | 7.7327800E−13 | 5.3483700E−13 | 4.0364765E−13 | 3.7129724E−13 | −1.1906315E−15 | 4.0618043E−13 |

### Example 27

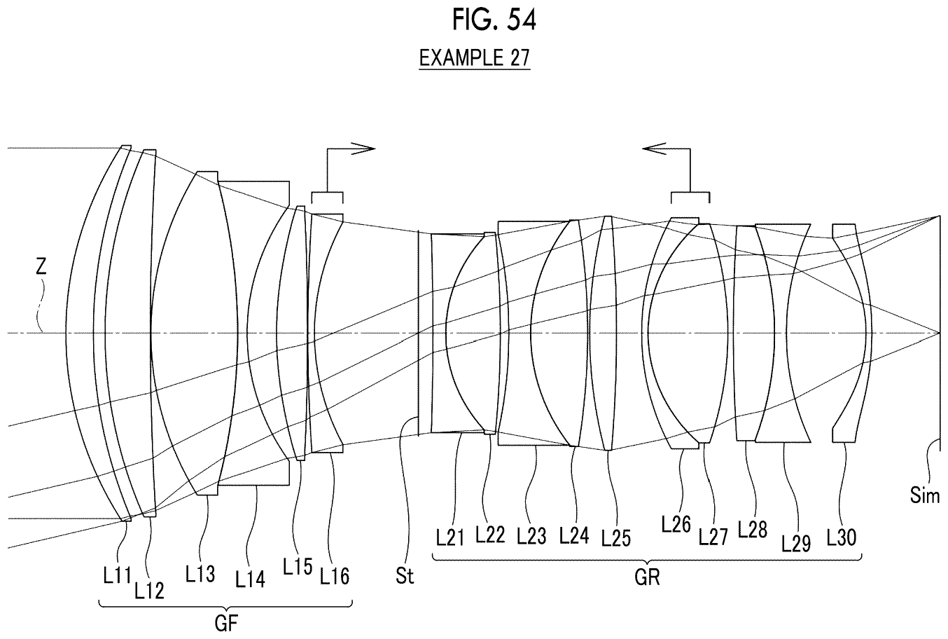

FIG. 54 shows a cross-sectional view of a configuration and luminous fluxes of a fixed-focal-length optical system of Example 27. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, 10 lenses including the lenses L21 to L30. The fixed-focal-length optical system includes two focus lens groups. The focus lens group on the object side consists of the lens L16, and the focus lens group on the image side consists of the lenses L26 and L27. During focusing from the infinite distance object to the short range object, the focus lens group on the object side moves to the image side, and the focus lens group on the image side moves to the object side.

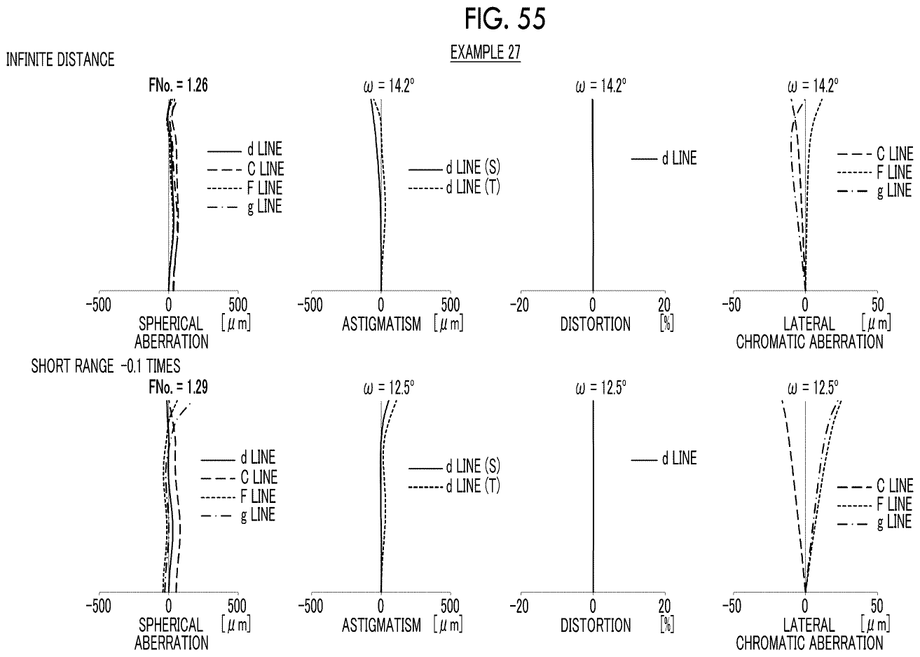

For the fixed-focal-length optical system of Example 27, Table 74 shows basic lens data, Table 75 shows specifications and variable surface spacings, Table 76 shows aspherical coefficients, and FIG. 55 shows each aberration diagram.

TABLE 74
Example 27

| Sn | R | D | Nd | νd | θgF | Material | ED |
|---|---|---|---|---|---|---|---|
| 1 | 67.0630 | 4.663 | 2.00266 | 31.67 | 0.5851 | N200.Glass | 69.00 |
| 2 | 93.4019 | 2.000 | | | | | 68.13 |
| 3 | 89.3026 | 7.698 | 1.81600 | 46.62 | 0.5568 | S-LAH59.OHARA | 67.38 |
| 4 | 596.9838 | 0.100 | | | | | 66.26 |
| 5 | 59.9237 | 14.743 | 1.59522 | 67.73 | 0.5443 | S-FPM2.OHARA | 59.40 |
| 6 | −117.3228 | 1.518 | 1.88300 | 39.22 | 0.5729 | H-ZLAF68N.CDGM | 55.78 |
| 7 | 42.1072 | 5.000 | | | | | 46.98 |
| *8 | 72.6678 | 5.227 | 1.76450 | 49.10 | 0.5529 | L-LAH91.OHARA | 46.65 |
| *9 | −914.7713 | DD[9] | | | | | 46.09 |
| 10 | 354.8468 | 1.120 | 1.59522 | 67.73 | 0.5443 | S-FPM2.OHARA | 43.77 |
| 11 | 45.4292 | DD[11] | | | | | 40.86 |
| 12 (St) | ∞ | 2.491 | | | | | 37.09 |
| 13 | −574.5527 | 2.173 | 2.00266 | 31.67 | 0.5851 | N200.Glass | 36.44 |
| 14 | 27.2729 | 9.275 | 1.59522 | 67.73 | 0.5443 | S-FPM2.OHARA | 35.42 |
| 15 | −199.9741 | 1.454 | | | | | 36.02 |
| 16 | −90.9926 | 3.713 | 1.74077 | 27.79 | 0.6096 | S-TIH13.OHARA | 36.20 |
| 17 | 35.0812 | 9.672 | 1.81600 | 46.62 | 0.5568 | S-LAH59.OHARA | 41.07 |
| 18 | −138.8644 | 0.355 | | | | | 41.52 |
| 19 | 91.3942 | 4.559 | 2.16217 | 21.24 | 0.6276 | N216.Glass | 42.94 |
| 20 | −273.2878 | DD[20] | | | | | 42.80 |
| 21 | 47.0360 | 1.086 | 1.84666 | 23.78 | 0.6205 | S-TIH53W.OHARA | 42.36 |
| 22 | 27.7355 | 13.467 | 1.48749 | 70.24 | 0.5301 | S-FSL5.OHARA | 40.20 |
| 23 | −66.4945 | DD[23] | | | | | 40.00 |
| 24 | 334.3642 | 7.000 | 2.30909 | 17.89 | 0.6452 | N231.Glass | 39.38 |
| 25 | −59.5735 | 2.010 | 1.75520 | 27.51 | 0.6103 | S-TIH4.OHARA | 38.98 |
| 26 | 50.3829 | 13.541 | | | | | 35.54 |
| *27 | −27.5995 | 1.000 | 1.76450 | 49.10 | 0.5529 | L-LAH91.OHARA | 34.86 |
| *28 | −56.2282 | 11.607 | | | | | 36.51 |

TABLE 75
Example 27

| | Infinite | Short |
|---|---|---|
| | Distance | Range −0.1x |
| Focal Length | 85.42 | 81.40 |
| Back Focus | 11.607 | 11.607 |
| Open F-Number | 1.26 | 1.29 |
| Maximum Full Angle of View [°] | 28.4 | 25.0 |
| DD[9] | 0.100 | 7.244 |
| DD[11] | 17.655 | 10.511 |
| DD[20] | 4.281 | 1.498 |
| DD[23] | 0.938 | 3.721 |

TABLE 76
Example 27

| Sn | 8 | 9 | 27 | 28 |
|---|---|---|---|---|
| KA | 1.0000000E+00 | 1.0000000E+00 | 1.0000000E+00 | 1.0000000E+00 |
| A4 | −1.5937042E−06 | −7.4819898E−07 | −3.6249465E−06 | −3.5043597E−06 |
| A6 | 2.9887578E−10 | −6.9631930E−10 | 2.4717291E−08 | 1.9044034E−08 |
| A8 | −5.1061005E−12 | −1.2834674E−12 | 2.3694713E−11 | 1.8373286E−11 |
| A10 | 1.0640082E−14 | 6.6632509E−15 | −1.5025179E−14 | −3.0167139E−14 |

### Example 28

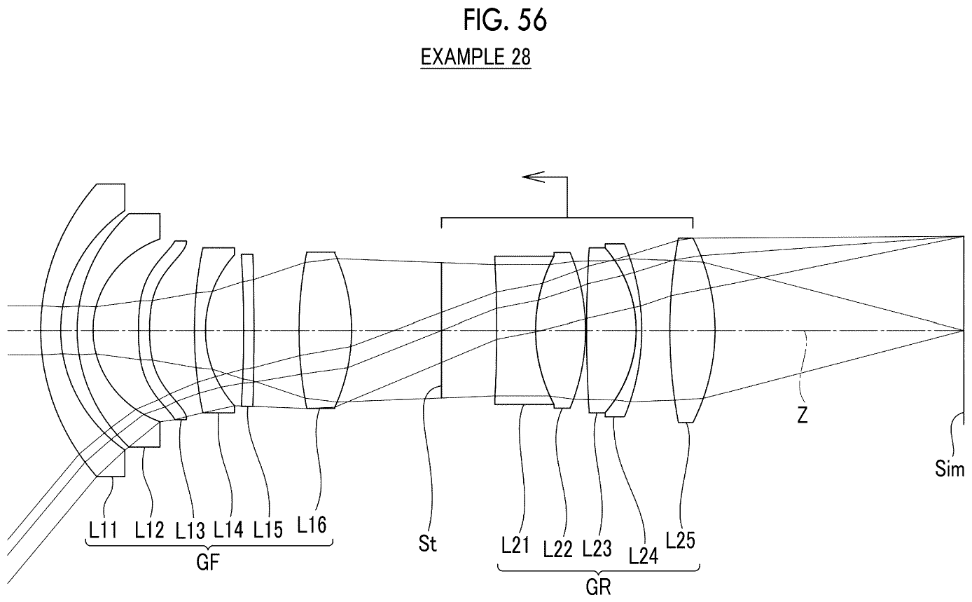

FIG. 56 shows a cross-sectional view of a configuration and luminous fluxes of a fixed-focal-length optical system of Example 28. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, five lenses including the lenses L21 to L25. The fixed-focal-length optical system includes only one focus lens group. The focus lens group consists of the aperture stop St and the rear group GR and moves to the object side during focusing from the infinite distance object to the short range object.

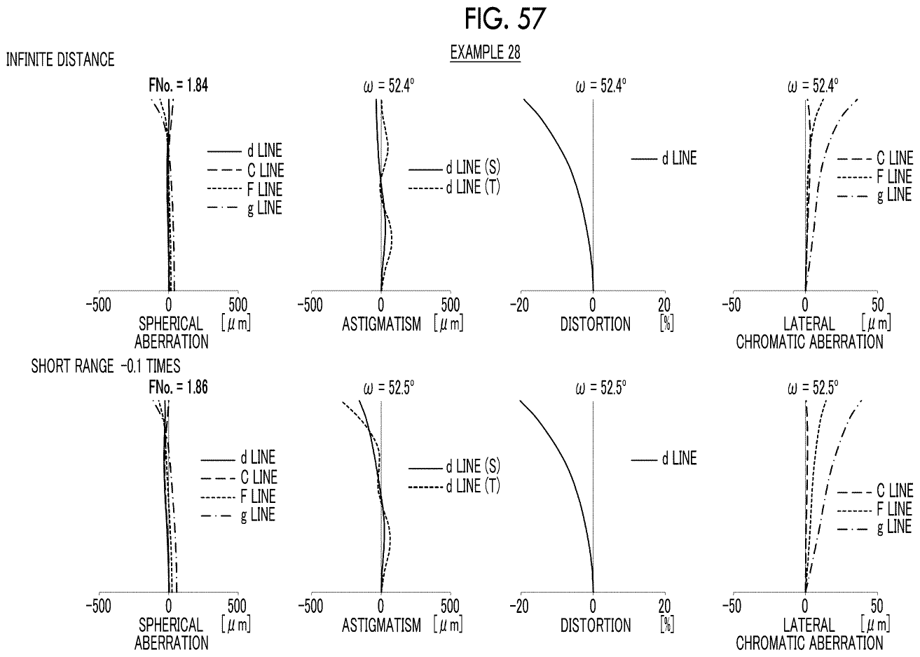

For the fixed-focal-length optical system of Example 28, Table 77 shows basic lens data, Table 78 shows specifications and variable surface spacings, Table 79 shows aspherical coefficients, and FIG. 57 shows each aberration diagram.

TABLE 77
Example 28

| Sn | R | D | Nd | νd | 0gF | Material | ED |
|---|---|---|---|---|---|---|---|
| 1 | 22.7271 | 1.810 | 2.00266 | 31.67 | 0.5851 | N200.Glass | 28.62 |
| 2 | 14.7060 | 1.489 | | | | | 23.41 |
| 3 | 16.2169 | 1.438 | 1.90525 | 35.04 | 0.5849 | S-LAH93.OHARA | 22.82 |
| 4 | 9.6150 | 4.121 | | | | | 17.87 |
| *5 | 33.4355 | 1.000 | 1.69304 | 52.93 | 0.5467 | L-LAL15.OHARA | 17.45 |
| *6 | 21.0025 | 4.057 | | | | | 16.87 |
| 7 | 42.9103 | 1.000 | 1.48749 | 70.24 | 0.5301 | S-FSL5.OHARA | 16.10 |
| 8 | 11.6373 | 3.464 | | | | | 14.75 |
| 9 | −128.3228 | 0.882 | 1.59551 | 39.24 | 0.5804 | S-TIM8.OHARA | 14.78 |
| 10 | −254.7155 | 4.074 | | | | | 14.85 |
| 11 | 41.6551 | 4.759 | 1.68893 | 31.07 | 0.6004 | S-TIM28.OHARA | 15.26 |
| 12 | −19.3407 | DD[12] | | | | | 15.00 |
| 13 (St) | ∞ | 5.000 | | | | | 13.21 |
| 14 | −136.7311 | 3.514 | 2.00266 | 31.67 | 0.5851 | N200.Glass | 13.85 |
| 15 | 16.5848 | 4.524 | 1.52841 | 76.45 | 0.5395 | S-FPM4.OHARA | 14.48 |
| 16 | −21.3943 | 0.100 | | | | | 15.20 |
| 17 | 137.7113 | 4.491 | 1.52841 | 76.45 | 0.5395 | S-FPM4.OHARA | 15.82 |
| 18 | −12.9355 | 0.500 | 1.90366 | 31.34 | 0.5964 | S-LAH95.OHARA | 16.10 |
| 19 | −23.6128 | 2.550 | | | | | 16.88 |
| 20 | 53.3059 | 4.087 | 1.48749 | 70.24 | 0.5301 | S-FSL5.OHARA | 17.95 |
| 21 | −21.2870 | DD[21] | | | | | 18.00 |

TABLE 78
Example 28

| | Infinite | Short |
|---|---|---|
| | Distance | Range −0.1x |
| Focal Length | 8.77 | 8.72 |
| Back Focus | 22.485 | 23.376 |
| Open F-Number | 1.84 | 1.86 |
| Maximum Full Angle of View [°] | 104.8 | 105.0 |
| DD[12] | 8.142 | 7.251 |
| DD[21] | 22.485 | 23.376 |

TABLE 79
Example 28

| Sn | 5 | 6 |
|---|---|---|
| KA | 1.0000000E+00 | 1.0000000E+00 |
| A4 | 8.1421882E−04 | 9.0383343E−04 |
| A6 | −9.3195827E−06 | −1.2897197E−05 |
| A8 | 1.2506127E−07 | 2.6757547E−07 |
| A10 | −1.1677939E−09 | −4.4399772E−09 |
| A12 | 1.6009358E−12 | 2.2181306E−11 |

### Example 29

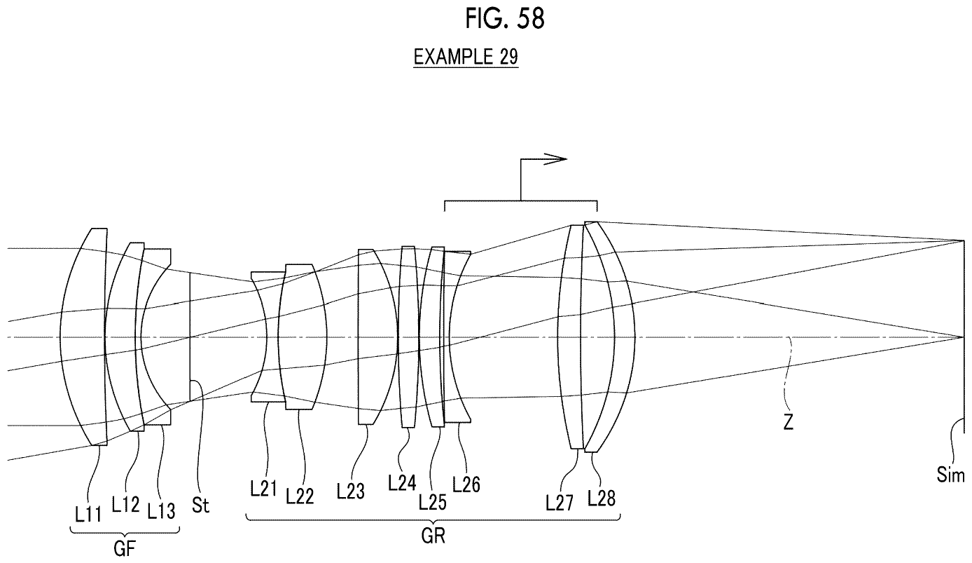

FIG. 58 shows a cross-sectional view of a configuration and luminous fluxes of a fixed-focal-length optical system of Example 29. The fixed-focal-length optical system consists of, in order from the object side to the image side, the front group GF having positive refractive power, the aperture stop St, and the rear group GR having positive refractive power. The front group GF consists of, in order from the object side to the image side, three lenses including the lenses L11 to L13. The rear group GR consists of, in order from the object side to the image side, eight lenses including the lenses L21 to L28. The fixed-focal-length optical system includes only one focus lens group. The focus lens group consists of the lenses L26 to L28 and moves to the image side during focusing from the infinite distance object to the short range object.

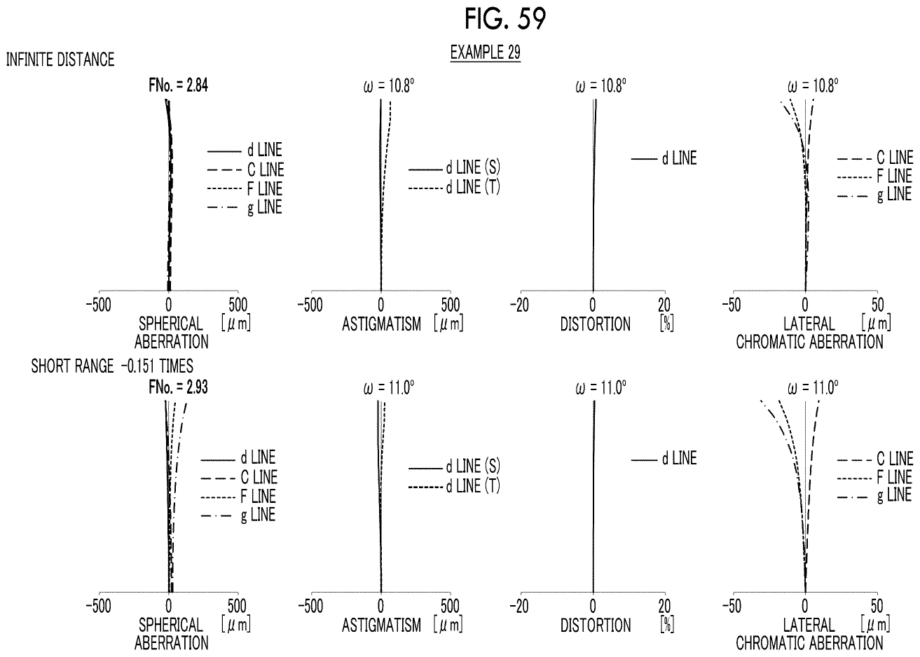

For the fixed-focal-length optical system of Example 29, Table 80 shows basic lens data, Table 81 shows specifications and variable surface spacings, and FIG. 59 shows each aberration diagram.

TABLE 80
Example 29

| Sn | R | D | Nd | νd | θgF | Material | ED |
|---|---|---|---|---|---|---|---|
| 1 | 20.6475 | 3.912 | 1.48749 | 70.24 | 0.5301 | S-FSL5.OHARA | 20.72 |
| 2 | 217.0921 | 0.050 | | | | | 19.88 |
| 3 | 19.2517 | 2.667 | 2.16217 | 21.24 | 0.6276 | N216.Glass | 18.00 |
| 4 | 45.4876 | 0.513 | 1.63980 | 34.47 | 0.5923 | S-TIM27.OHARA | 16.78 |
| 5 | 10.4765 | 4.352 | | | | | 13.88 |
| 6 (St) | ∞ | 6.721 | | | | | 12.26 |
| 7 | −12.0294 | 1.000 | 1.84666 | 23.78 | 0.6205 | S-TIH53W.OHARA | 11.20 |
| 8 | 29.4542 | 4.302 | 1.49700 | 81.54 | 0.5375 | S-FPL51.OHARA | 12.40 |
| 9 | −18.9367 | 2.777 | | | | | 13.83 |
| 10 | 1967.2113 | 3.490 | 1.60300 | 65.44 | 0.5402 | S-PHM53.OHARA | 16.00 |
| 11 | −17.0965 | 0.050 | | | | | 16.69 |
| 12 | 108.5435 | 1.814 | 1.83481 | 42.74 | 0.5649 | S-LAH55VS.OHARA | 17.23 |
| 13 | −98.6684 | 0.050 | | | | | 17.28 |
| 14 | 33.5647 | 1.803 | 2.00266 | 31.67 | 0.5851 | N200.Glass | 17.17 |
| 15 | 87.2659 | DD[15] | | | | | 16.84 |
| 16 | 359.9140 | 0.500 | 2.00266 | 31.67 | 0.5851 | N200.Glass | 16.33 |
| 17 | 17.3348 | 9.584 | | | | | 15.78 |
| 18 | 48.4462 | 2.022 | 2.16217 | 21.24 | 0.6276 | N216.Glass | 21.32 |
| 19 | 222.2549 | 3.004 | | | | | 21.35 |
| 20 | −23.0827 | 1.807 | 2.00266 | 31.67 | 0.5851 | N200.Glass | 21.37 |
| 21 | −19.7335 | DD[21] | | | | | 22.00 |

TABLE 81
Example 29

| | Infinite | Short |
|---|---|---|
| | Distance | Range −0.151x |
| Focal Length | 48.00 | 45.74 |
| Back Focus | 29.063 | 26.613 |
| Open F-Number | 2.84 | 2.93 |
| Maximum Full Angle of View [°] | 21.6 | 22.0 |
| DD[15] | 0.342 | 2.792 |
| DD[21] | 29.063 | 26.613 |

### Example 30

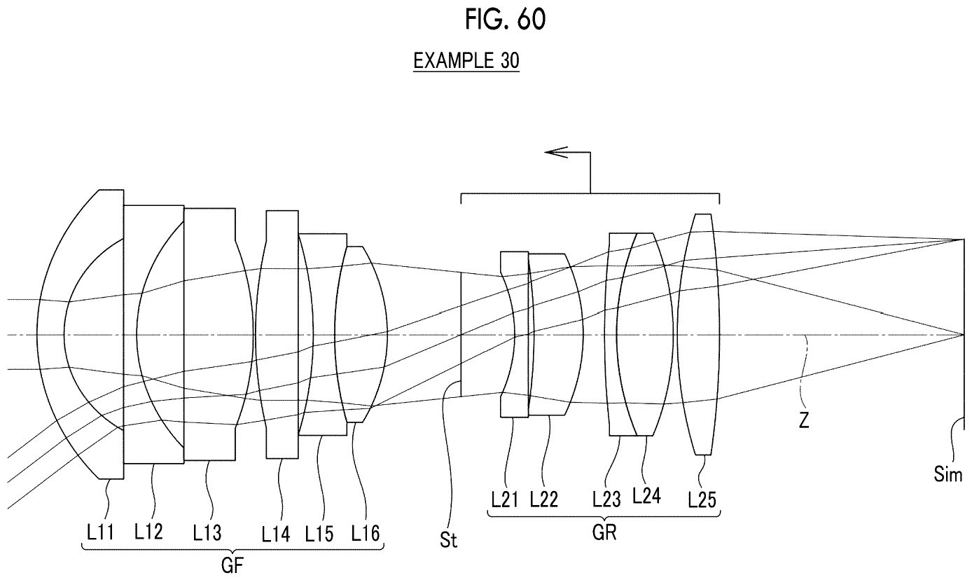

FIG. 60 shows a cross-sectional view of a configuration and luminous fluxes of a fixed-focal-length optical system of Example 30. The fixed-focal-length optical system consists of, in order from the object side to the image side, the front group GF having positive refractive power, the aperture stop St, and the rear group GR having positive refractive power. The front group GF consists of, in order from the object side to the image side, six lenses including the lenses L11 to L16. The rear group GR consists of, in order from the object side to the image side, five lenses including the lenses L21 to L25. The fixed-focal-length optical system includes only one focus lens group. The focus lens group consists of the aperture stop St and the rear group GR and moves to the object side during focusing from the infinite distance object to the short range object.

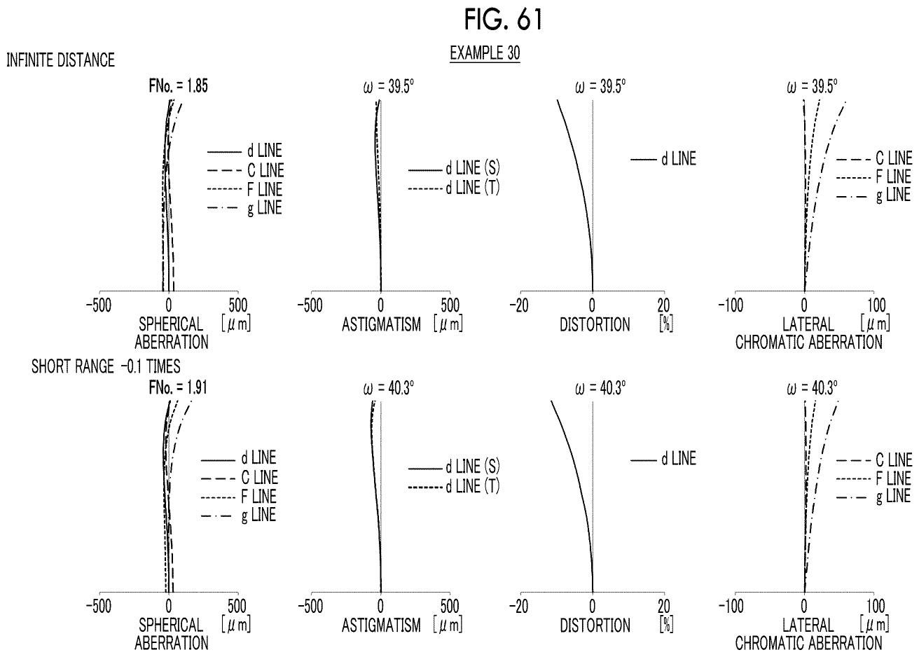

For the fixed-focal-length optical system of Example 30, Table 82 shows basic lens data, Table 83 shows specifications and variable surface spacings, and FIG. 61 shows each aberration diagram.

TABLE 82
Example 30

| Sn | R | D | Nd | νd | θgF | Material | ED |
|---|---|---|---|---|---|---|---|
| 1 | 20.4145 | 2.420 | 2.00266 | 31.67 | 0.5851 | N200.Glass | 23.36 |
| 2 | 10.7644 | 5.340 | | | | | 17.95 |
| 3 | ∞ | 1.170 | 1.62280 | 56.91 | 0.5470 | E-BACD10.HOYA | 17.66 |
| 4 | 16.3954 | 4.230 | | | | | 16.55 |
| 5 | ∞ | 6.220 | 1.72825 | 28.32 | 0.6082 | H-ZF4A.CDGM | 16.93 |
| 6 | −26.1903 | 0.200 | | | | | 17.44 |
| 7 | 42.5844 | 3.820 | 1.92286 | 18.90 | 0.6499 | H-ZF72A.CDGM | 16.59 |
| 8 | ∞ | 1.350 | | | | | 15.48 |
| 9 | −35.8371 | 1.910 | 1.90366 | 31.42 | 0.5943 | H-ZLAF75B.CDGM | 15.08 |
| 10 | 33.3500 | 4.730 | 1.71300 | 53.83 | 0.5452 | H-LAK7A.CDGM | 14.56 |
| 11 | −17.3677 | DD[11] | | | | | 14.28 |
| 12 (St) | ∞ | 4.750 | | | | | 12.00 |
| 13 | −14.9371 | 1.230 | 1.84666 | 23.78 | 0.6208 | H-ZF52.CDGM | 11.19 |
| 14 | ∞ | 0.500 | | | | | 11.77 |
| 15 | −52.5864 | 4.410 | 1.83481 | 42.72 | 0.5643 | H-ZLAF55D.CDGM | 11.85 |
| 16 | −19.1277 | 1.910 | | | | | 13.18 |
| 17 | 87.4410 | 1.080 | 1.84666 | 23.78 | 0.6208 | H-ZF52.CDGM | 16.03 |
| 18 | 27.1670 | 5.080 | 1.49700 | 81.61 | 0.5380 | H-FK61.CDGM | 16.74 |
| 19 | −27.1670 | 0.360 | | | | | 18.09 |
| 20 | 42.6708 | 3.780 | 1.85150 | 40.73 | 0.5691 | H-ZLAF85L.CDGM | 19.86 |
| 21 | −88.7356 | DD[21] | | | | | 20.00 |

TABLE 83
Example 30

| | Infinite | Short |
|---|---|---|
| | Distance | Range −0.1x |
| Focal Length | 12.36 | 12.08 |
| Back Focus | 21.928 | 23.362 |
| Open F-Number | 1.85 | 1.91 |
| Maximum Full Angle of View [°] | 79.0 | 80.6 |
| DD[11] | 6.600 | 5.166 |
| DD[21] | 21.928 | 23.362 |

### Example 31

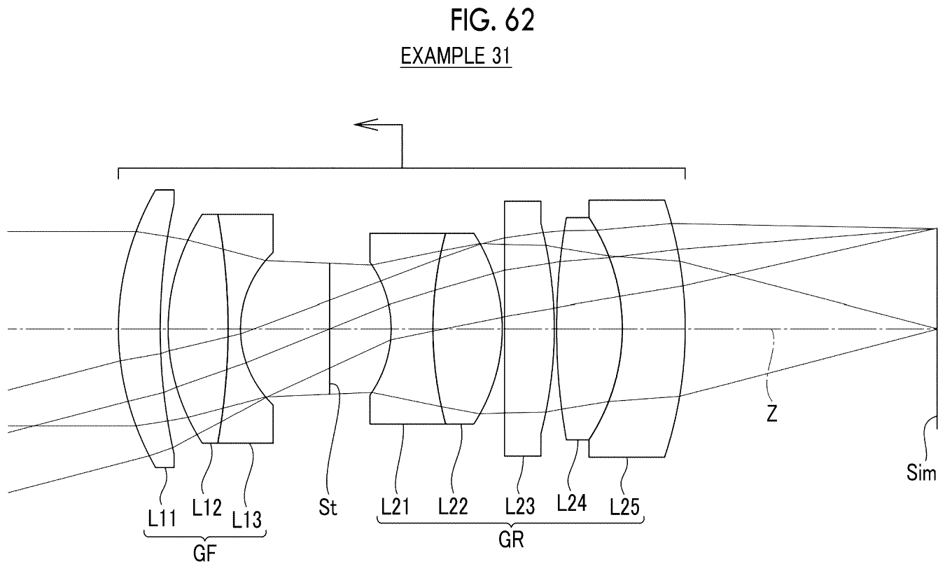

FIG. 62 shows a cross-sectional view of a configuration and luminous fluxes of a fixed-focal-length optical system of Example 31. The fixed-focal-length optical system consists of, in order from the object side to the image side, the front group GF having positive refractive power, the aperture stop St, and the rear group GR having positive refractive power. The front group GF consists of, in order from the object side to the image side, three lenses including the lenses L11 to L13. The rear group GR consists of, in order from the object side to the image side, five lenses including the lenses L21 to L25. The focus lens group consists of the whole fixed-focal-length optical system and moves to the object side during focusing from the infinite distance object to the short range object.

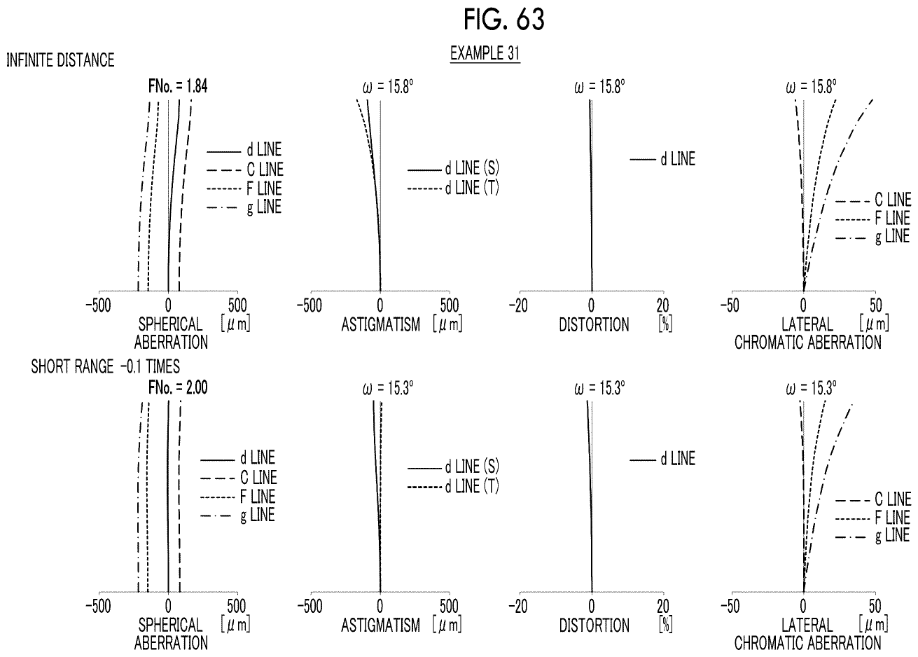

For the fixed-focal-length optical system of Example 31, Table 84 shows basic lens data, Table 85 shows specifications and variable surface spacings, and FIG. 63 shows each aberration diagram.

TABLE 84
Example 31

| Sn | R | D | Nd | νd | θgF | Material | ED |
|---|---|---|---|---|---|---|---|
| 1 | 27.3032 | 3.554 | 2.00266 | 31.67 | 0.5851 | N200.Glass | 23.34 |
| 2 | 56.9340 | 0.671 | | | | | 21.84 |
| 3 | 20.4603 | 5.091 | 1.61800 | 63.39 | 0.5432 | H-ZPK1A.CDGM | 19.48 |
| 4 | −63.2400 | 1.010 | 1.57501 | 41.50 | 0.5775 | H-QF3.CDGM | 17.78 |
| 5 | 10.2145 | 7.569 | | | | | 13.91 |
| 6 (St) | ∞ | 5.242 | | | | | 12.00 |
| 7 | −11.1712 | 3.554 | 1.72341 | 37.99 | 0.5838 | H-ZBAF21.CDGM | 11.67 |
| 8 | 35.9870 | 5.882 | 1.80400 | 46.53 | 0.5578 | S-LAH65VS.OHARA | 14.30 |
| 9 | −17.0743 | 0.200 | | | | | 15.62 |
| 10 | ∞ | 4.225 | 1.83481 | 42.72 | 0.5643 | H-ZLAF55D.CDGM | 16.68 |
| 11 | −41.6097 | 0.200 | | | | | 17.67 |
| 12 | 62.7334 | 5.595 | 1.49700 | 81.61 | 0.5380 | H-FK61.CDGM | 18.02 |
| 13 | −19.7350 | 5.344 | 1.80000 | 29.84 | 0.6018 | S-NBH55.OHARA | 18.11 |
| 14 | −40.5181 | DD[14] | | | | | 19.37 |

TABLE 85
Example 31

| | Infinite | Short |
|---|---|---|
| | Distance | Range −0.1x |
| Focal Length | 32.74 | 32.74 |
| Back Focus | 21.355 | 24.629 |
| Open F-Number | 1.84 | 2.00 |
| Maximum Full Angle of View [°] | 31.6 | 30.6 |
| DD[14] | 21.355 | 24.629 |

### Example 32

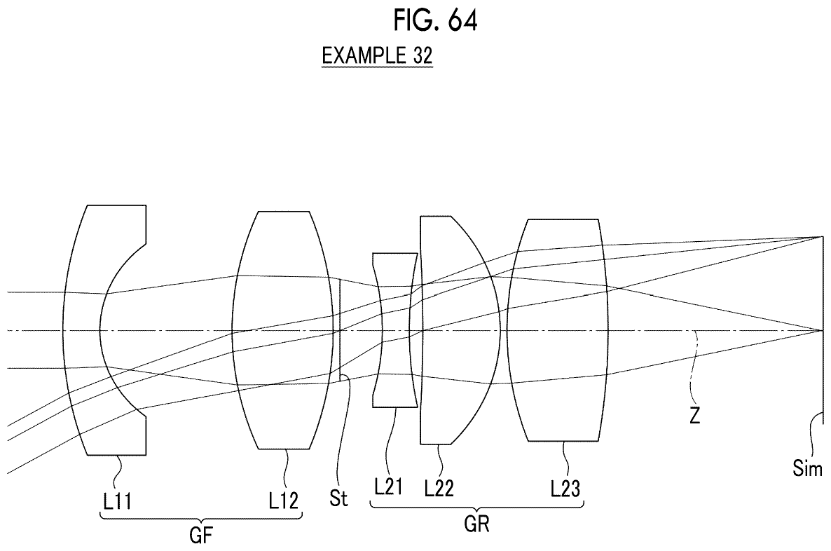

FIG. 64 shows a cross-sectional view of a configuration and luminous fluxes of a fixed-focal-length optical system of Example 32. The fixed-focal-length optical system consists of, in order from the object side to the image side, the front group GF having positive refractive power, the aperture stop St, and the rear group GR having positive refractive power. The front group GF consists of, in order from the object side to the image side, two lenses including the lenses L11 and L12. The rear group GR consists of, in order from the object side to the image side, three lenses including the lenses L21 to L23.

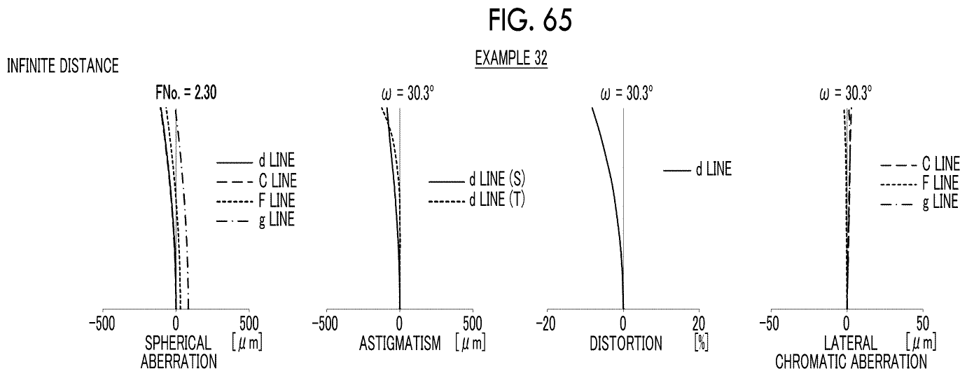

For the fixed-focal-length optical system of Example 32, Table 86 shows basic lens data, Table 87 shows specifications, and FIG. 65 shows each aberration diagram.

TABLE 86
Example 32

| Sn | R | D | Nd | νd | θgF | Material | ED |
|---|---|---|---|---|---|---|---|
| 1 | 11.3603 | 1.100 | 1.58913 | 61.13 | 0.5407 | S-BAL35.OHARA | 6.66 |
| 2 | 3.4661 | 3.906 | | | | | 5.05 |
| 3 | 9.6532 | 3.000 | 2.00266 | 31.67 | 0.5851 | N200.Glass | 4.28 |
| 4 | −10.5126 | 0.200 | | | | | 3.59 |
| 5 (St) | ∞ | 1.260 | | | | | 3.25 |
| 6 | −7.7326 | 0.800 | 2.30909 | 17.89 | 0.6452 | N231.Glass | 3.14 |
| 7 | 12.4525 | 0.400 | | | | | 3.34 |
| 8 | −50.0029 | 2.300 | 1.75500 | 52.32 | 0.5476 | S-LAH97.OHARA | 3.56 |
| 9 | −5.2682 | 0.200 | | | | | 4.52 |
| 10 | 10.3414 | 3.000 | 1.75500 | 52.32 | 0.5476 | S-LAH97.OHARA | 5.04 |
| 11 | −21.6052 | 6.419 | | | | | 5.44 |

TABLE 87
Example 32

| | Infinite Distance |
|---|---|
| Focal Length | 5.59 |
| Back Focus | 6.419 |
| Open F-Number | 2.30 |
| Maximum Full Angle of View [°] | 60.6 |

### Example 33

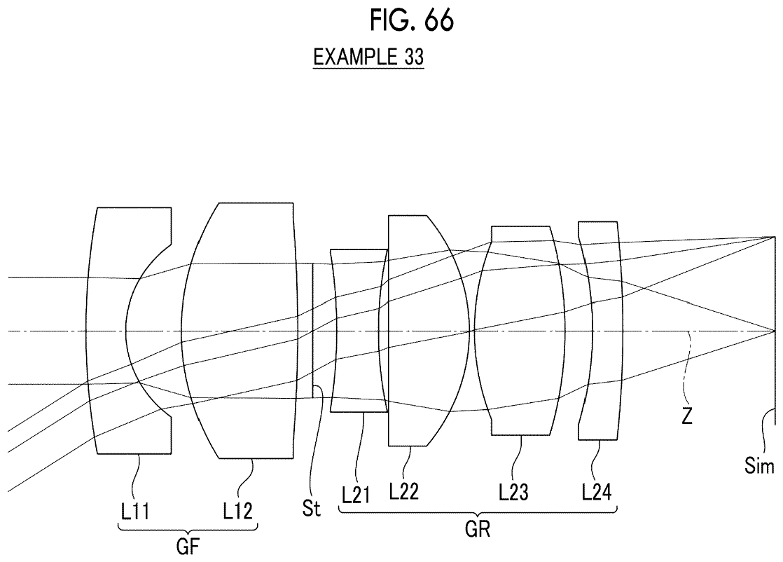

FIG. 66 shows a cross-sectional view of a configuration and luminous fluxes of a fixed-focal-length optical system of Example 33. The fixed-focal-length optical system consists of, in order from the object side to the image side, the front group GF having positive refractive power, the aperture stop St, and the rear group GR having positive refractive power. The front group GF consists of, in order from the object side to the image side, two lenses including the lenses L11 and L12. The rear group GR consists of, in order from the object side to the image side, four lenses including the lenses L21 to L24.

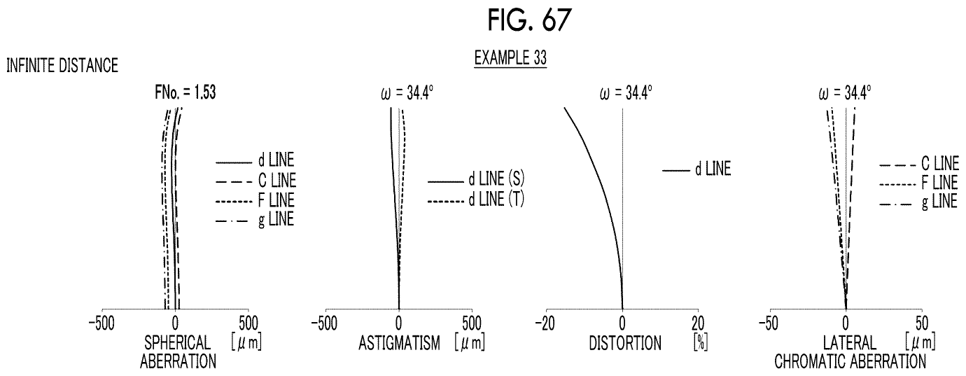

For the fixed-focal-length optical system of Example 33, Table 88 shows basic lens data, Table 89 shows specifications, and FIG. 67 shows each aberration diagram.

TABLE 88
Example 33

| Sn | R | D | Nd | νd | θgF | Material | ED |
|---|---|---|---|---|---|---|---|
| 1 | 23.1858 | 1.180 | 1.58913 | 61.13 | 0.5407 | S-BAL35.OHARA | 6.81 |
| 2 | 3.5051 | 1.650 | | | | | 5.01 |
| 3 | 8.1799 | 3.441 | 2.00266 | 31.67 | 0.5851 | N200.Glass | 5.06 |
| 4 | −48.6430 | 0.445 | | | | | 4.51 |
| 5 (St) | ∞ | 0.715 | | | | | 4.30 |
| 6 | −16.9069 | 1.240 | 2.16217 | 21.24 | 0.6276 | N216.Glass | 4.35 |
| 7 | 12.9960 | 0.300 | | | | | 4.65 |
| 8 | ∞ | 2.400 | 1.83481 | 42.74 | 0.5649 | S-LAH55VS.OHARA | 4.73 |
| 9 | −6.0219 | 0.150 | | | | | 5.55 |
| 10 | 8.2429 | 2.690 | 1.80400 | 46.58 | 0.5573 | S-LAH65V.OHARA | 5.70 |
| 11 | −12.4974 | 0.800 | | | | | 5.78 |
| 12 | −11.4851 | 0.900 | 2.16217 | 21.24 | 0.6276 | N216.Glass | 5.52 |
| 13 | −35.4956 | 4.513 | | | | | 5.66 |

TABLE 89
Example 33

| | Infinite Distance |
|---|---|
| Focal Length | 5.21 |
| Back Focus | 4.513 |
| Open F-Number | 1.53 |
| Maximum Full Angle of View [°] | 68.8 |

### Example 34

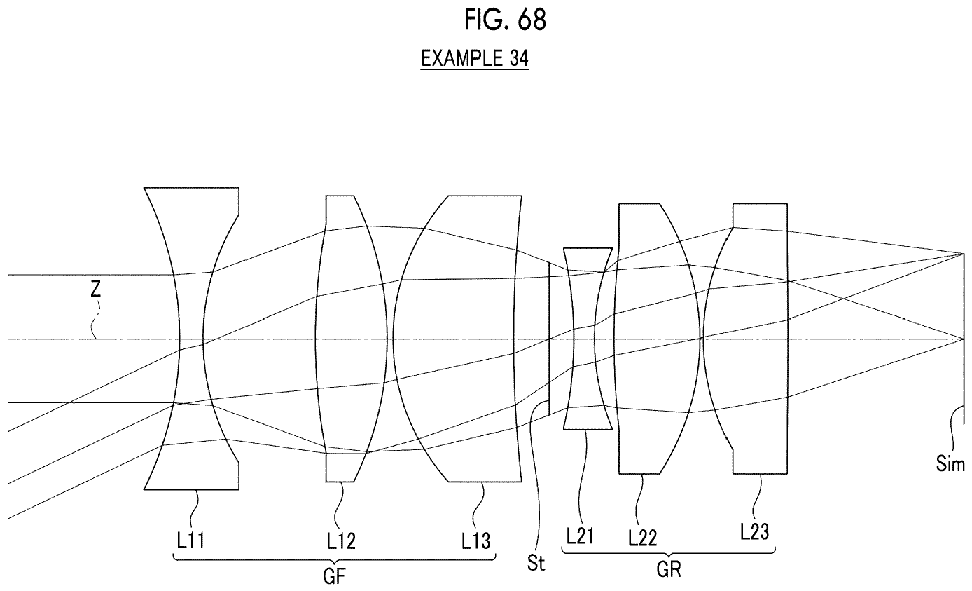

FIG. 68 shows a cross-sectional view of a configuration and luminous fluxes of a fixed-focal-length optical system of Example 34. The fixed-focal-length optical system consists of, in order from the object side to the image side, the front group GF having positive refractive power, the aperture stop St, and the rear group GR having positive refractive power. The front group GF consists of, in order from the object side to the image side, three lenses including the lenses L11 to L13. The rear group GR consists of, in order from the object side to the image side, three lenses including the lenses L21 to L23.

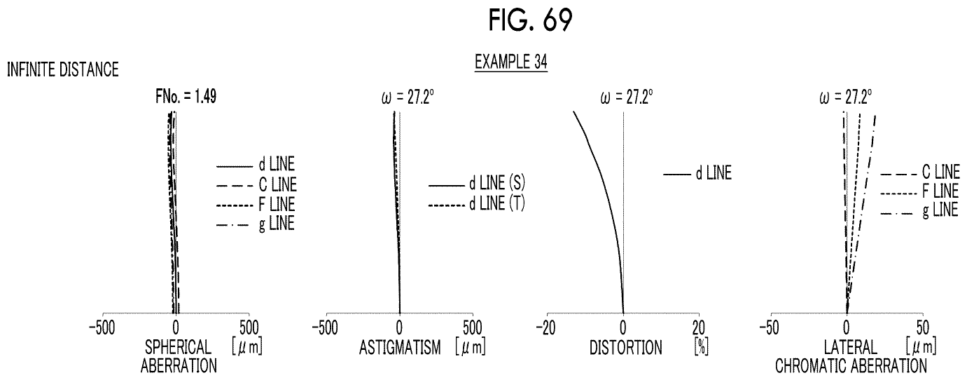

For the fixed-focal-length optical system of Example 34, Table 90 shows basic lens data, Table 91 shows specifications, and FIG. 69 shows each aberration diagram.

TABLE 90
Example 34

| Sn | R | D | Nd | νd | θgF | Material | ED |
|---|---|---|---|---|---|---|---|
| 1 | −11.3350 | 0.680 | 1.77250 | 49.60 | 0.5521 | S-LAH66.OHARA | 6.70 |
| 2 | 7.8333 | 3.250 | | | | | 6.30 |
| 3 | 20.7977 | 2.090 | 1.80100 | 34.97 | 0.5864 | S-LAM66.OHARA | 7.20 |
| 4 | −10.8827 | 0.170 | | | | | 7.44 |
| 5 | 7.0919 | 3.510 | 1.75500 | 52.32 | 0.5476 | S-LAH97.OHARA | 7.12 |
| 6 | 43.6689 | 1.030 | | | | | 5.63 |
| 7 (St) | −86.5300 | 0.720 | | | | | 4.81 |
| 8 | −13.3652 | 0.600 | 2.30909 | 17.89 | 0.6452 | N231.Glass | 4.56 |
| 9 | 7.9313 | 0.570 | | | | | 4.59 |
| 10 | 27.5953 | 2.500 | 1.83481 | 42.74 | 0.5649 | S-LAH55VS.OHARA | 5.09 |
| 11 | −8.2747 | 0.100 | | | | | 6.19 |
| 12 | 7.6506 | 2.440 | 1.75500 | 52.32 | 0.5476 | S-LAH97.OHARA | 7.00 |
| 13 | −455.0008 | 5.164 | | | | | 6.76 |

TABLE 91
Example 34

| | Infinite Distance |
|---|---|
| Focal Length | 5.99 |
| Back Focus | 5.164 |
| Open F-Number | 1.49 |
| Maximum Full Angle of View [°] | 54.4 |

Table 92 shows the corresponding values of Conditional Expressions (1) to (3) for “N231.Glass”, “N216.Glass”, and “N200.Glass” used in the above examples. Tables 93 to 99 show the corresponding values of Conditional Expressions (4) to (20) of the fixed-focal-length optical systems of Examples 1 to 34 described above. Preferable ranges of the conditional expressions may be set using the corresponding values shown in Tables 92 to 99 as upper limits or lower limits of the conditional expressions.

TABLE 92

| Expression | | | | |
|---|---|---|---|---|
| Number | | N231.Glass | N216.Glass | N200.Glass |
| (1) | Nd + | 2.564 | 2.465 | 2.454 |
| | 0.01425 × νd | | | |
| (2) | νd | 17.89 | 21.24 | 31.67 |
| (3) | θgF + | 0.702 | 0.695 | 0.685 |
| | 0.00316 × νd | | | |

TABLE 93

| Expression Number | | Example 1 | Example 2 | Example 3 | Example 4 | Example 5 |
|---|---|---|---|---|---|---|
| (4) | fR/fF | 0.3607 | 0.3058 | 0.6018 | 0.3566 | 0.4756 |
| (5) | \|ffocmax/f\| | 1.2758 | 1.1010 | 0.8364 | 0.9046 | 1.3949 |
| (6) | \|ff1/ff2\| | — | — | — | — | — |
| (7) | f/ffocF | — | — | — | — | 0.2549 |
| (8) | f/ffocR | 0.3848 | 1.0988 | −0.3666 | −0.2939 | −0.1481 |
| (9) | \|ffocF/fM\| | — | — | — | — | — |
| (10) | \|fIS/f\| | — | — | 0.3725 | 0.3739 | — |
| (11) | Amax/TLf | — | — | — | — | — |
| (12) | \|θc\| | 21.18 | 19.97 | 15.04 | 19.77 | 21.52 |
| (13) | (L1r − L1f)/ | 0.3924 | 0.3216 | −32.8848 | 2.0311 | −0.5197 |
| | (L1r + L1f) | | | | | |
| (14) | Fno | 1.45 | 2.86 | 2.08 | 2.07 | 1.46 |
| (15) | ωm | 22.6 | 25.9 | 14.9 | 16.5 | 46.3 |
| (16) | f/fp2 | — | 1.9897 | 1.0648 | 1.0640 | — |
| (17) | f/fp3 | — | — | 1.5589 | 1.4732 | — |
| (18) | f/fn2 | — | — | — | — | −0.5424 |
| (19) | f/fn3 | — | — | — | — | −0.5367 |
| (20) | \|β\| | 0.1 | 0.1 | 0.5 | 0.6 | 0.1 |

TABLE 94

| Expression Number | | Example 6 | Example 7 | Example 8 | Example 9 | Example 10 |
|---|---|---|---|---|---|---|
| (4) | fR/fF | −0.2638 | 0.1088 | 1.1615 | 6.3671 | −0.1143 |
| (5) | \|ffocmax/f\| | 2.0967 | 1.7618 | 0.9418 | 0.5252 | 3.0605 |
| (6) | \|ff1/ff2\| | — | — | — | — | — |
| (7) | f/ffocF | 0.5918 | 0.0602 | 0.6935 | 1.2640 | −0.0457 |
| (8) | f/ffocR | −0.1531 | −0.0371 | −0.5470 | 1.5220 | 0.1932 |
| (9) | \|ffocF/fM\| | — | — | — | — | — |
| (10) | \|fIS/f\| | — | — | — | — | — |
| (11) | Amax/TLf | — | — | — | — | — |
| (12) | \|θc\| | 16.19 | 24.95 | 22.25 | 11.97 | 29.01 |
| (13) | (L1r − L2f)/ | −0.3245 | −0.4951 | −14.1218 | 0.4252 | −0.7863 |
| | (L1r + L1f) | | | | | |
| (14) | Fno | 2.83 | 1.34 | 1.89 | 2.06 | 1.85 |
| (15) | ωm | 43.6 | 42.8 | 22.2 | 14.2 | 55.9 |
| (16) | f/fp2 | — | — | — | 1.3172 | — |
| (17) | f/fp3 | — | — | — | 1.5258 | — |
| (18) | f/fn2 | −0.7627 | — | — | — | −0.6504 |
| (19) | f/fn3 | — | — | — | — | −1.3615 |
| (20) | \|β\| | 0.1 | 0.1 | 0.1 | 0.1 | 0.1 |

TABLE 95

| Expression Number | | Example 11 | Example 12 | Example 13 | Example 14 | Example 15 |
|---|---|---|---|---|---|---|
| (4) | fR/fF | −0.2146 | 0.4724 | 0.4675 | 0.3332 | −0.2861 |
| (5) | \|ffocmax/f\| | 0.1261 | 2.1571 | 0.9901 | 1.2151 | 0.2327 |
| (6) | \|ff1/ff2\| | — | — | — | — | — |
| (7) | f/ffocF | 4.0162 | 0.2411 | −0.2273 | 0.2322 | 3.0542 |
| (8) | f/ffocR | −3.6936 | 0.0859 | −0.0825 | 0.2060 | −2.4190 |
| (9) | \|ffocF/fM\| | — | — | — | — | — |
| (10) | \|fIS/f] | 0.0666 | — | — | — | 0.0801 |
| (11) | Amax/TLf | 0.5325 | — | — | — | 0.5276 |
| (12) | \|θc\| | 9.18 | 23.44 | 20.57 | 18.28 | 12.35 |
| (13) | (L1r − L1f)/ | 0.6580 | −0.2875 | −0.6629 | 1.0446 | 1.0000 |
| | (L1r + L1f) | | | | | |
| (14) | Fno | 5.90 | 1.44 | 1.78 | 1.45 | 5.73 |
| (15) | ωm | 1.8 | 41.3 | 27 | 14.7 | 3.4 |
| (16) | f/fp2 | 4.9316 | — | — | 1.1023 | 2.9446 |
| (17) | f/fp3 | — | — | — | — | 5.2807 |
| (18) | f/fn2 | — | −0.6123 | — | — | — |
| (19) | f/fn3 | — | −0.7966 | — | — | — |
| (20) | \|β\| | 0.1 | 0.1 | 0.1 | 0.1 | 0.1 |

TABLE 96

| Expression Number | | Example 16 | Example 17 | Example 18 | Example 19 | Example 20 |
|---|---|---|---|---|---|---|
| (4) | fR/fF | 1.1532 | 0.5091 | 8.0088 | 0.6400 | 0.8219 |
| (5) | \|ffocmax/f\| | 4.1993 | 1.5887 | 0.9457 | 1.0968 | 1.0017 |
| (6) | \|ff1/ff2\| | 1.3673 | 0.9804 | 1.0637 | 3.2221 | 2.7271 |
| (7) | f/ffocF | 0.9568 | 0.2643 | 1.4572 | 0.4323 | 0.5019 |
| (8) | f/ffocR | 0.2142 | −0.7545 | −0.4264 | −0.2375 | −0.2871 |
| (9) | \|ffocF/fM\| | — | — | — | — | — |
| (10) | \|fIS/f\| | — | — | — | — | — |
| (11) | Amax/TLf | — | — | — | — | — |
| (12) | \|θc\| | 28.78 | 20.87 | 9.88 | 20.04 | 19.76 |
| (13) | (L1r − L1f)/ | −1.8913 | −0.5130 | 1.7579 | −0.3405 | −0.1545 |
| | (L1r + L1f) | | | | | |
| (14) | Fno | 1.87 | 2.88 | 1.47 | 1.29 | 1.29 |
| (15) | ωm | 55.5 | 34.9 | 30.3 | 23.9 | 22.6 |
| (16) | f/fp2 | — | — | — | — | — |
| (17) | f/fp3 | — | — | — | — | — |
| (18) | f/fn2 | −0.8260 | −1.1948 | −0.6947 | — | −0.5386 |
| (19) | f/fn3 | −1.0098 | — | — | — | — |
| (20) | \|β\| | 0.1 | 0.1 | 0.1 | 0.1 | 0.1 |

TABLE 97

| Expression Number | | Example 21 | Example 22 | Example 23 | Example 24 | Example 25 |
|---|---|---|---|---|---|---|
| (4) | fR/fF | 0.2882 | −1.1417 | −1.5948 | −0.5721 | 1.3046 |
| (5) | \|ffocmax/f\| | 0.7216 | 0.8430 | 0.7880 | 3.2795 | 1.4286 |
| (6) | \|ff1/ff2\| | 1.2284 | 0.8175 | 0.7663 | 0.2699 | 2.1158 |
| (7) | f/ffocF | 1.0221 | 1.3932 | 1.3171 | −0.8725 | 0.2213 |
| (8) | f/ffocR | −0.4604 | −2.2159 | −2.3001 | −0.2284 | −0.1519 |
| (9) | \|ffocF/fM\| | — | 0.4700 | 0.7981 | 0.7408 | 0.5853 |
| (10) | \|fIS/f] | — | — | — | — | — |
| (11) | Amax/TLf | — | — | — | — | — |
| (12) | \|θc\| | 25.77 | 19.19 | 18.71 | 21.836 | 21.97 |
| (13) | (L1r − L1f)/ | 0.6461 | 0.3853 | 0.3454 | −0.6586 | −0.4340 |
| | (L1r + L1f) | | | | | |
| (14) | Fno | 1.85 | 1.85 | 1.85 | 1.52 | 1.26 |
| (15) | ωm | 14.8 | 10.2 | 10.2 | 45.3 | 41.3 |
| (16) | f/fp2 | 1.2345 | 1.1648 | 1.1756 | — | — |
| (17) | f/fp3 | — | 1.8780 | 2.0102 | — | — |
| (18) | f/fn2 | — | — | — | −0.8725 | −0.5246 |
| (19) | f/fn3 | — | — | — | — | −0.6230 |
| (20) | \|β\| | 0.123 | 0.1 | 0.1 | 0.12 | 0.11 |

TABLE 98

| Expression Number | | Example 26 | Example 27 | Example 28 | Example 29 | Example 30 |
|---|---|---|---|---|---|---|
| (4) | fR/fF | 1.3871 | 0.3830 | 0.3981 | 0.7569 | 0.7890 |
| (5) | \|ffocmax/f\| | 1.0128 | 0.9678 | 2.7408 | 2.0720 | 1.9646 |
| (6) | \|ff1/ff2\| | 2.6629 | 1.0603 | — | — | — |
| (7) | f/ffocF | 0.4617 | 1.0564 | 0.1452 | 2.0030 | 0.4016 |
| (8) | f/ffocR | −0.3439 | −1.3041 | — | — | — |
| (9) | \|ffocF/fM\| | 0.4583 | 0.7351 | — | — | — |
| (10) | \|fIS/f] | — | — | — | — | — |
| (11) | Amax/TLf | — | — | — | — | — |
| (12) | \|θc\| | 21.9 | 21.53 | 4.62 | 1.96 | 4.59 |
| (13) | (L1r − L1f)/ | −3.9296 | 0.1641 | −0.2143 | 0.8263 | −0.3095 |
| | (L1r + L1f) | | | | | |
| (14) | Fno | 1.44 | 1.26 | 1.84 | 2.84 | 1.85 |
| (15) | ωm | 33.1 | 14.2 | 52.4 | 10.8 | 39.5 |
| (16) | f/fp2 | — | 1.0332 | — | — | — |
| (17) | f/fp3 | — | — | — | — | — |
| (18) | f/fn2 | — | — | −0.4994 | — | −1.0271 |
| (19) | f/fn3 | — | — | −0.6341 | — | — |
| (20) | \|β\| | 0.11 | 0.1 | 0.1 | 0.151 | 0.1 |

TABLE 99

| Expression | | Exam- | Exam- | Exam- | Exam- |
|---|---|---|---|---|---|
| Number | | ple 31 | ple 32 | ple 33 | ple 34 |
| (4) | fR/fF | 0.1669 | 1.7405 | 0.2234 | 2.5164 |
| (5) | \|ffocmax/f\| | 1.0000 | — | — | — |
| (6) | \|ff1/ff2\| | — | — | — | — |
| (7) | f/ffocF | — | — | — | — |
| (8) | f/ffocR | — | — | — | — |
| (9) | \|ffocF/fM\| | — | — | — | — |
| (10) | \|fIS/f\| | — | — | — | — |
| (11) | Amax/TLf | — | — | — | — |
| (12) | \|θc\| | 5.01 | 6.47 | 9.5 | 9.81 |
| (13) | (L1r − L1f)/ | 0.3518 | −0.5324 | −0.7374 | −5.4740 |
| | (L1r + L1f) | | | | |
| (14) | Fno | 1.84 | 2.30 | 1.53 | 1.49 |
| (15) | ωm | 15.8 | 30.3 | 34.4 | 27.2 |
| (16) | f/fp2 | — | — | — | — |
| (17) | f/fp3 | — | — | — | — |
| (18) | f/fn2 | — | — | — | — |
| (19) | f/fn3 | — | — | — | — |
| (20) | \|β\| | 0.1 | — | — | — |

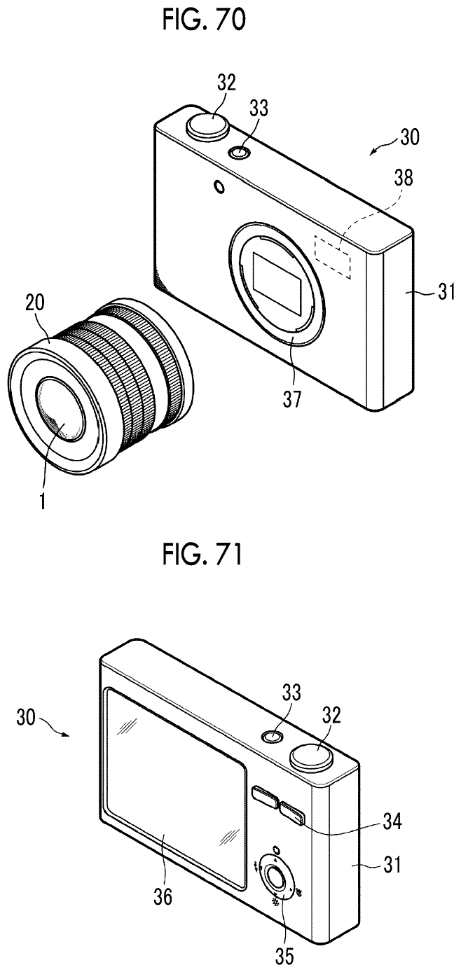

Next, an imaging apparatus according to the embodiment of the present disclosure will be described. FIGS. 70 and 71 show external views of a camera 30 that is the imaging apparatus according to the embodiment of the present disclosure. FIG. 70 shows a perspective view of the camera 30 seen from a front side, and FIG. 71 shows a perspective view of the camera 30 seen from a rear side. The camera 30 is a digital camera of a so-called mirrorless type on which an interchangeable lens 20 can be attachably and detachably mounted. The interchangeable lens 20 is configured to include a fixed-focal-length optical system 1 according to one embodiment of the present disclosure accommodated in a lens barrel. In the present example, the fixed-focal-length optical system 1 functions as an imaging lens.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before being captured.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 via the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not shown), a recording medium (not shown), and the like are provided in the camera body 31. The signal processing circuit generates an image by processing the imaging signal output from the imaging element 38. The generated image is recorded on the recording medium. In the camera 30, a still image or a moving image can be captured by pressing the shutter button 32, and image data obtained by this capturing is recorded on the recording medium.

While the disclosed technology is described above using the embodiment and the examples, the disclosed technology is not limited to the embodiment and the examples, and various modifications can be made. For example, the curvature radius, the surface spacing, the refractive index, the Abbe number, and the aspherical coefficients of each lens are not limited to the values shown in each example and may have other values.

The imaging apparatus according to the embodiment of the present disclosure is not limited to the above example and may adopt various aspects such as a camera of a type other than a mirrorless type, a camera composed of an imaging lens and a camera body that are integrated with each other, a film camera, a video camera, a surveillance camera, a broadcasting camera, a movie imaging camera, a factory automation (FA) camera, and a machine vision (MV) camera.

The following appendices are further disclosed with respect to the embodiment and the examples described above.

### APPENDIX 1

A fixed-focal-length optical system consisting of, in order from an object side to an image side, a front group, a stop, and a rear group,
in which in a case where a refractive index at a d line for a lens included in the fixed-focal-length optical system is denoted by Nd, and
an Abbe number based on the d line for the lens included in the fixed-focal-length optical system is denoted by νd,
the fixed-focal-length optical system includes at least one specific lens that is a lens satisfying Conditional Expressions (1) and (2) represented by

$$2.435 < Nd + 0.01425 \times vd < 2.75 , \qquad ( 1 )$$

$$and$$

$$15 < vd < 39 . \qquad ( 2 )$$

### APPENDIX 2

The fixed-focal-length optical system according to Appendix 1,
in which in a case where a partial dispersion ratio between a g line and an F line for the lens included in the fixed-focal-length optical system is denoted by θgF,
the specific lens satisfies Conditional Expression (3) represented by

$$0.65 < θ gF + 0.00316 \times vd < 0.85 . \qquad ( 3 )$$

### APPENDIX 3

The fixed-focal-length optical system according to Appendix 1 or 2,
in which in a case where a focal length of the front group in a state where an infinite distance object is in focus is denoted by fF, and
a focal length of the rear group in the state where the infinite distance object is in focus is denoted by fR,
Conditional Expression (4) is satisfied, which is represented by

$$- 5 < fR / fF < 10. \qquad ( 4 )$$

### APPENDIX 4

The fixed-focal-length optical system according to any one of Appendices 1 to 3,
in which at least one focus lens group that moves along an optical axis during focusing is disposed.

### APPENDIX 5

The fixed-focal-length optical system according to Appendix 4,
in which in a case where a focal length of a focus lens group having strongest refractive power among the focus lens groups included in the fixed-focal-length optical system is denoted by ffocmax, and
a focal length of the fixed-focal-length optical system in a state where an infinite distance object is in focus is denoted by f,
Conditional Expression (5) is satisfied, which is represented by

$$0.2 < \vert ffoc max / f \vert < 3.5 . \qquad ( 5 )$$

### APPENDIX 6

The fixed-focal-length optical system according to Appendix 4 or 5,
in which the number of focus lens groups included in the fixed-focal-length optical system is two, and
in a case where a focal length of the focus lens group on the object side out of the two focus lens groups is denoted by ff1, and
a focal length of the focus lens group on the image side out of the two focus lens groups is denoted by ff2,
Conditional Expression (6) is satisfied, which is represented by

$$0.1 < \vert ff 1 / ff 2 \vert < 10. \qquad ( 6 )$$

### APPENDIX 7

The fixed-focal-length optical system according to any one of Appendices 4 to 6,
in which in a case where a combined focal length of all lenses on the object side with respect to a focus lens group closest to the object side among the focus lens groups included in the fixed-focal-length optical system is denoted by ffocF, and
a focal length of the fixed-focal-length optical system in a state where an infinite distance object is in focus is denoted by f,
Conditional Expression (7) is satisfied, which is represented by

$$- 2 < f / ffocF < 6. \qquad ( 7 )$$

### APPENDIX 8

The fixed-focal-length optical system according to any one of Appendices 4 to 7,
in which in a case where a combined focal length of all lenses on the image side with respect to a focus lens group closest to the image side among the focus lens groups included in the fixed-focal-length optical system is denoted by ffocR, and
a focal length of the fixed-focal-length optical system in a state where an infinite distance object is in focus is denoted by f,
Conditional Expression (8) is satisfied, which is represented by

$$- 6 < f / ffocR < 2. \qquad ( 8 )$$

### APPENDIX 9

The fixed-focal-length optical system according to any one of Appendices 4 to 8,
in which two focus lens groups that move on different trajectories from each other during focusing are disposed in the rear group.

### APPENDIX 10

The fixed-focal-length optical system according to any one of Appendices 4 to 9,
in which one focus lens group is disposed in each of the front group and the rear group,
the focus lens group of the front group and the focus lens group of the rear group move on different trajectories from each other during focusing, and
in a case where a combined focal length of all lenses on the object side with respect to a focus lens group closest to the object side among the focus lens groups included in the fixed-focal-length optical system is denoted by ffocF, and
a combined focal length from a lens adjacent to the focus lens group of the front group on the image side to a lens adjacent to the focus lens group of the rear group on the object side is denoted by fM,
Conditional Expression (9) is satisfied, which is represented by

$$0.1 < \vert ffocF / fM \vert < 2. \qquad ( 9 )$$

### APPENDIX 11

The fixed-focal-length optical system according to any one of Appendices 4 to 10,
in which the at least one focus lens group includes at least one specific lens.

### APPENDIX 12

The fixed-focal-length optical system according to any one of Appendices 1 to 11,
in which the rear group includes at least one specific lens.

### APPENDIX 13

The fixed-focal-length optical system according to any one of Appendices 1 to 12,
in which the front group includes at least one specific lens.

### APPENDIX 14

The fixed-focal-length optical system according to any one of Appendices 1 to 13,
in which each of the front group and the rear group includes at least one specific lens.

### APPENDIX 15

The fixed-focal-length optical system according to any one of Appendices 1 to 14,
in which the fixed-focal-length optical system includes at least one cemented lens, and
the at least one cemented lens includes at least one specific lens.

### APPENDIX 16

The fixed-focal-length optical system according to any one of Appendices 1 to 15,
in which the rear group includes a vibration-proof group that moves in a direction intersecting with an optical axis during image shake correction, and
in a case where a focal length of the vibration-proof group is denoted by fIS, and
a focal length of the fixed-focal-length optical system in a state where an infinite distance object is in focus is denoted by f,
Conditional Expression (10) is satisfied, which is represented by

$$0.05 < \vert fIS / f \vert < 2. \qquad ( 10 )$$

### APPENDIX 17

The fixed-focal-length optical system according to Appendix 16,
in which the vibration-proof group includes at least one specific lens.

### APPENDIX 18

The fixed-focal-length optical system according to any one of Appendices 1 to 17,
in which a maximum half angle of view in a state where an infinite distance object is in focus is 7 degrees or less, and
in a case where a maximum value of an air spacing on an optical axis in the front group in the state where the infinite distance object is in focus is denoted by Amax, and
a distance on the optical axis from a lens surface closest to the object side in the front group to a lens surface closest to the image side in the front group in the state where the infinite distance object is in focus is denoted by TLf,
Conditional Expression (11) is satisfied, which is represented by

$$0.2 < A max / TLf < 0.8 . \qquad ( 11 )$$

### APPENDIX 19

The fixed-focal-length optical system according to any one of Appendices 1 to 18,
in which in a case where an angle, with respect to an optical axis, of incidence of a chief ray of a maximum angle of view on an image plane in a state where an object at a longest object distance capable of being focused is in focus is denoted by θc, and
θc is in degree units,
Conditional Expression (12) is satisfied, which is represented by

$$0 < \vert θ c \vert < 30. \qquad ( 12 )$$

### APPENDIX 20

An imaging apparatus comprising:
the fixed-focal-length optical system according to any one of Appendices 1 to 19.

What is claimed is:

1. A fixed-focal-length optical system consisting of, in order from an object side to an image side, a front group, a stop, and a rear group,
wherein in a case where a refractive index at a d line for a lens included in the fixed-focal-length optical system is denoted by Nd, and
an Abbe number based on the d line for the lens included in the fixed-focal-length optical system is denoted by νd,
the fixed-focal-length optical system includes at least one specific lens that is a lens satisfying Conditional Expressions (1) and (2) represented by
$$2.435 < Nd + 0.01425 \times v d < 2.75 , and \qquad ( 1 )$$
$$15 < vd < 39. \qquad ( 2 )$$

2. The fixed-focal-length optical system according to claim 1,
wherein in a case where a partial dispersion ratio between a g line and an F line for the lens included in the fixed-focal-length optical system is denoted by θgF,
the specific lens satisfies Conditional Expression (3) represented by
$$0.65 < θ gF + 0.00316 \times v d < 0 \text{.85} . \qquad ( 3 )$$

3. The fixed-focal-length optical system according to claim 1,
wherein in a case where a focal length of the front group in a state where an infinite distance object is in focus is denoted by fF, and
a focal length of the rear group in the state where the infinite distance object is in focus is denoted by fR,
Conditional Expression (4) is satisfied, which is represented by
$$- 5 < fR / fF < 10. \qquad ( 4 )$$

4. The fixed-focal-length optical system according to claim 1,
wherein at least one focus lens group that moves along an optical axis during focusing is disposed.

5. The fixed-focal-length optical system according to claim 4,
wherein in a case where a focal length of a focus lens group having strongest refractive power among the focus lens groups included in the fixed-focal-length optical system is denoted by ffocmax, and
a focal length of the fixed-focal-length optical system in a state where an infinite distance object is in focus is denoted by f,
Conditional Expression (5) is satisfied, which is represented by
$$0.2 < \vert ffoc max / f \vert < 3.5 . \qquad ( 5 )$$

6. The fixed-focal-length optical system according to claim 4,
wherein the number of focus lens groups included in the fixed-focal-length optical system is two, and
in a case where a focal length of the focus lens group on the object side out of the two focus lens groups is denoted by ff1, and
a focal length of the focus lens group on the image side out of the two focus lens groups is denoted by ff2,
Conditional Expression (6) is satisfied, which is represented by
$$0 \text{.1} < \vert ff 1 / ff 2 \vert < 10. \qquad ( 6 )$$

7. The fixed-focal-length optical system according to claim 4,
wherein in a case where a combined focal length of all lenses on the object side with respect to a focus lens group closest to the object side among the focus lens groups included in the fixed-focal-length optical system is denoted by ffocF, and
a focal length of the fixed-focal-length optical system in a state where an infinite distance object is in focus is denoted by f,
Conditional Expression (7) is satisfied, which is represented by
$$- 2 < f / ffocF < 6. \qquad ( 7 )$$

8. The fixed-focal-length optical system according to claim 4,
wherein in a case where a combined focal length of all lenses on the image side with respect to a focus lens group closest to the image side among the focus lens groups included in the fixed-focal-length optical system is denoted by ffocR, and
a focal length of the fixed-focal-length optical system in a state where an infinite distance object is in focus is denoted by f,
Conditional Expression (8) is satisfied, which is represented by
$$- 6 < f / ffocR < 2. \qquad ( 8 )$$

9. The fixed-focal-length optical system according to claim 4,
wherein two focus lens groups that move on different trajectories from each other during focusing are disposed in the rear group.

10. The fixed-focal-length optical system according to claim 4,
wherein one focus lens group is disposed in each of the front group and the rear group,
the focus lens group of the front group and the focus lens group of the rear group move on different trajectories from each other during focusing, and
in a case where a combined focal length of all lenses on the object side with respect to a focus lens group closest to the object side among the focus lens groups included in the fixed-focal-length optical system is denoted by ffocF, and
a combined focal length from a lens adjacent to the focus lens group of the front group on the image side to a lens adjacent to the focus lens group of the rear group on the object side is denoted by fM,
Conditional Expression (9) is satisfied, which is represented by
$$0.1 < \vert ffocF / fM \vert < 2. \qquad ( 9 )$$

11. The fixed-focal-length optical system according to claim 4,
wherein the at least one focus lens group includes at least one specific lens.

12. The fixed-focal-length optical system according to claim 1,
wherein the rear group includes at least one specific lens.

13. The fixed-focal-length optical system according to claim 1,
wherein the front group includes at least one specific lens.

14. The fixed-focal-length optical system according to claim 1,
wherein each of the front group and the rear group includes at least one specific lens.

15. The fixed-focal-length optical system according to claim 1,
wherein the fixed-focal-length optical system includes at least one cemented lens, and
the at least one cemented lens includes at least one specific lens.

16. The fixed-focal-length optical system according to claim 1,
wherein the rear group includes a vibration-proof group that moves in a direction intersecting with an optical axis during image shake correction, and
in a case where a focal length of the vibration-proof group is denoted by fIS, and
a focal length of the fixed-focal-length optical system in a state where an infinite distance object is in focus is denoted by f,
Conditional Expression (10) is satisfied, which is represented by
$$0.05 < \vert fIS / f \vert < 2. \qquad ( 10 )$$

17. The fixed-focal-length optical system according to claim 16,
wherein the vibration-proof group includes at least one specific lens.

18. The fixed-focal-length optical system according to claim 1,
wherein a maximum half angle of view in a state where an infinite distance object is in focus is 7 degrees or less, and
in a case where a maximum value of an air spacing on an optical axis in the front group in the state where the infinite distance object is in focus is denoted by Amax, and
a distance on the optical axis from a lens surface closest to the object side in the front group to a lens surface closest to the image side in the front group in the state where the infinite distance object is in focus is denoted by TLf,
Conditional Expression (11) is satisfied, which is represented by
$$0.2 < A max / TLf < 0.8 . \qquad ( 11 )$$

19. The fixed-focal-length optical system according to claim 1,
wherein in a case where an angle, with respect to an optical axis, of incidence of a chief ray of a maximum angle of view on an image plane in a state where an object at a longest object distance capable of being focused is in focus is denoted by θc, and
θc is in degree units,
Conditional Expression (12) is satisfied, which is represented by
$$0 < \vert θ c \vert < 30. \qquad ( 12 )$$

20. An imaging apparatus comprising:
the fixed-focal-length optical system according to claim 1.
